(19) United States
(12) Patent Application Publication
(10) Pub. No.: US 2003/0083900 A1
(43) Pub. Date: May 1, 2003

(54) Template-based method and system for reverse engineering

(76) Inventors: Ismail Khriss, LaSalle (CA); Michel Brassard, Montreal (CA)

Correspondence Address: OGILVY RENAULT, 1981 MCGILL COLLEGE AVENUE, SUITE 1600, MONTREAL, QC, H3A2Y3, CA

(21) Appl. No.: 10/279,726

(22) Filed: Oct. 25, 2002

Related U.S. Application Data
(60) Provisional application No. 60/330,642, filed on Oct. 26, 2001.

(51) Int. Cl. G06F 17/60

(52) U.S. Cl. 705/1

(57) ABSTRACT

A component-based source code associated with a software system is provided. The purpose is to extract its abstract representation. This abstract representation consists of the business logic of the source code and its infrastructure code. First, the source code is analyzed structurally. This produces a set of structural meta-data. These meta-data enable the extraction of the business logic of the source code. Then all concrete instances of the structural meta-data are replaced with context variables, which reference the business logic, allowing discovery of repetitive and nearly repetitive portions of source code which constitute the infrastructure code. Finally, the abstract representation obtained from the source code can be used for a reengineering step, which may consist of changes in the business logic and/or in the infrastructure code. The advantages are ensuring traceability between source code and its abstract representation filtered by a set of pre-existing generation templates, deriving the business logic of the source code and its generation templates and updating the business logic of the source code and its generation templates.

### CROSS-REFERENCE TO RELATED APPLICATIONS

The application claims priority of U.S. provisional patent application No. 60/330,442 filed Oct. 26, 2001.

### FIELD OF THE INVENTION

The present invention is directed toward a template-based system and method for reverse engineering source code of a component-based application. More particularly, the present invention is directed to a system and method in which the system performs a post-development analysis on an existing component-based application. It analyzes a component-based application and creates its representation at higher abstraction level. This abstract information facilitates the comprehension and evolution of existing object-oriented applications.

### TERMS

For the purpose of the present invention, the following terms are defined:

Software system: An application to be developed.

Software model: An abstraction of a software system.

Model element: An atomic constituent of a software model. A model element has relationships with other model elements and a set of property values. An example of a model element is a component or a class called “Customer,” which represents all customers managed by a developed software application with predefined attributes representing unique characteristics like first name, last name, birth date, etc.

Model element type: One of the valid types of model elements to be found within a software model. The model element type determines the role, valid relationships with other model elements, and properties of a model element. Examples of model element types are class, attribute, state, package, association, etc.

Stereotype: A designator, textual and graphical, for a model element denoting its role within the software model and, optionally, implying additional properties associated with the model element.

Property: A property is a characteristic of all model elements of a given model element type. A property has a name and content. Each model element of a type has content for each of the properties associated with its corresponding model element type. A property can be used to capture a non-functional requirement like a design decision, an implementation decision, or a code-related option. In the UML™ 1.3 specification, a property is called a tagged value.

Architectural issues: Statements that cover the best practices for transforming or implementing the model elements of a software system. The word “statements” refers to the domain model itself or to any technology or platform involved in its implementation.

Design decision: Implementation data or decisions that provide a valid answer for an architecture issue.

Software technology: Any significant software used to implement directly or indirectly a domain software model. The kind of software technology—free, commercial, in-house offering, or other—is immaterial. It is sufficient to note that collaborating or competing technologies have different implementations and different issues guiding their correct use.

Architectural layer: a portion of a software system representing the industry domain or a selected software technology or operating system platform used to implement the domain software model. Layering permits the developers of a system to group architecture issues per industry domain, technology, or platform so that changes within one layer have little or no impact on the other layers.

Infrastructure code: Code found in a software system that complements the business logic code.

### BACKGROUND OF THE INVENTION

Rather than designing an application from scratch, companies develop multi-tier applications based on framework solutions offering services like persistence, security, and transaction. A framework is an object-oriented abstraction that provides an extensible library of cooperating classes that make up a reusable design solution for a given problem domain. In essence, a framework offers a generic solution, and software engineers need to implement specialized code—acting as component-to-framework integration code—in each component in order to specify its special treatments when processed by the framework.

When a framework is customized or additional functionalities are implemented, changes are often required in the component-to-framework integration code for all participating components. Maintaining the integration code over the course of such changes is a tedious and error-prone process. Software engineers have to manually edit and modify the generated component-to-framework integration code in every component participating in a given framework because its associated code generator is rarely customizable so as to reflect company requirements implemented inside the framework. Most frameworks prevent a company from centralizing and capturing their corporate repository data because their associated code generators are rarely integrated with a modeling tool. With Codagen Architect and its generation templates (see international patent application PCT/CA99/00929 filed Oct. 12, 1999 by the Applicant), software engineers maintain the component-to-framework integration code by making the appropriate changes in the associated generation templates before generating the code from the model.

Moreover, corporations face mounting maintenance and reengineering costs for existing large applications. Evolving over several years, these applications embody substantial corporate knowledge, including requirements, business rules, and design decisions. Such knowledge, which can be considered an in-house framework, is difficult to recover after many years of operation, evolution, and turnover rate. To address this problem, software engineers are spending an increasing amount of effort to understand source code, commonly called program understanding. In fact, it has been estimated that fifty to ninety percent of evolution work is devoted to program comprehension or understanding (see T. A Standish. “An essay on software reuse.” IEEE Transactions on Software Engineering, Vol. 10, Num. 5, pp. 494-497, September 1984.) Hence, simplifying the understanding process can have significant economic savings.

One solution to program comprehension is to provide tools for facilitating source navigation. Examples of such tools are Sniff+ available from Wind River Systems and Source Navigator available from Free Software Foundation. These tools provide fast and intuitive source navigation and allow for the analysis of complex relationships within a large body of source code that may have thousands of files and over a million lines of code.

Another solution to the problem of program understanding is reverse engineering. Reverse engineering is the process of analyzing a subject system to (1) identify the system's components and their interrelationships and (2) create representations of the system in another form or a higher level of abstraction.

In the realm of component source code, several tools, such as Rational Rose, available from Rational and Together Control Center available from TogetherSoft, provide reverse engineering support. These tools allow one to get a higher representation of a component source code. This representation is usually a static structure of the source described as a class diagram, which shows a set of classes and interfaces and their relationships. Note that some systems, such as the system described by Graham in U.S. Pat. No. 6,199,198 and Together Control Center, also allow one to get a dynamic representation of source code expressed as object interaction diagrams. These diagrams show the messages exchanged by the different components included in the source code.

However, the higher abstraction representation of source code allowed by these approaches provides not only the business logic of the system but also its underlying infrastructure code for a given platform, which creates noise. It is believed that once a representation of source code grows beyond a certain size, its usefulness diminishes to the point where the cost of production and maintenance exceeds the benefit. It is therefore believed that it is futile to build a representation of source code that is very large. Hence, there is a need for distinguishing the business or core logic of the source code associated with a software system from some or all aspects of the infrastructure code.

### SUMMARY OF THE INVENTION

Accordingly, it is an object of the present invention to provide a system that performs post-development analysis on existing component-based source code.

Another object of the present invention is to provide a system for deriving the abstract representation of component-based source code. This abstract representation can be a UML class diagram containing the necessary meta-data information from the domain logic structure and its implementation data as used in the infrastructure code and, separately, its infrastructure code.

Another object of the present invention is to provide a system for deriving an abstract representation of component-based source code that may be used for reengineering purposes.

According to one broad aspect of the present invention, there is provided a method of generating a higher-level representation of program source code, the method comprising: providing a program source code; parsing the program source code to obtain meta-data corresponding to the program source code; determining a business logic from at least the meta-data; translating the program source code into parameterized source code using at least one of the business logic and the meta-data; extracting infrastructure code from the parameterized source code using at least one of the source code and the meta-data; building the higher-level representation of the source code using the business logic and the infrastructure code, wherein the higher-level representation provides sufficient information about the source code to permit generation of the program source code using the higher-level representation.

According to another broad aspect of the present invention, there is provided a method of program code reengineering comprising: providing a program source code; parsing the program source code to obtain meta-data corresponding to the program source code; determining a business logic from at least the meta-data; translating the program source code into parameterized source code using at least one of the business logic and the meta-data; extracting infrastructure code from the parameterized source code using at least one of the source code and the meta-data; building the higher-level representation of the source code using the business logic and the infrastructure code, wherein the higher-level representation provides sufficient information about the source code to permit generation of the program source code using the higher-level representation; modifying at least a portion of the higher-level representation to effect a reengineering change in the program source code; and generating reengineered program source code using the modified higher-level representation.

According to still another broad aspect of the present invention, there is provided a method of generating a higher-level representation of program source code using a set of previously used generation template data, the method comprising: providing a program source code; providing a set of generation template data previously used to generate the program source code; selecting at least one of the set of generation template data; parsing the program source code to obtain meta-data corresponding to the program source code; determining a business logic from at least the meta-data; translating the program source code into parameterized source code using the set of generation template data and at least one of the business logic and the meta-data; extracting infrastructure code from the parameterized source code using the set of generation template data and at least one of the source code and the meta-data; building the higher-level representation of the source code using the business logic and the infrastructure code, wherein the higher-level representation provides sufficient information about the source code to permit generation of the program source code using the higher-level representation.

According to a further broad aspect of the present invention, there is provided an apparatus for generating a higher-level representation of program source code comprising: a program source code provider for providing a program source code; a parser for parsing the program source code to obtain meta-data corresponding to the program source code; a business logic determiner for determining a business logic from at least the meta-data; a code translator for translating the program source code into parameterized source code using at least one of the business logic and the meta-data; an infrastructure extractor for extracting infrastructure code from the parameterized source code using at least one of the source code and the meta-data; an abstraction builder for building the higher-level representation of the source code using the business logic and the infrastructure code, wherein the higher-level representation provides sufficient information about the source code to permit to a code generator to generate the program source code using the higher-level representation.

According to another broad aspect of the present invention, there is provided an apparatus for reengineering program code comprising: a program source code provider for providing a program source code; a parser for parsing the program source code to obtain meta-data corresponding to the program source code; a business logic determiner for determining a business logic from at least the meta-data; a code translator for translating the program source code into parameterized source code using at least one of the business logic and the meta-data; an infrastructure extractor for extracting infrastructure code from the parameterized source code using at least one of the source code and the meta-data; an abstraction builder for building the higher-level representation of the source code using the business logic and the infrastructure code, wherein the higher-level representation provides sufficient information about the source code to permit to a code generator to generate the program source code using the higher-level representation; a reengineering modifier for modifying at least a portion of the higher-level representation to effect a reengineering change in the program source code; and a code generator for generating reengineered program source code using the modified higher-level representation.

According to a further broad aspect of the present invention, there is provided an apparatus for generating a higher-level representation of program source code using a set of previously used generation template data, the apparatus comprising: a program source code provider for providing a program source code; template provider for providing a set of generation template data previously used to generate the program source code; template selector for selecting at least one of the set of generation template data; a parser for parsing the program source code to obtain meta-data corresponding to the program source code; a business logic determiner for determining a business logic from at least the meta-data; a code translator for translating the program source code into parameterized source code using the set of generation template data and at least one of the business logic and the meta-data; an infrastructure extractor for extracting infrastructure code from the parameterized source code using the set of generation template data and at least one of the source code and the meta-data; an abstraction builder for building the higher-level representation of the source code using the business logic and the infrastructure code, wherein the higher-level representation provides sufficient information about the source code to permit to a code generator to generate the program source code using the higher-level representation.

A component-based source code associated with a software system is provided. The purpose is to extract its abstract representation. This abstract representation consists of the business logic of the source code and its infrastructure code. First, the source code is analyzed structurally. This produces a set of structural meta-data. These meta-data enable the extraction of the business logic of the source code. Then all concrete instances of the structural meta-data are replaced with context variables, which reference the business logic, allowing discovery of repetitive and nearly repetitive portions of source code which constitute the infrastructure code. Finally, the abstract representation obtained from the source code can be used for a reengineering step, which may consist of changes in the business logic and/or in the infrastructure code. The advantages are ensuring traceability between source code and its abstract representation filtered by a set of pre-existing generation templates, deriving the business logic of the source code and its generation templates and updating the business logic of the source code and its generation templates.

Let sourceCode1 be component-based source code and higherRep1 be its higher abstraction representation. Assuming that sourceCode1 has evolved to sourceCode2, the purpose of (1) is to report the delta code (the difference between sourceCode1 and sourceCode2) in order to update higherRep1 by filtering the source code with a library of transformation rules (generation templates). SourceCode1 and higherRep1 could be empty.

Let sourceCode be component-based source code. The purpose of (2) is to extract the higher abstraction representation of sourceCode and a set of generation templates, which capture transformation decisions and repetitive and nearly repetitive portions of sourceCode.

Let sourceCode1 be component-based source code, businessLogic be its business logic, and projGen a library of generation templates used to generate sourceCode1 from businessLogic. Assuming that sourceCode1 has evolved to sourceCode2, the purpose of (3) is to update businessLogic and projGen in order to reflect the evolution of sourceCode1 to sourceCode2.

### BRIEF DESCRIPTION OF THE FIGURES

Having thus generally described the nature of the invention, reference will now be made to the accompanying figures, showing by way of illustration a preferred embodiment thereof, and in which

FIG. 1 shows the generic process for reverse engineering and reengineering of component source code;

FIG. 2 shows the process for ensuring consistency between source code and its higher abstraction representation;

FIG. 3 describes a higher abstraction representation of a ‘Bank’ system;

FIG. 4 shows a set of generation templates;

FIG. 5 shows the detail of the generation template ‘model class’;

FIG. 6 shows the detail of the generation template ‘model attributes’;

FIG. 7 shows the detail of the generation template ‘association card max=1’;

FIG. 8 shows the detail of the generation template ‘association card max=N’;

FIG. 9 shows the detail of the generation template ‘get selector’;

FIG. 10 shows the detail of the generation template ‘set selector’;

FIG. 11 shows the detail of the generation template ‘add elements of associations card max=N’;

FIG. 12 shows the detail of the generation template ‘remove elements of associations card max=N’;

FIG. 13 shows the new version of the higher abstraction representation of the ‘Bank system’ after application of the process to the evolved source code;

FIG. 14 shows the process for extracting the business logic and generation templates of component source code;

FIG. 15 shows the sub-steps for extracting the business logic of component source code;

FIG. 16 presents the results of extracting the business logic of the Bank system described in FIGS. 38-58;

FIG. 17 describes the sub-steps for creating class and interface templates;

FIG. 18 describes the sub-steps for creating attribute templates;

FIG. 19 describes the sub-steps for creating method templates;

FIG. 20 describes the sub-steps for updating the business logic and generation templates from evolved source code;

FIG. 21 describes the sub-steps for updating the business logic from evolved source code;

FIG. 22 describes the sub-steps for updating generation templates from evolved source code;

FIG. 23 is pseudo-code for the algorithm parseSourceCode;

FIG. 24 is pseudo-code for the algorithm getHeaderClass;

FIG. 25 is pseudo-code for the algorithm getAttributes;

FIG. 26 is pseudo-code for the algorithm getMethods;

FIG. 27 is pseudo-code for the algorithm reportDeltaCode;

FIG. 28 comprises FIG. 28A and FIG. 28B and is pseudo-code for the algorithm reportChanges;

FIG. 29 is pseudo-code for the algorithm updateBusinessLogic;

FIG. 30 is pseudo-code for the algorithm isClassInfrastructureCode;

FIG. 31 is pseudo-code for the algorithm isAttributeInfrastructureCode;

FIG. 32 is pseudo-code for the algorithm isMethodInfrastructureCode;

FIG. 33 is the source code of the class Account;

FIG. 34 is the source code of the class Customer;

FIG. 35 is the source code of the class BankTransaction;

FIG. 36 is the source code of the class CheckingAccount;

FIG. 37 is the source code of the class SavingAccount;

FIG. 38 is the source code of the class Withdrawal;

FIG. 39 is the source code of the class Deposit;

FIG. 40 is the source code of the class Currency;

FIG. 41 is the source code of the class Account;

FIG. 42 is the source code of the class BankTransaction;

FIG. 43 is the source code of the class CheckingAccount;

FIG. 44 is the source code of the class SavingAccount;

FIG. 45 is the source code of the class Customer;

FIG. 46 is the source code of the class Deposit;

FIG. 47 is the source code of the class Withdrawal;

FIG. 48 comprises FIG. 48A and FIG. 48B and is the source code of the class AccountBean;

FIG. 49 comprises FIG. 49A and FIG. 49B and is the source code of the class BankTransactionBean;

FIG. 50 is the source code of the class CheckingAccountBean;

FIG. 51 is the source code of the class SavingAccountBean;

FIG. 52 is the source code of the class CustomerBean;

FIG. 53 is the source code of the class DepositBean;

FIG. 54 is the source code of the class WithdrawalBean;

FIG. 55 is the source code of the class AccountHome;

FIG. 56 is the source code of the class BankTransactionHome;

FIG. 57 is the source code of the class CheckingAccountHome;

FIG. 58 is the source code of the class SavingAccountHome;

FIG. 59 is the source code of the class CustomerHome;

FIG. 60 is the source code of the class DepositHome;

FIG. 61 is the source code of the class WithdrawalHome;

FIG. 62 is pseudo-code for the algorithm retrieveBusinessClasses;

FIG. 63 is pseudo-code for the algorithm patternMatching;

FIG. 64 is pseudo-code for the algorithm extractArchitecturalLayers;

FIG. 65 is pseudo-code for the algorithm retrieveAttributesForBusinessClasses;

FIG. 66 is pseudo-code for the algorithm getRelatedClasses;

FIG. 67is pseudo-code for the algorithm retrieveMethodsForBusinessClasses;

FIG. 68 is pseudo-code for the algorithm classDerivationMapping;

FIG. 69 is pseudo-code for the algorithm createClassAndInterfaceTemplates;

FIG. 70 is pseudo-code for the algorithm expressExtendInterfaceAsContextVariables;

FIG. 71 is pseudo-code for the algorithm expressInterfacePackageAsContextVariables;

FIG. 72 is pseudo-code for the algorithm expressInterfaceNameAsContextVariables;

FIG. 73 is pseudo-code for the algorithm expressSuperclassPackageAsContextVariables;

FIG. 74 is pseudo-code for the algorithm expressSuperclassNameAsContextVariables;

FIG. 75 is pseudo-code for the algorithm expressClassPackageAsContextVariables;

FIG. 76 is pseudo-code for the algorithm expressClassNameAsContextVariables;

FIG. 77 is pseudo-code for the algorithm attributeDerivationMapping;

FIG. 78 is pseudo-code for the algorithm createAttributeTemplates;

FIG. 79 is pseudo-code for the algorithm expressAttributeNameAsContextVariables;

FIG. 80 is pseudo-code for the algorithm expressAttributeTypeAsContextVariables;

FIG. 81 comprises FIG. 81A and FIG. 81B and is pseudo-code for the algorithm methodDerivationMapping;

FIG. 82 comprises FIG. 82A and FIG. 82B and is pseudo-code for the algorithm createMethodTemplates;

FIG. 83 is pseudo-code for the algorithm expressMethodNameAsContextVariables;

FIG. 84 is pseudo-code for the algorithm expressReturnTypeAsContextVariables;

FIG. 85 is pseudo-code for the algorithm expressParametersAsContextVariables;

FIG. 86 is pseudo-code for the algorithm abstractBodyOfMethodTemplates; and

FIG. 87 is pseudo-code for the algorithm replaceConcreteInstancesWithContextVariables;

FIG. 88 is pseudo-code for the algorithm updateBusinessClasses;

FIG. 89 is pseudo-code for the algorithm updateAttributesForBusinessClasses;

FIG. 90 is pseudo-code for the algorithm updateMethodsForBusinessClasses;

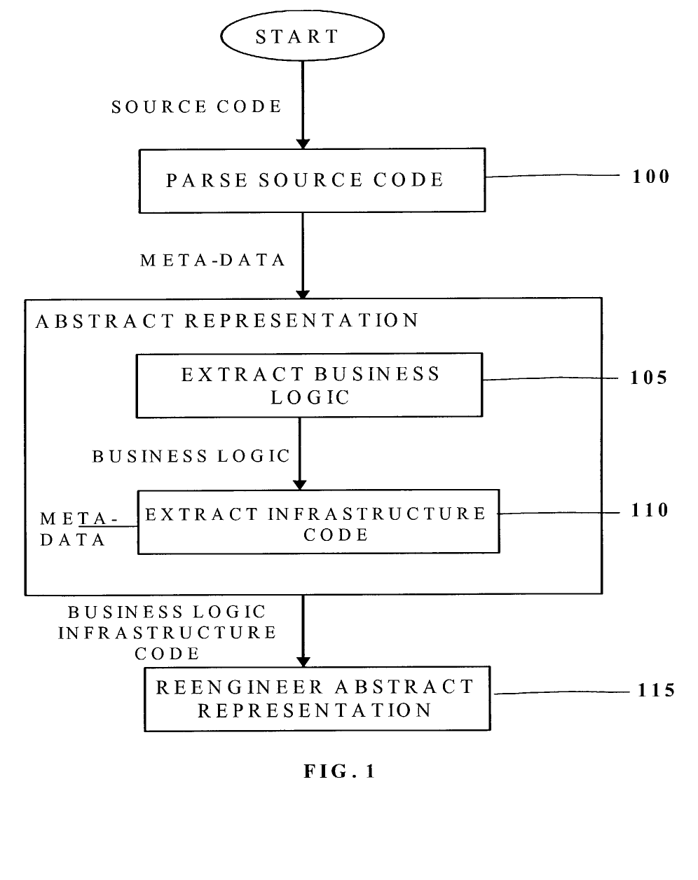

In the figures, [ref to patent] refers to international patent application PCT/CA99/00929 filed Oct. 12, 1999 by the Applicant.

### DETAILED DESCRIPTION OF THE PREFERRED EMBODIMENTS

While illustrated in the block diagrams as groups of discrete components communicating with each other via distinct data signal connections, it will be understood by those skilled in the art that the preferred embodiments are provided by a combination of hardware and software components, with some components being implemented by a given function or operation of a hardware or software system, and many of the data paths illustrated being implemented by data communication within a computer application or operating system. The structure illustrated is thus provided for efficiency of teaching the present preferred embodiment.

SCENARIO 1

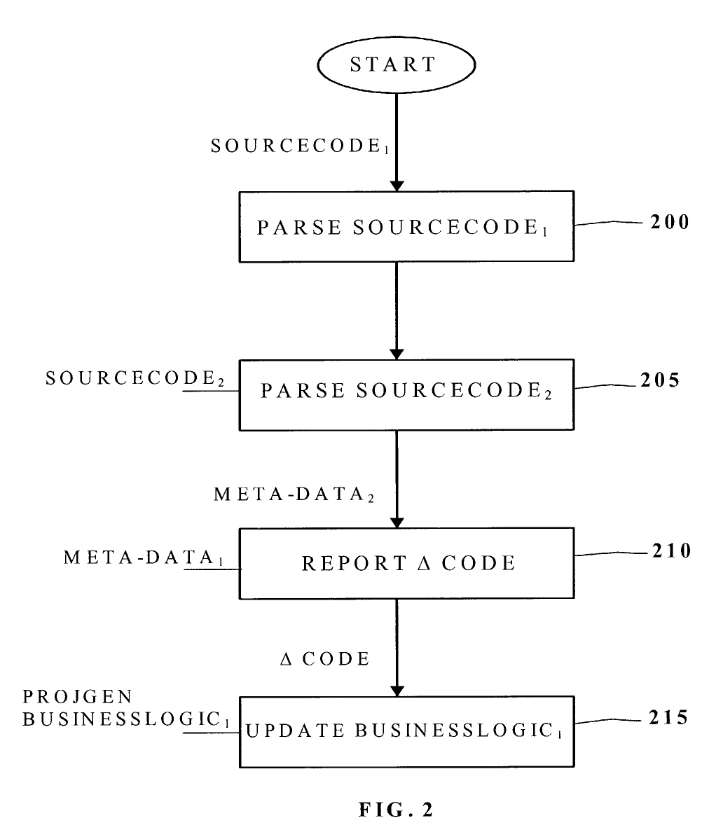

Let sourceCode1 be a component-based source code, businessLogic1 be the abstract representation of its business logic, and projGen a set of generation templates used to generate sourceCode1 from businessLogic1 [see international patent application PCT/CA99/00929 filed Oct. 12, 1999 by the applicant]. Assuming that sourceCode1 has evolved to sourceCode2, to ensure the consistency between source code and its abstract representation, the reverse-engineering engine follows the process described in FIG. 2. This process consists of four steps: parse sourceCode1, parse sourceCode2, report Δ code, and update businessLogic1 to be compliant with sourceCode2. Note that the first step is optional if sourceCode1 does not exist.

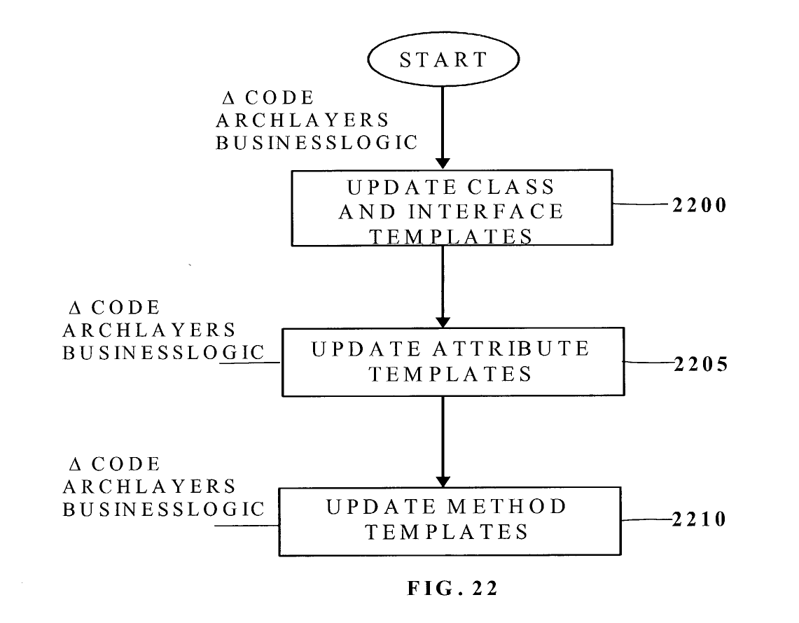

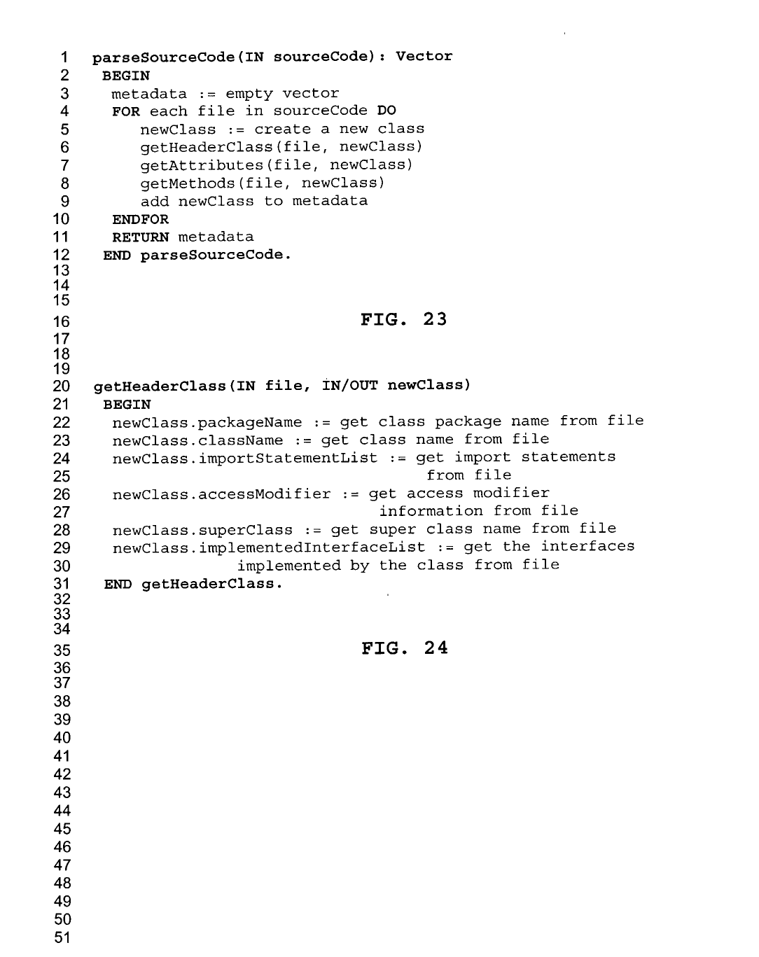

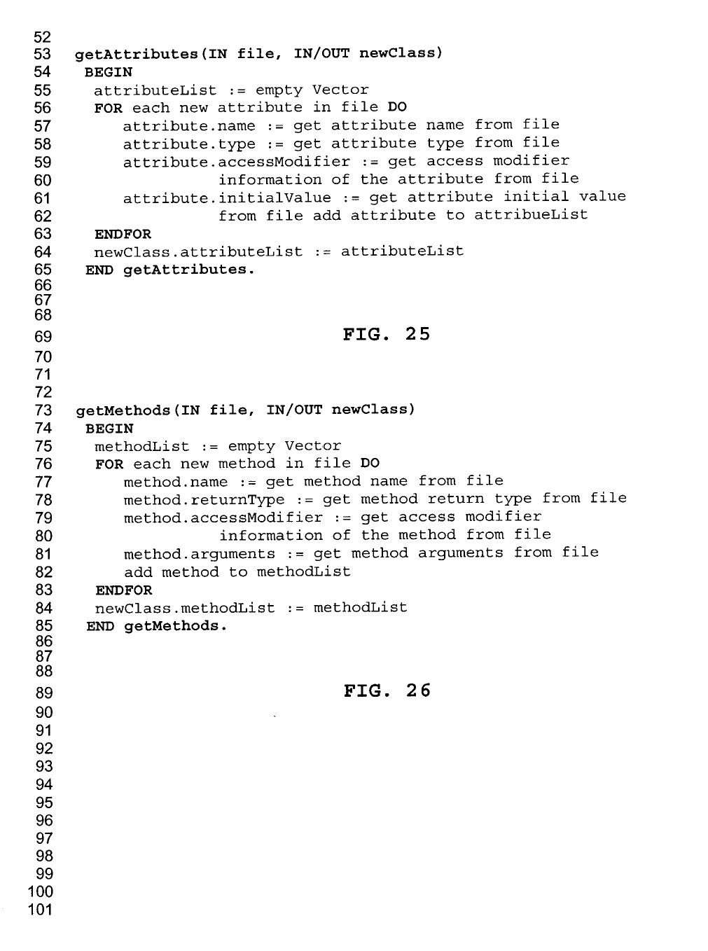

The parsing steps (200 and 205) consist of getting the meta-data of source code including packages, classes, class and component attributes, and class and component methods. Note that non-primitive attributes are considered as associations between classes. The algorithm for the parsing steps is described in FIG. 23, the pseudo-code for the algorithm parseSourceCode. FIG. 24, is the pseudo-code for the algorithm getHeaderClass. FIG. 25, is the pseudo-code for the algorithm getAttributes, and FIG. 26, is the pseudo-code for the algorithm getMethods.

The step ‘report Δ code’ (210) provides the following information:

What are the classes of sourceCode2 that do not exist in sourceCode1?

What are the classes of sourceCode1 that do not exist anymore in sourceCode2?

What are the classes of sourceCode1 that are changed in sourceCode2?

For each changed class of sourceCode2,

What are the new attributes?

What are the suppressed attributes?

What are the updated attributes?

What are the new methods?

What are the suppressed methods?

What are the updated methods?

What are the new associations?

What are the suppressed associations?

What are the updated associations?

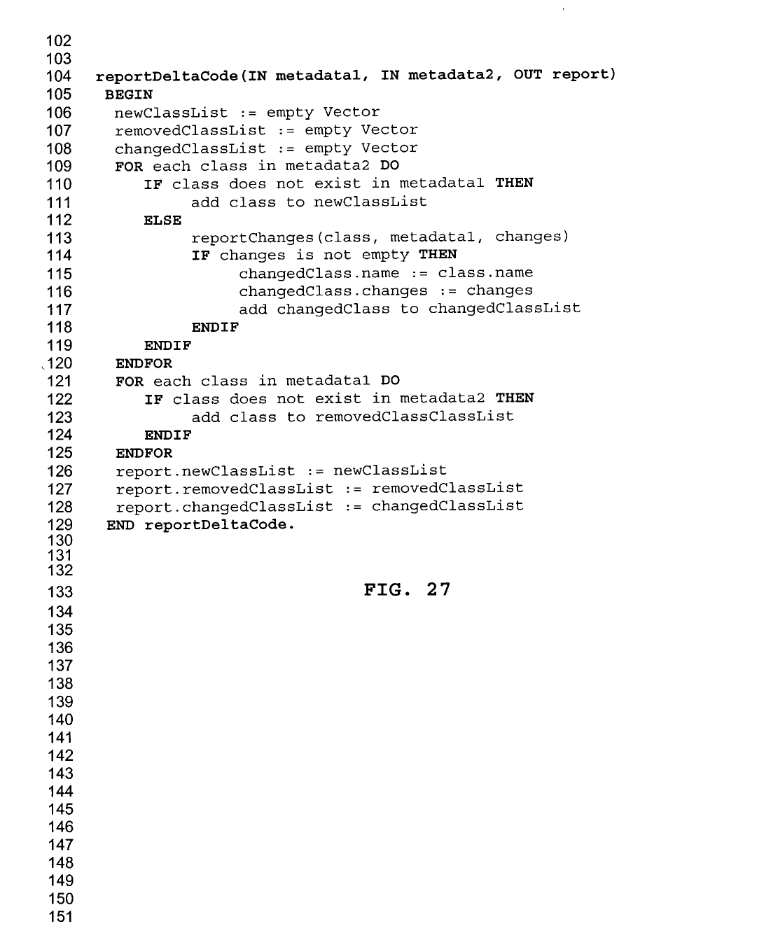

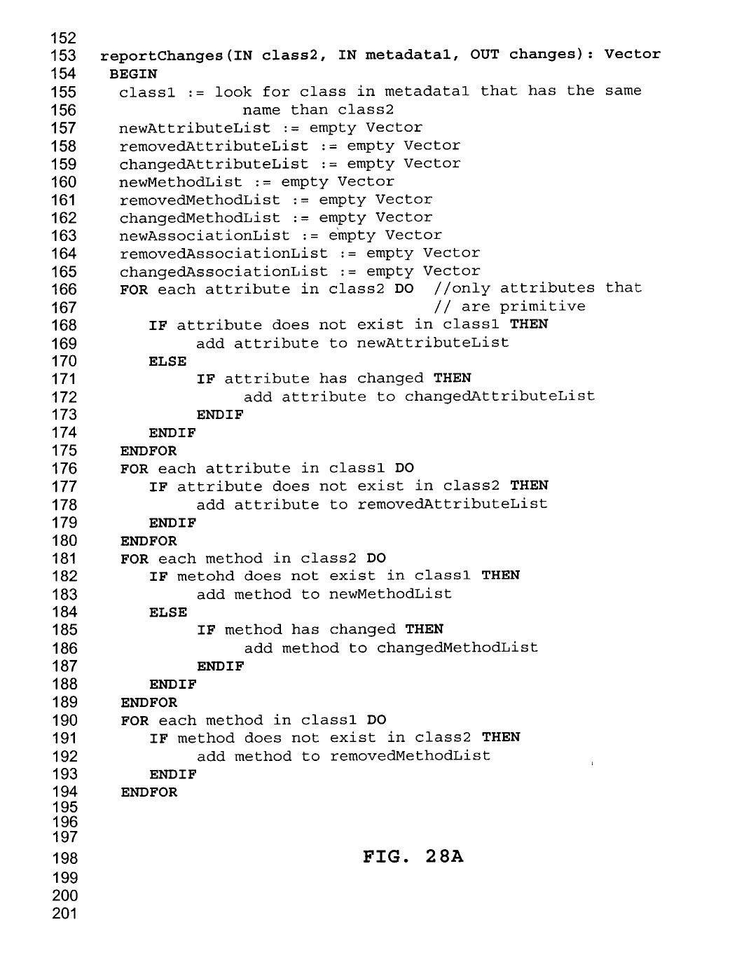

The algorithm of step 210 is described in FIG. 27, the pseudo-code for the algorithm reportDeltaCode and FIG. 28, which comprises FIG. 28A and FIG. 28B which is the pseudo-code for the algorithm reportChanges.

The last step, ‘update businessLogic1,’ (215) consists of updating the abstract representation of the component source code with the information reported by the preceding step and filtered with the generation templates contained in projGen. In fact, the abstract representation is not polluted with the portions of source code that are generated from user-selected generation templates. The algorithm of the step 215 is described in FIG. 29, which is pseudo-code for the algorithm updateBusinessLogic, FIG. 30, which is pseudo-code for the algorithm isClassInfrastructureCode, FIG. 31, which is pseudo-code for the algorithm isAttributeInfrastructureCode, and FIG. 32, which is pseudo-code for the algorithm isMethodInfrastructureCode.

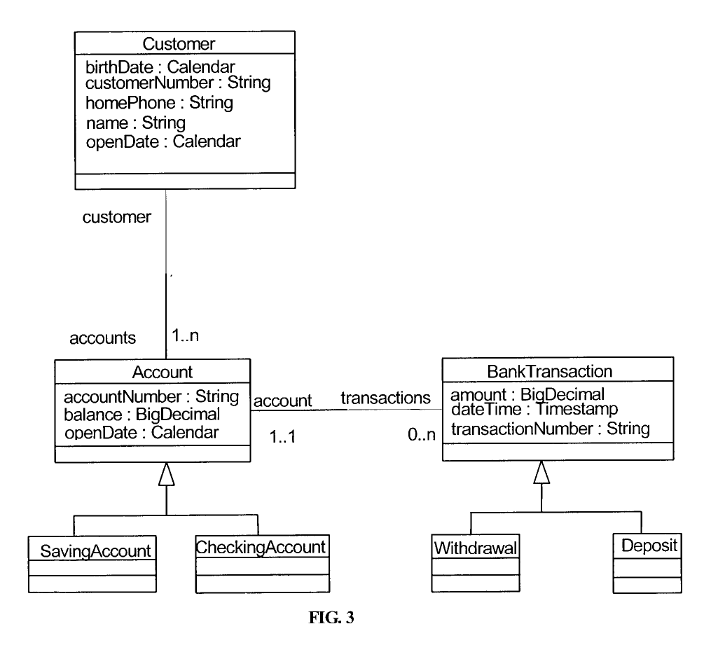

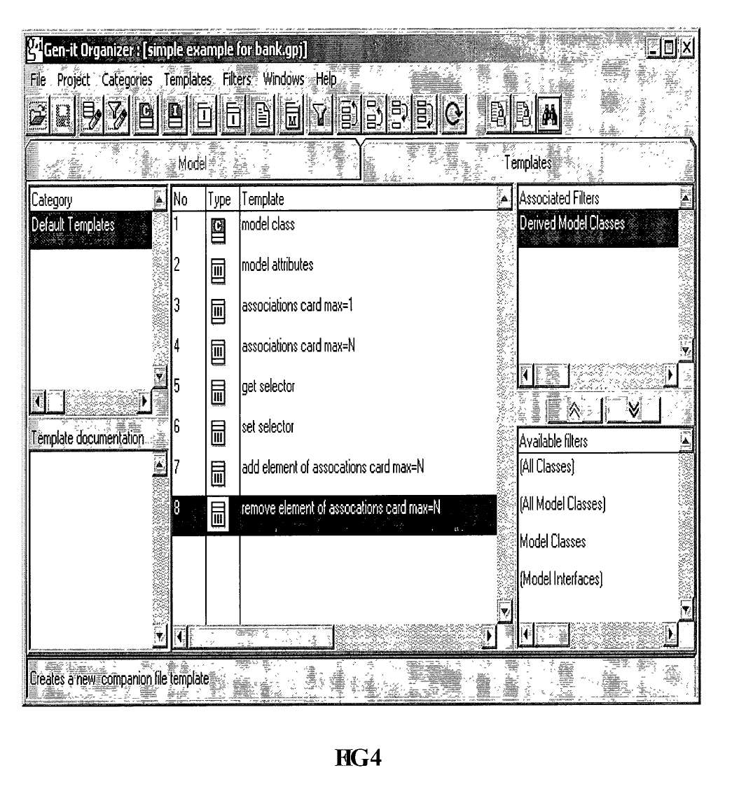

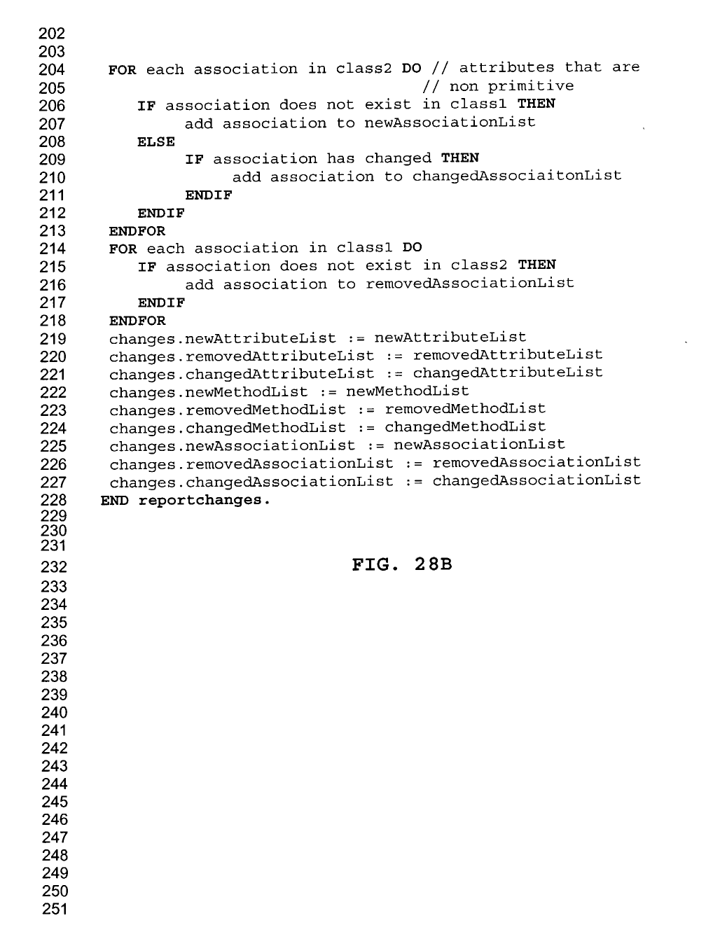

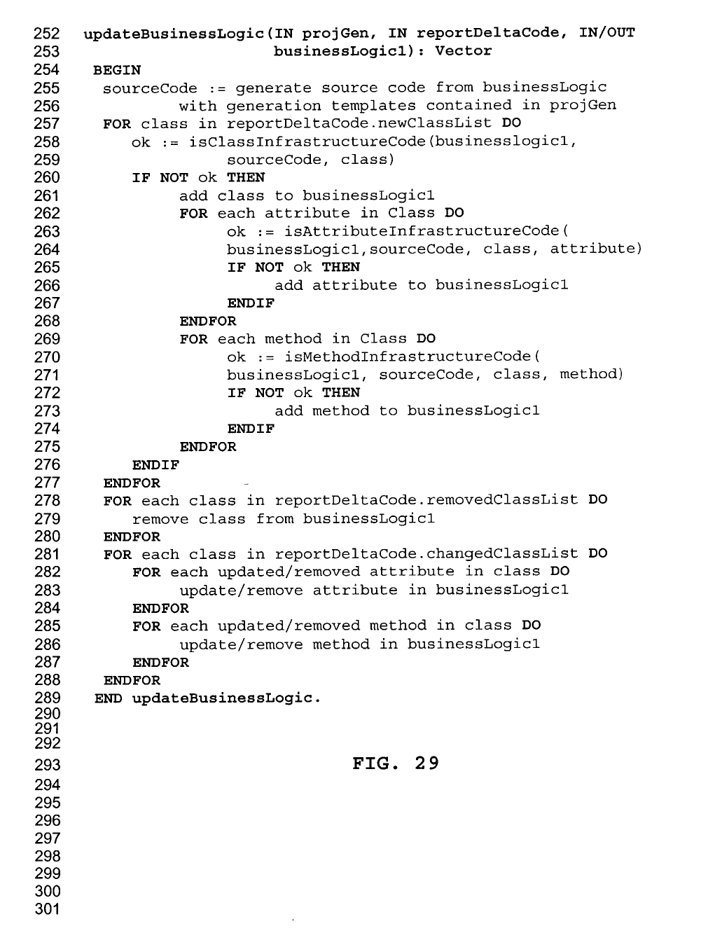

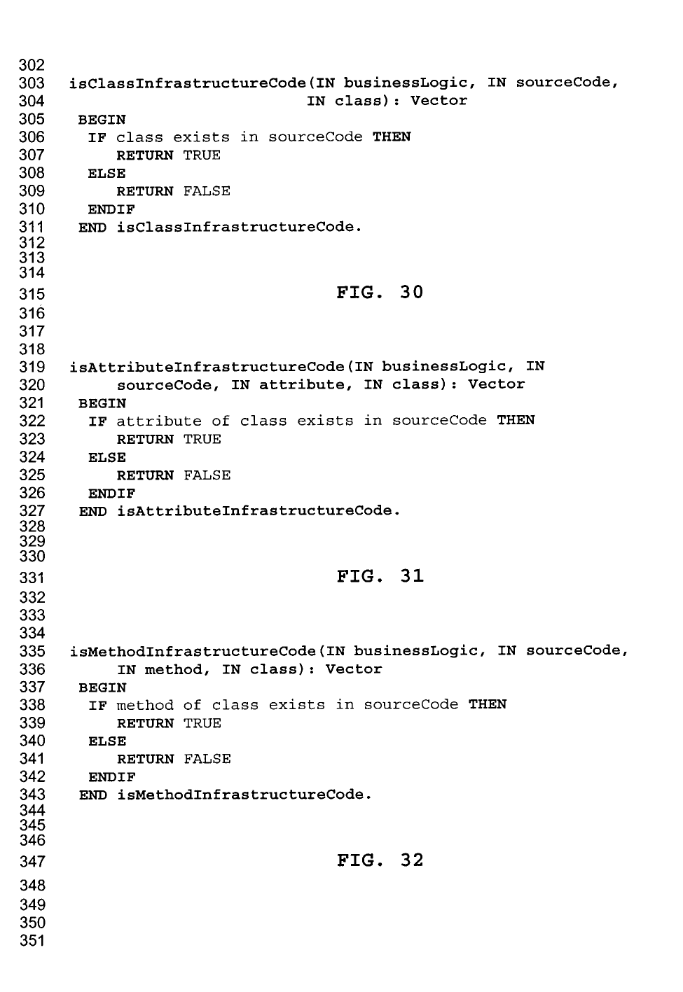

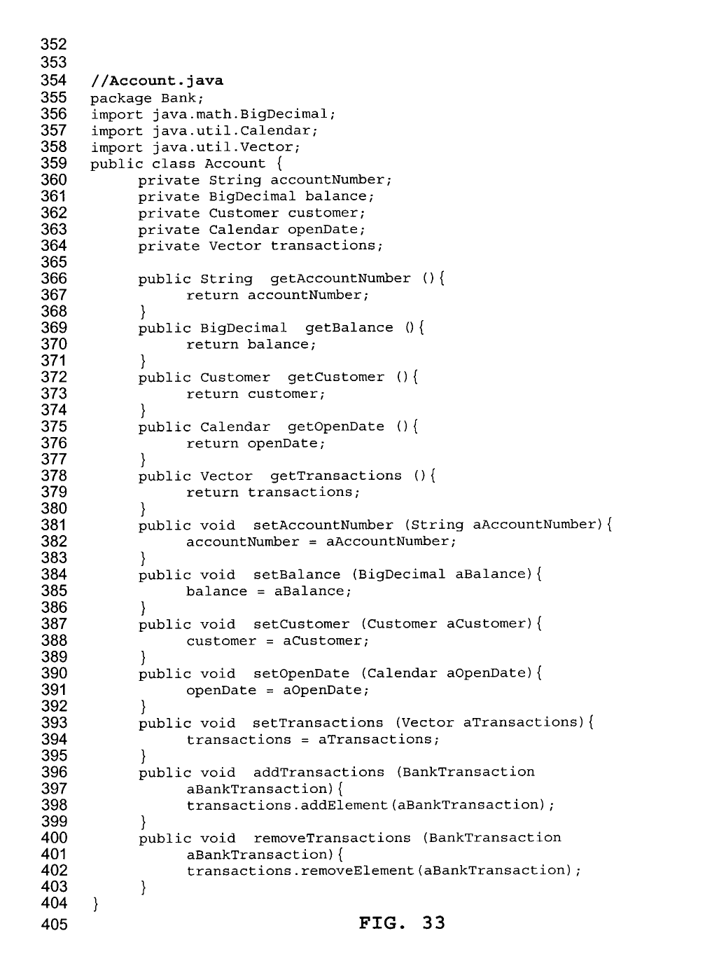

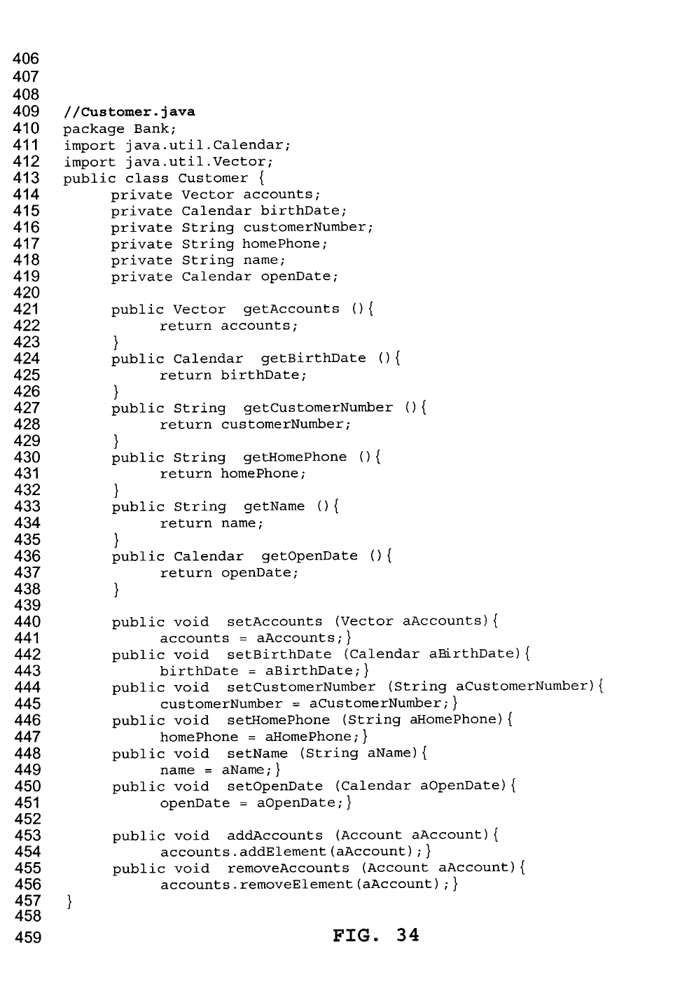

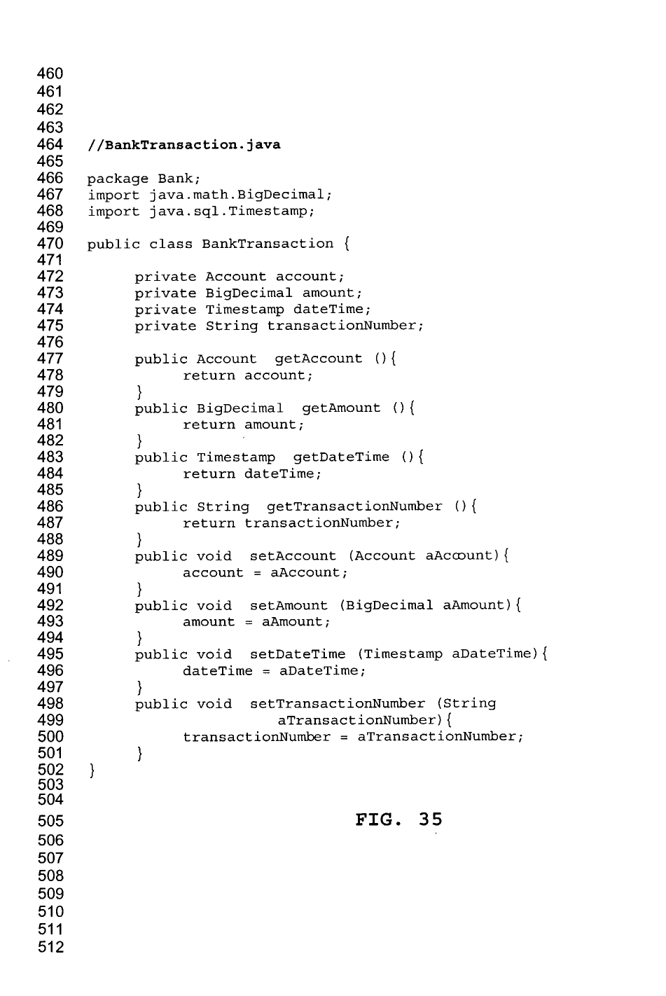

FIG. 3 shows the higher abstract representation (businessLogic1) of a simplified version of a Bank system. This system consists of seven business objects: ‘Customer’, ‘Account’, ‘SavingAccount’, ‘CheckingAccount’, ‘BankTransaction’, ‘Withdrawal’, and ‘Deposit.’ A customer could have one or many accounts. An account could be a savings account or a checking account. A transaction, which could be a withdrawal or a deposit, is performed on one account. FIG. 4 shows eight generation templates: ‘model class’, ‘model attributes’, ‘association card max=1’, ‘association card max=N’, ‘get selector’, ‘set selector’, ‘add element of associations card max=N’, and ‘remove element card max=N’. These templates are transformations rules that enable the generation from businessLogic1 of the source code (sourceCode1) presented in FIGS. 33-39. FIG. 33 is the source code of the class Account. FIG. 34 is the source code of the class Customer. FIG. 35 is the source code of the class BankTransaction. FIG. 36 is the source code of the class CheckingAccount. FIG. 37 is the source code of the class SavingAccount. FIG. 38 is the source code of the class Withdrawal. Finally, FIG. 39 is the source code of the class Deposit.

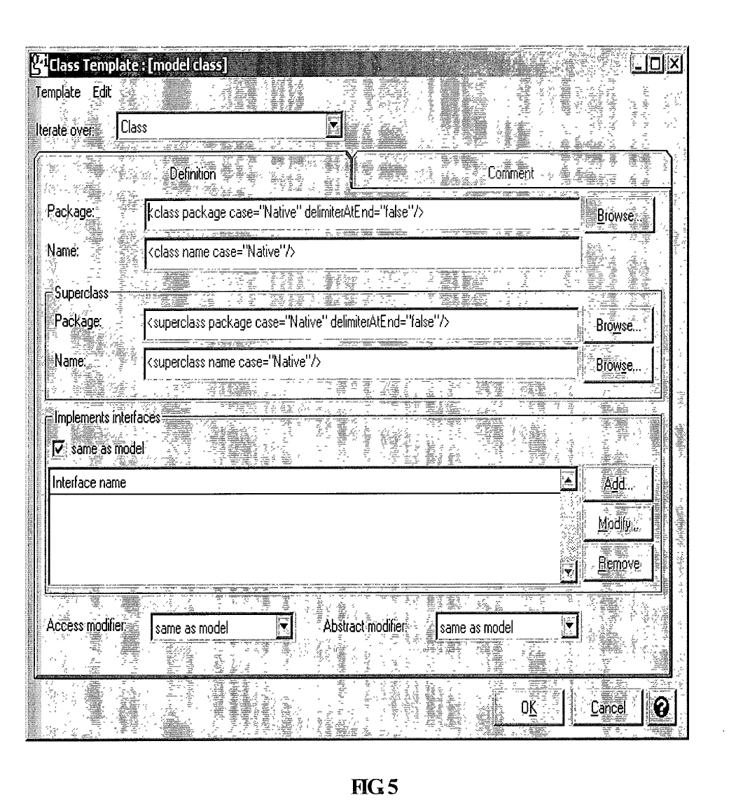

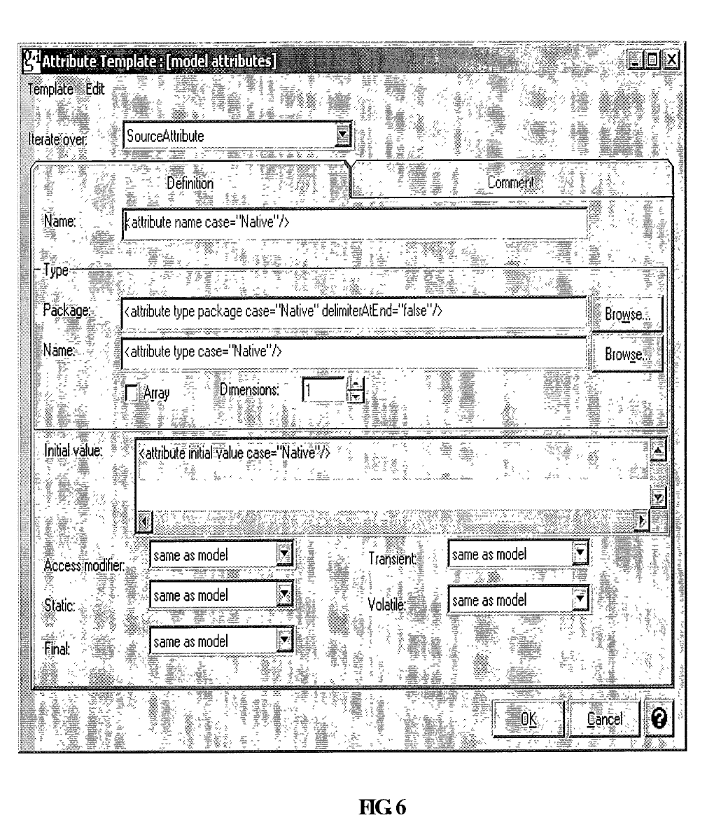

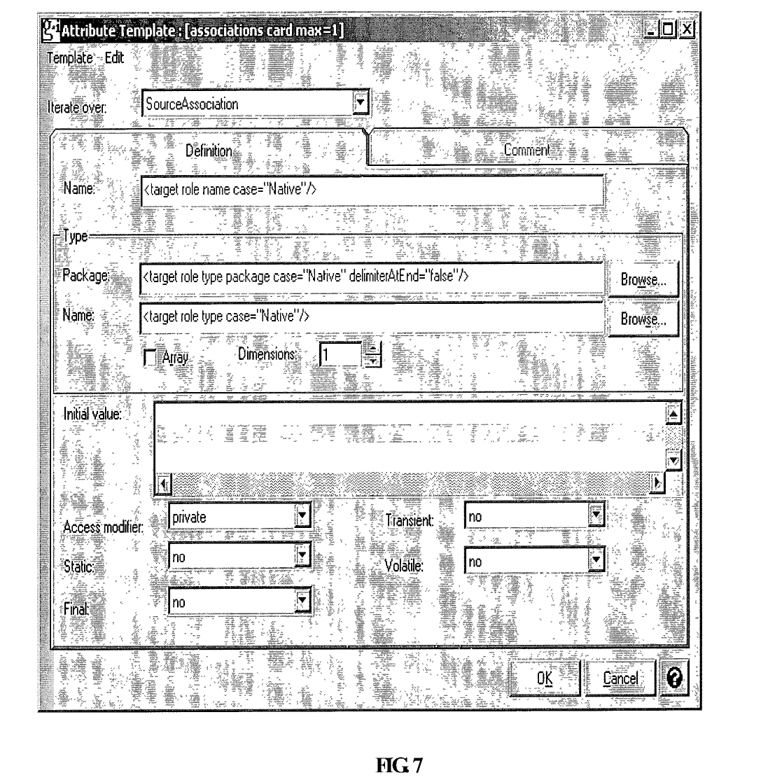

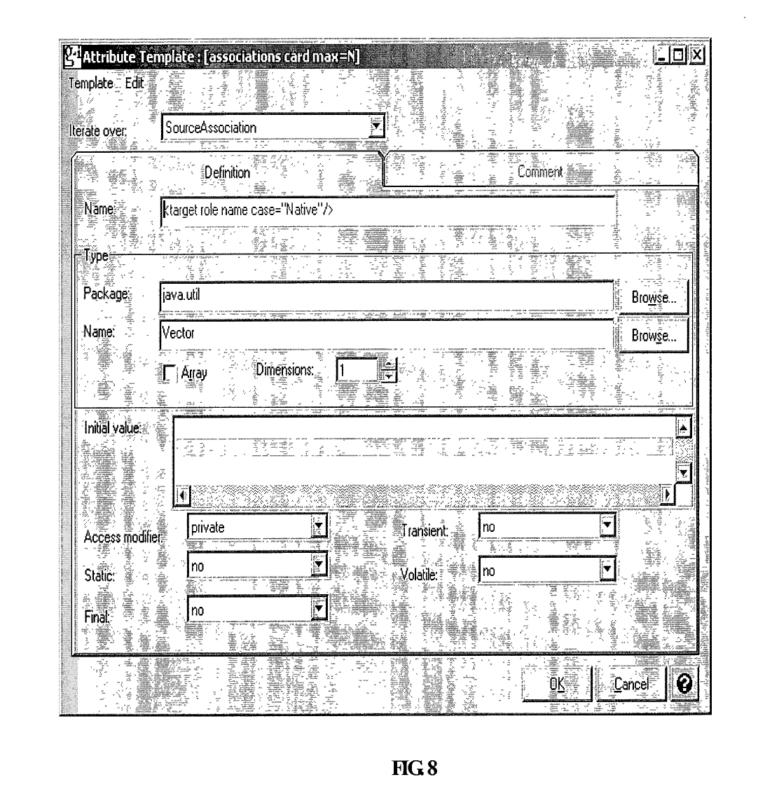

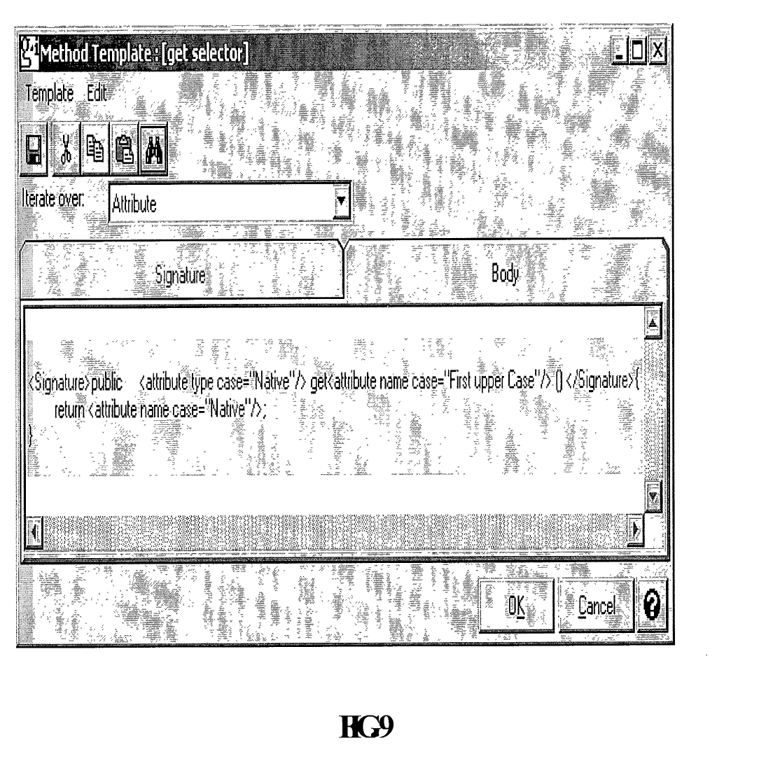

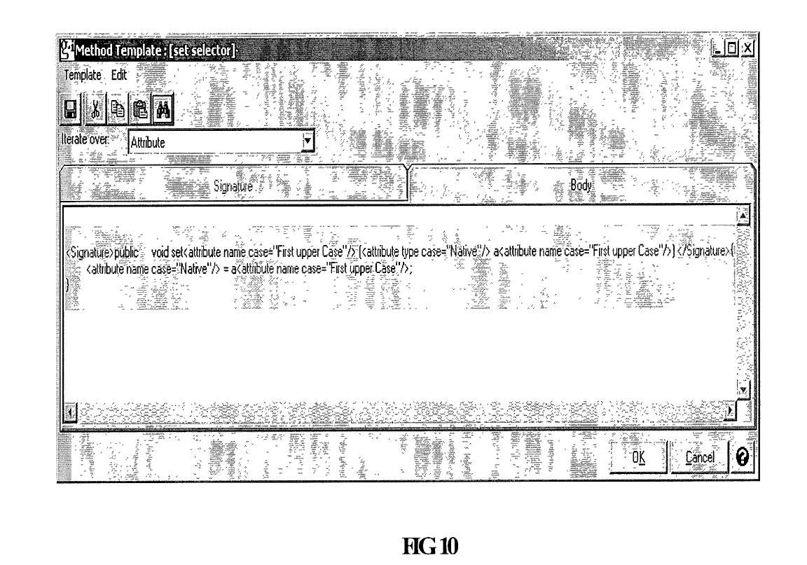

FIGS. 5-12 present the details of these generation templates. For instance, FIG. 9 shows the template ‘get selector’ that generates one get selector method for each attribute of the business objects. It generates, for example, the method ‘getCustomerNumber’ in the ‘Account’ class for the attribute ‘customerNumber’.

The source code described above has evolved to sourceCode2. This evolution consists of:

A new attribute ‘workPhone’ of type ‘String’ in the class ‘Customer’

A new method ‘getWorkPhone’ in the class ‘Customer’.

A new method setWorkPhone in the class ‘Customer’.

A new attribute ‘currrency’ of type ‘Currency’ in the class ‘Account’

A new method ‘getCurrency’ in the class ‘Account’.

A new method setCurrency in the class ‘Account’.

A new class ‘Currency’ as described in FIG. 40.

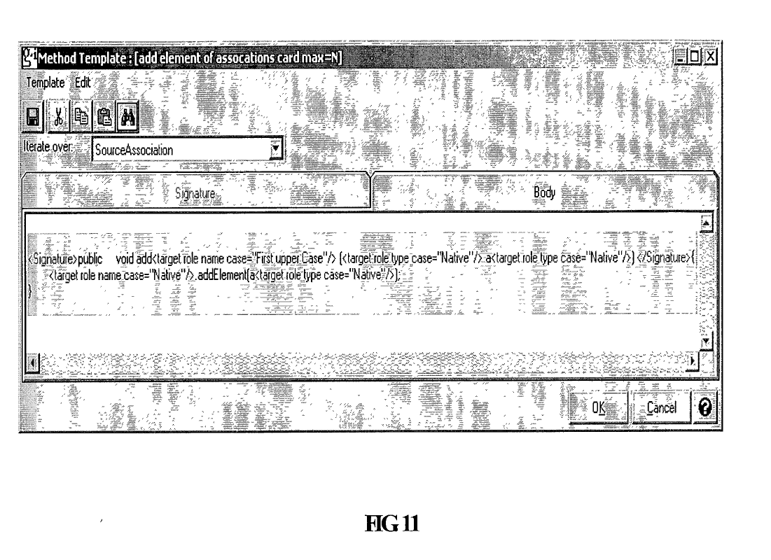

Assuming that all the generation templates are selected by the user as the filter for the process of ensuring the consistency between sourceCode2 and businessLogic1, the process will update businessLogic1 by adding to the model (see FIG. 13):

A new attribute ‘workPhone’ of type ‘String’ in the class ‘Customer’

A new class ‘Currency’ with three attributes:

An attribute ‘currencyType’ of type ‘String’.

An attribute ‘name’ of type ‘String’.

An attribute ‘shortName’ of type ‘String’.

A new association between the classes ‘Account’ and ‘Currency’.

Note that all implementation details (get and set selector methods) are not reflected in businessLogic1 since they are filtered by the generation templates ‘get selector’ and ‘set selector.’ In fact, when handling these methods, the engine in step 215 (see the algorithm of the function updateBusinessLogic), does not add these methods since they are infrastructure code. Therefore the function ‘isMethodInfrastructureCode’ (line 270) returns ‘True,’ as the methods can be generated by the templates ‘get selector’ and ‘set selector’.

SCENARIO 2

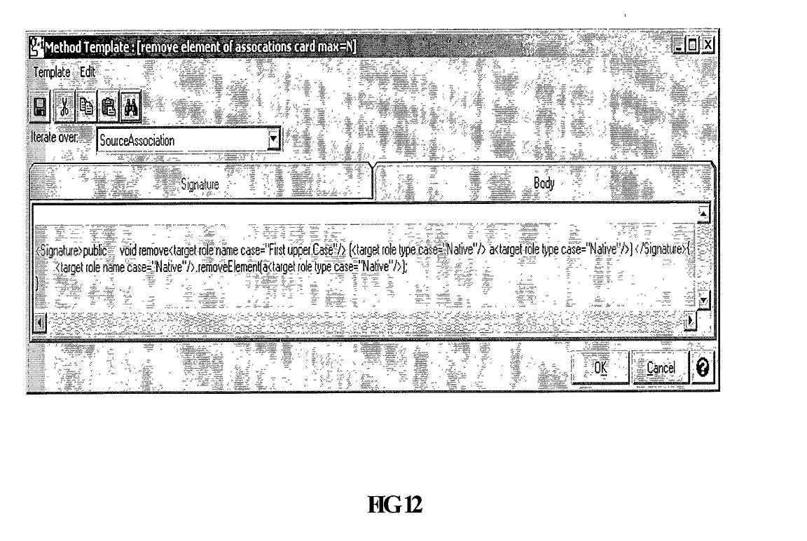

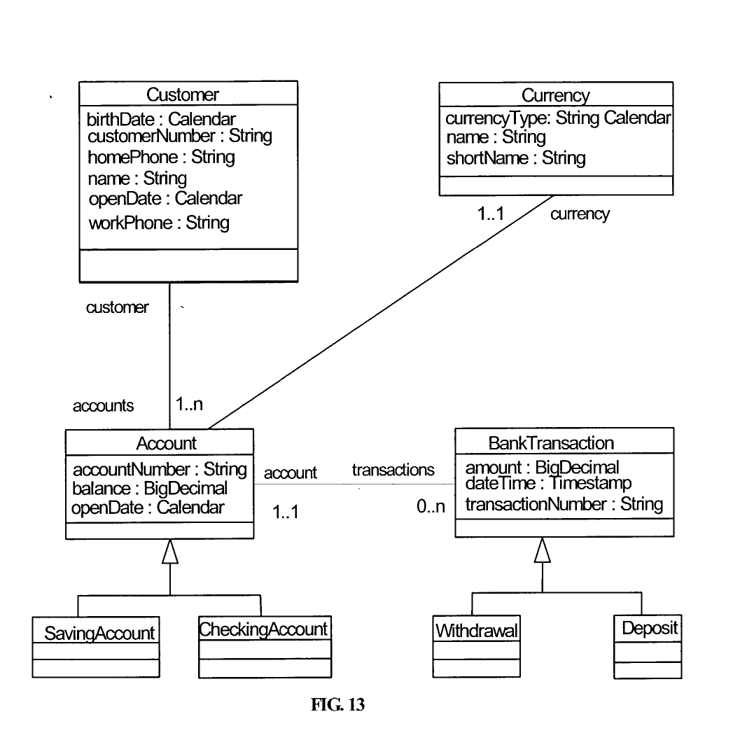

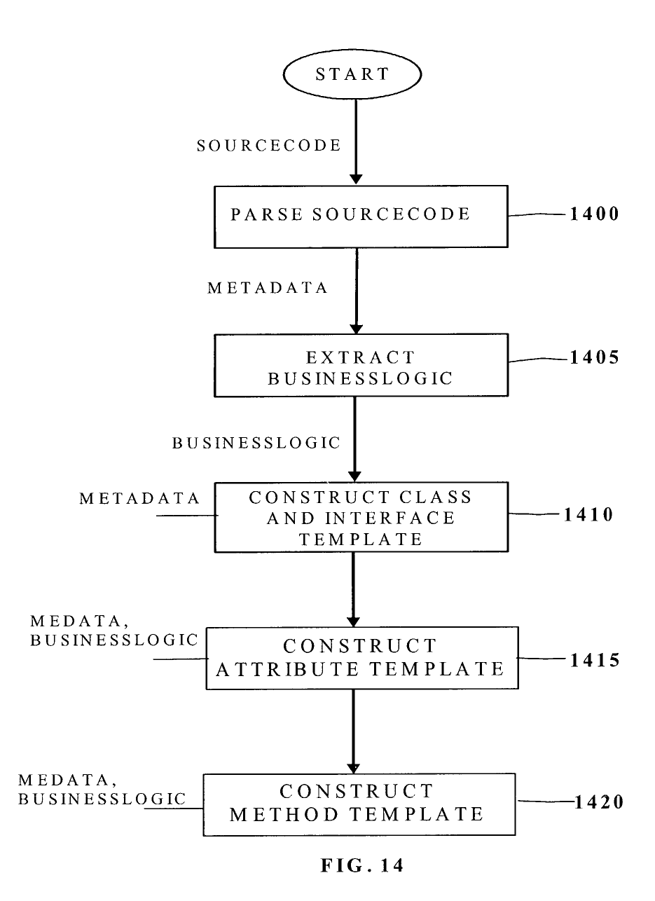

Let sourceCode be component-based source code. Extracting the business logic and generation templates of sourceCode is a process of five steps (see FIG. 14): parse sourceCode, extract businessLogic, construct class and interface templates, construct attribute templates, and construct method templates.

The step ‘parse sourceCode’ (1400) consists of analyzing the source code structurally and is same as the first step (200) of the first scenario.

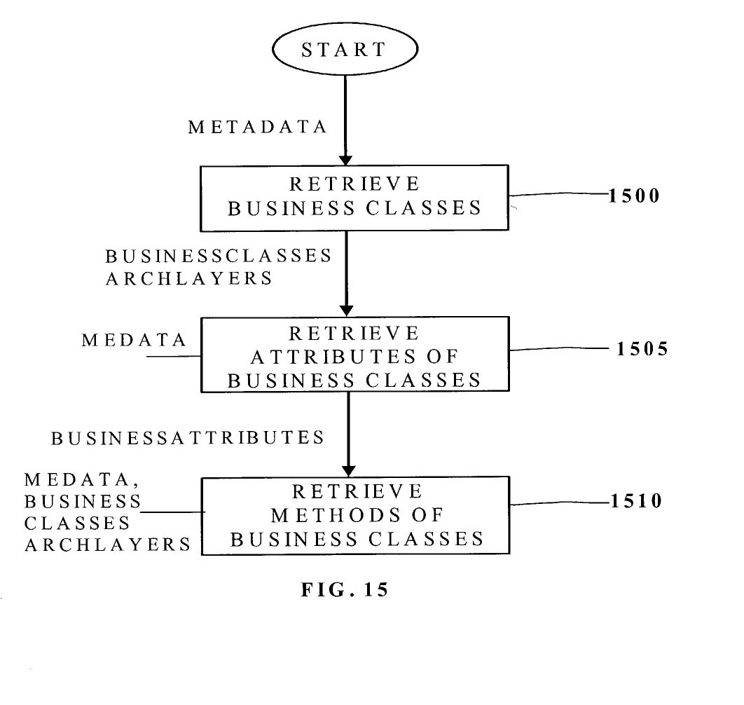

The step ‘extract businessLogic’ (1405) consists of getting from the structural meta-data associated with the business logic of the source code. It comprises three sub-steps (see FIG. 15): retrieve business classes, retrieve attributes of business classes, and retrieve methods of business classes.

The algorithm of retrieving business classes (1500) is presented below. A class is a candidate business class if its name satisfies one of the two following criteria:

It is a pattern of the name of some of the other classes (line 1330), or

Its name does not contain an architectural layer as a pattern (line 1337).

For instance, the source code of a simplified version of a Bank system described in the appendix consists of twenty-one Java classes and interfaces: ‘Account’, ‘BankTransaction’, ‘CheckingAccount’, ‘SavingAccount’, ‘Customer’, ‘Deposit’, ‘Withdrawal, ‘AccountBean’, ‘BankTransactionBean’, ‘CheckingAccountBean’, ‘SavingAccountBean’, ‘CustomerBean’, ‘DepositBean’, WithdrawalBean, ‘AccountHome’, ‘BankTransactionHome’, ‘CheckingAccountHome’, ‘SavingAccountHome’, ‘CustomerHome’, ‘DepositHome’, and ‘WithdrawalHome. The candidate business classes are: ‘Account’, ‘BankTransaction’, ‘CheckingAccount’, ‘SavingAccount’, ‘Customer’, ‘Deposit’, and ‘Withdrawal’. In fact, the name of the ‘Account’ class (i.e. ‘Account’) is a pattern in the name of other classes such as ‘AccountBean’ and ‘AccountHome’. The same reasoning applies to ‘BankTransaction’, ‘CheckingAccount’, ‘SavingAccount’, ‘Customer’, ‘Deposit’, and ‘Withdrawal’.

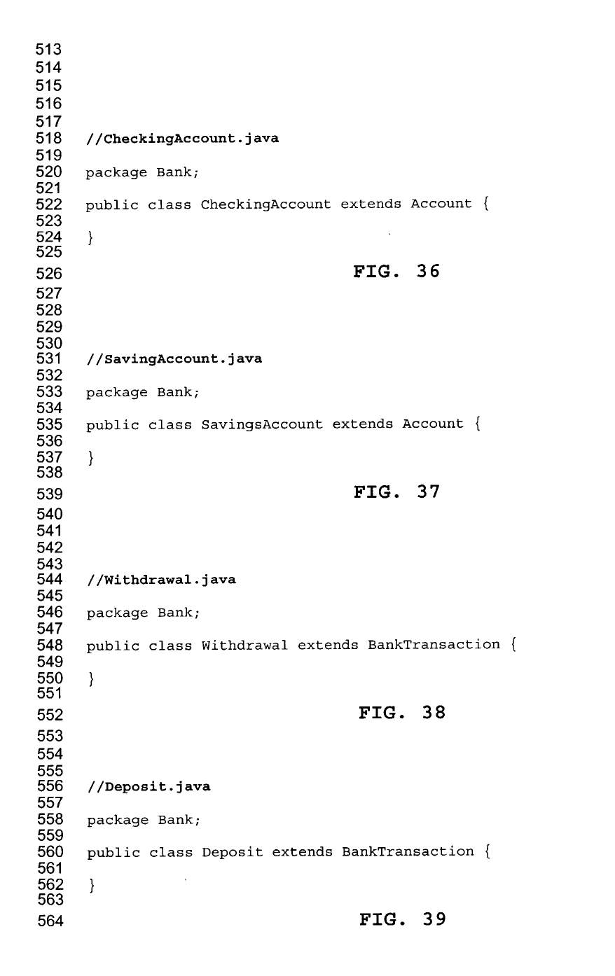

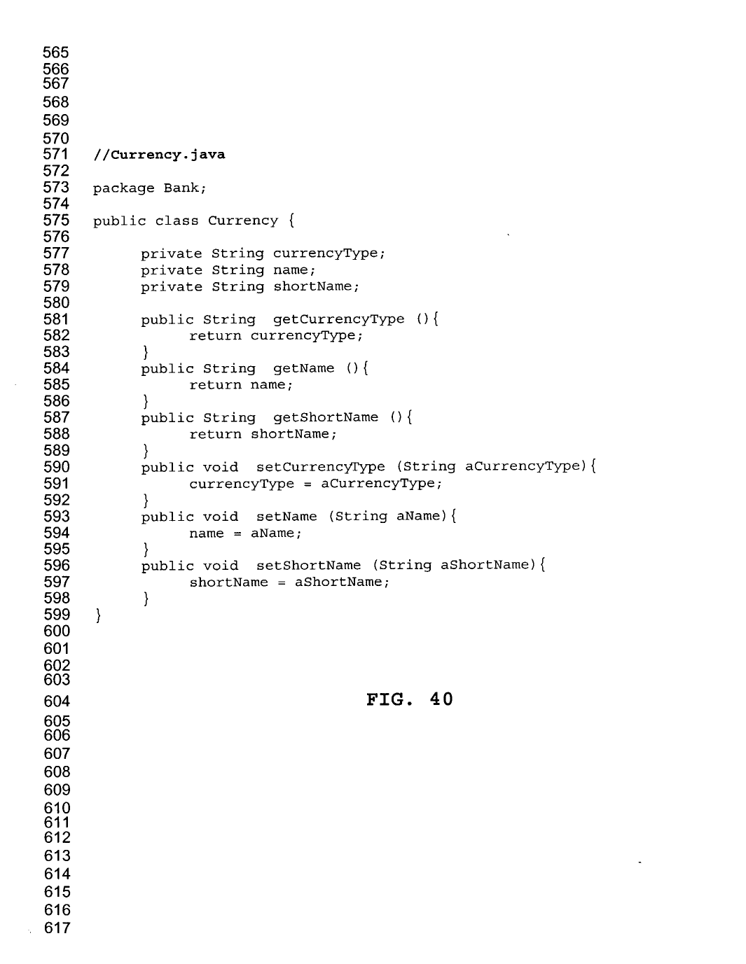

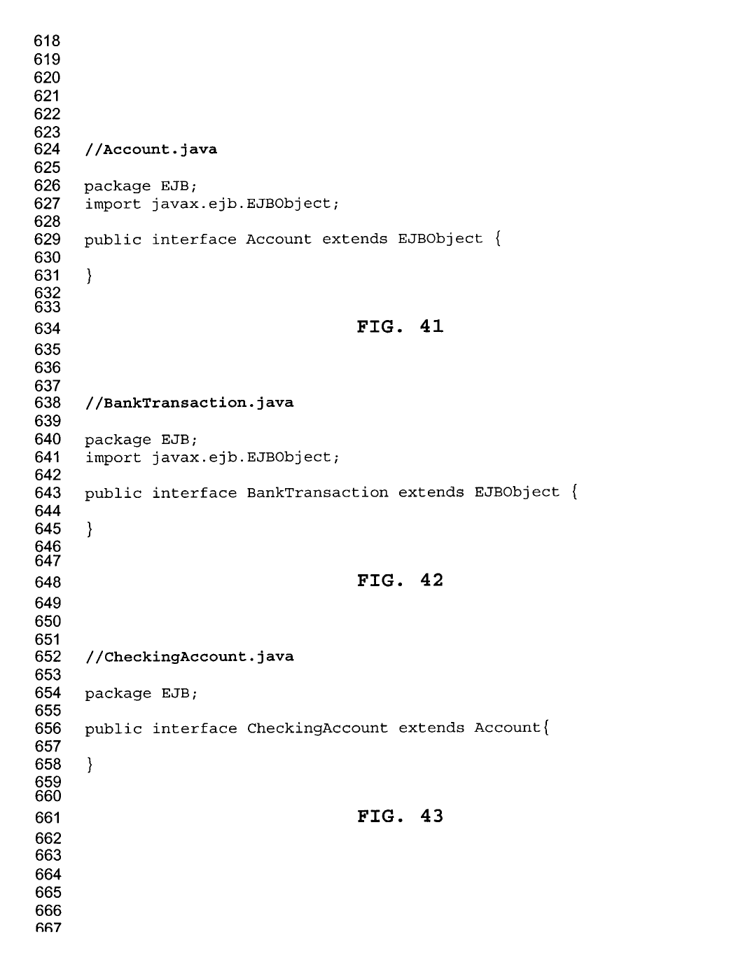

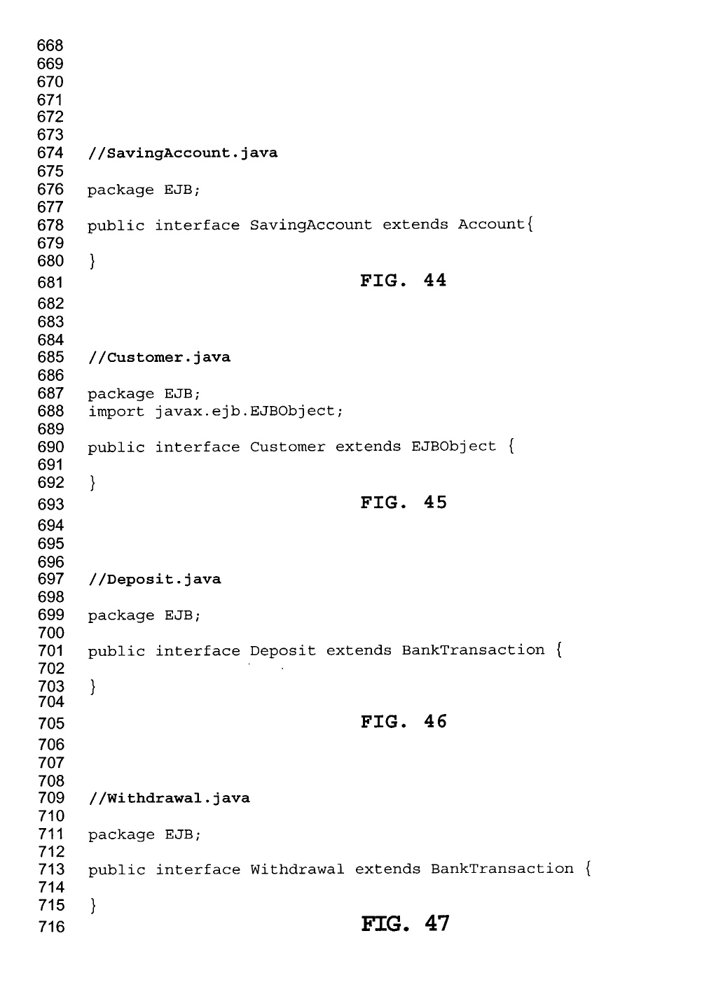

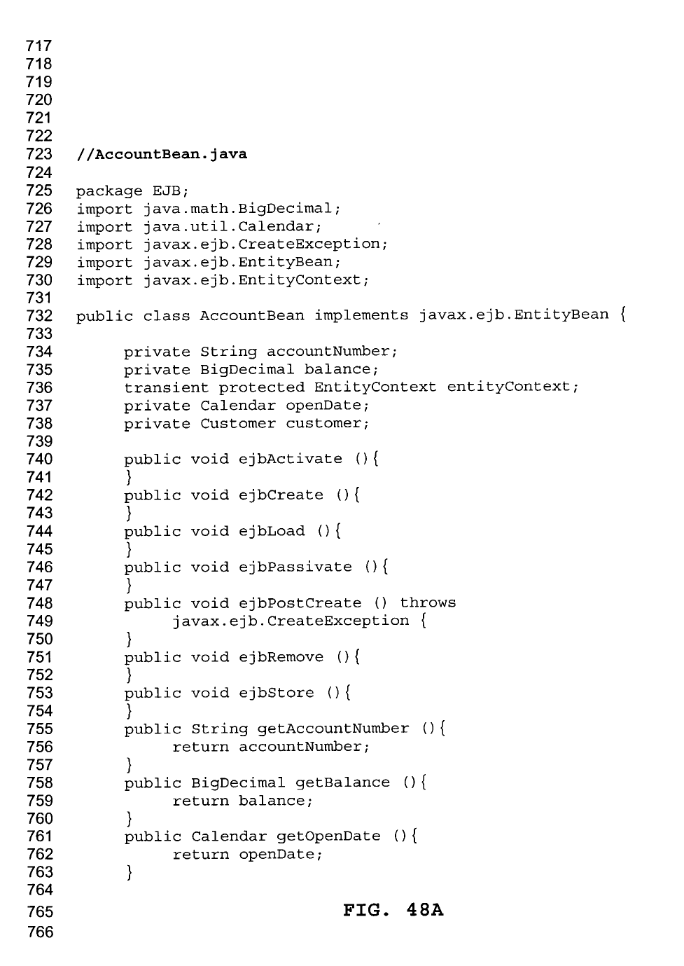

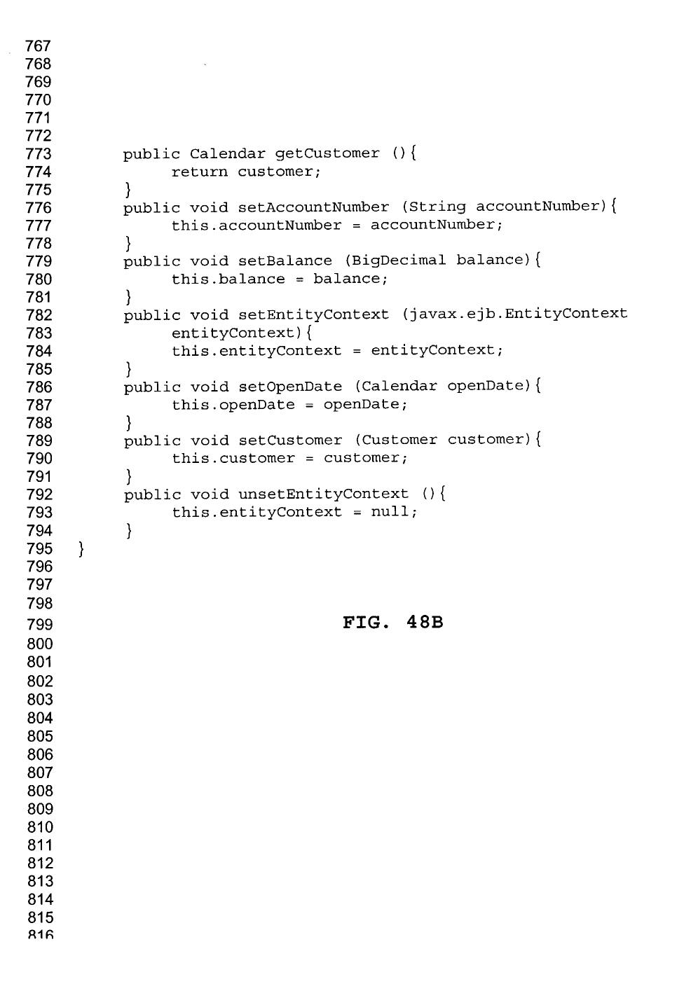

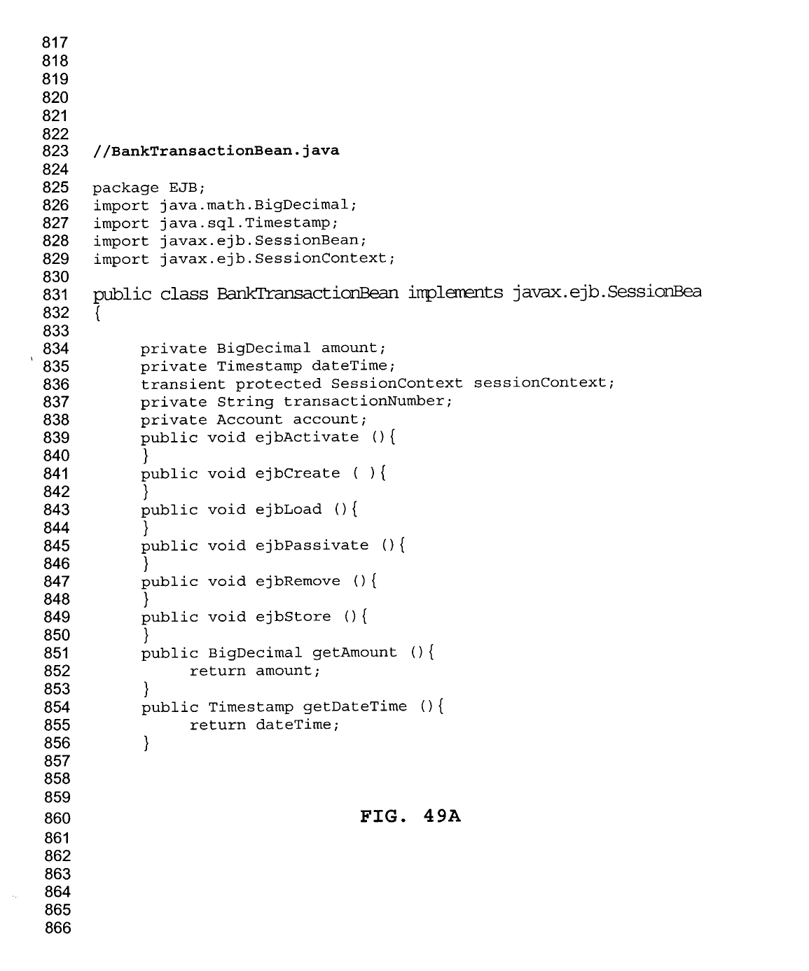

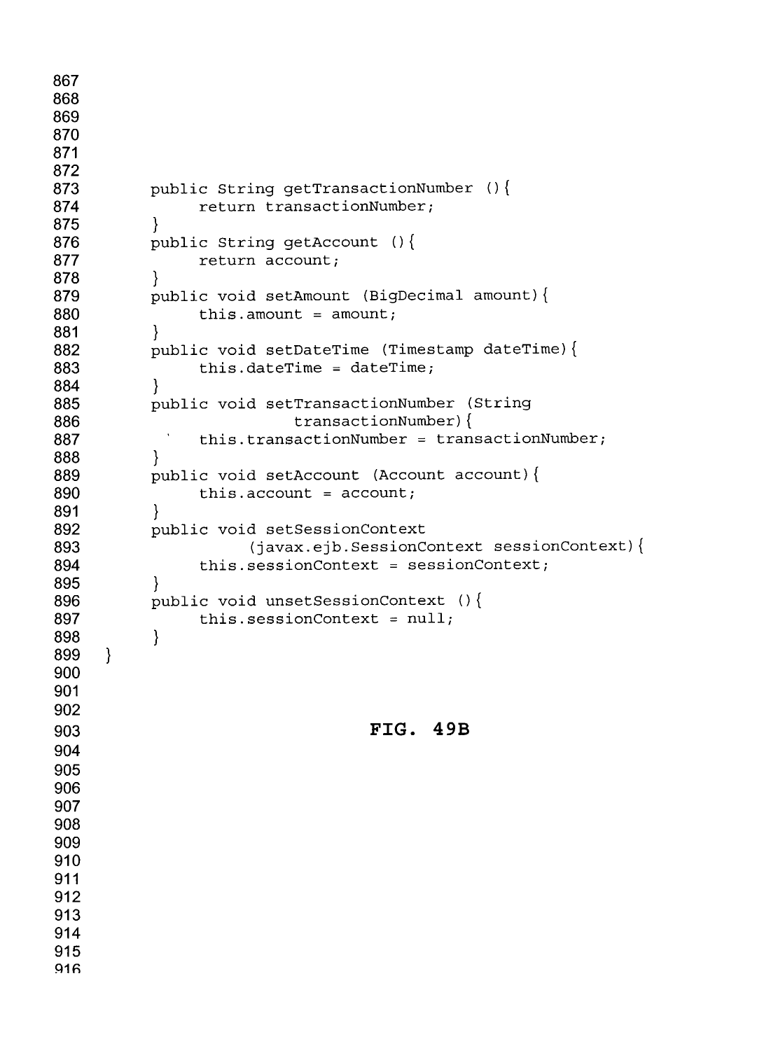

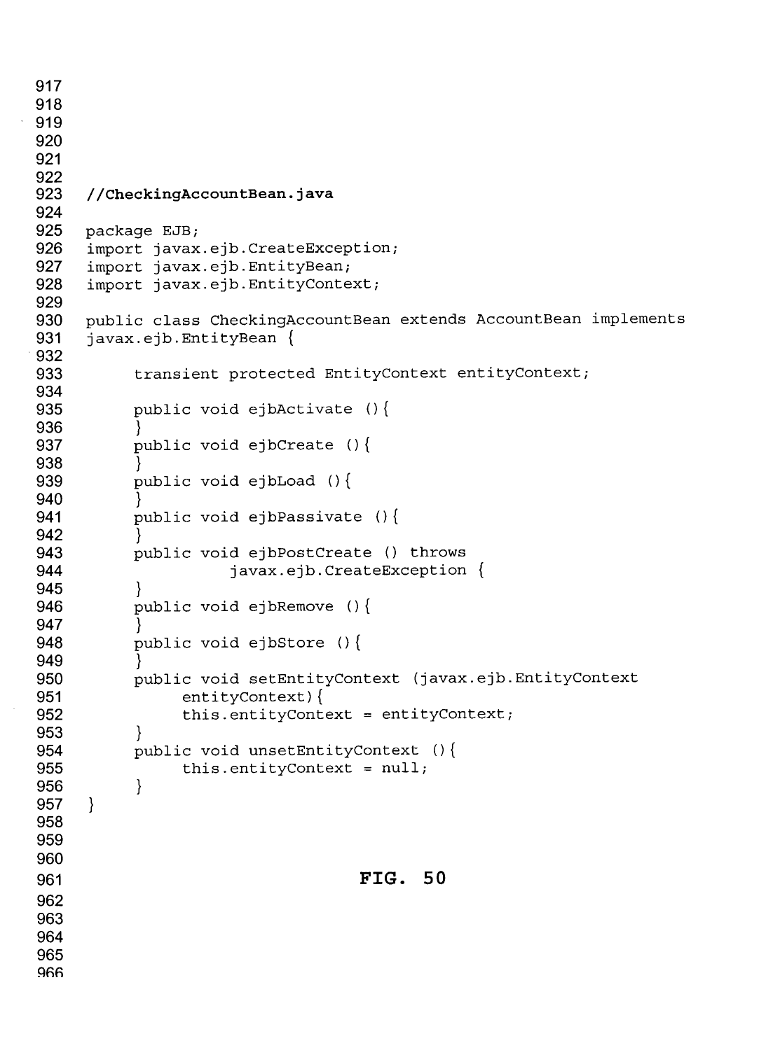

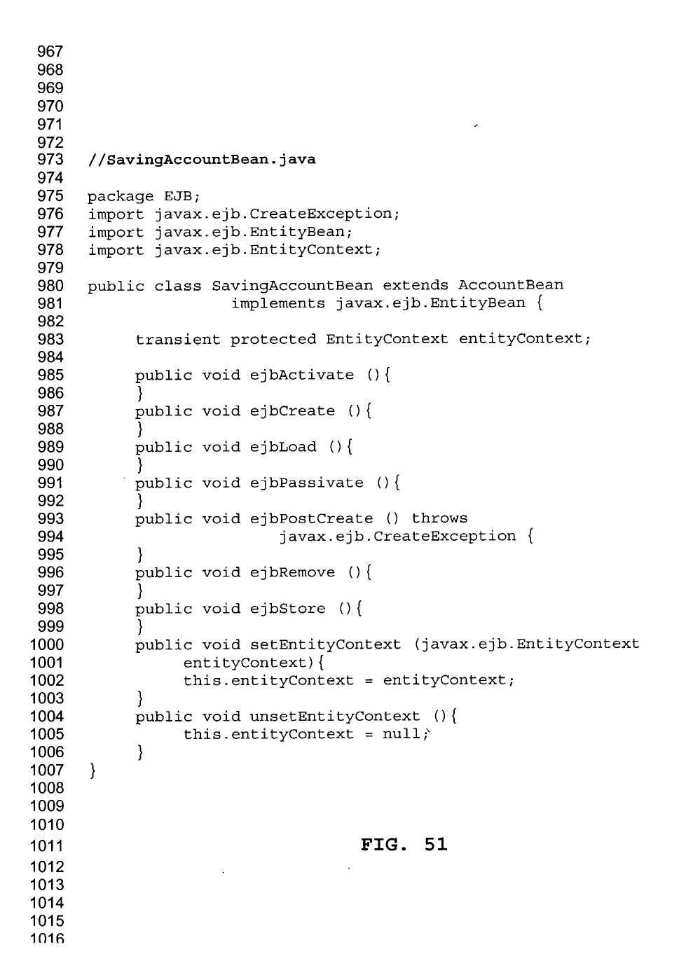

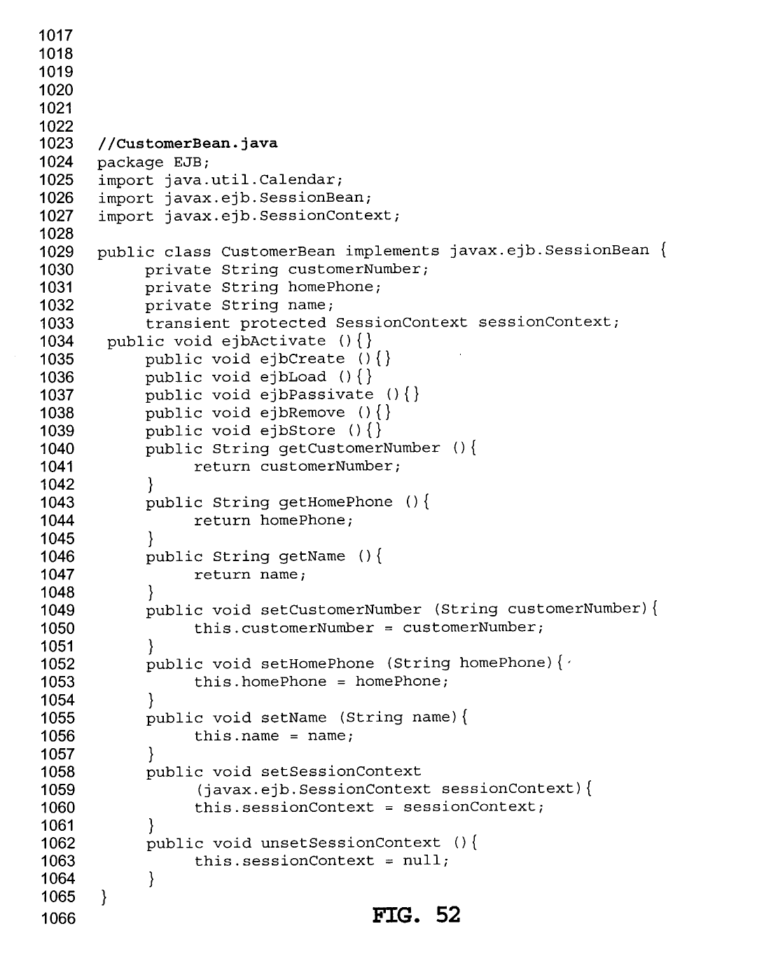

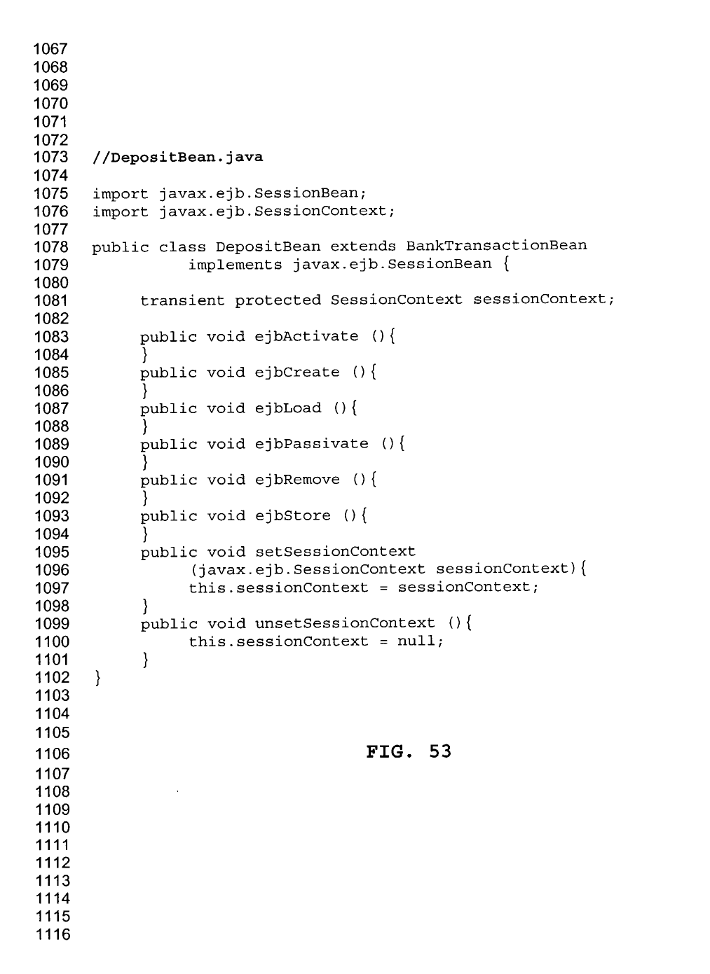

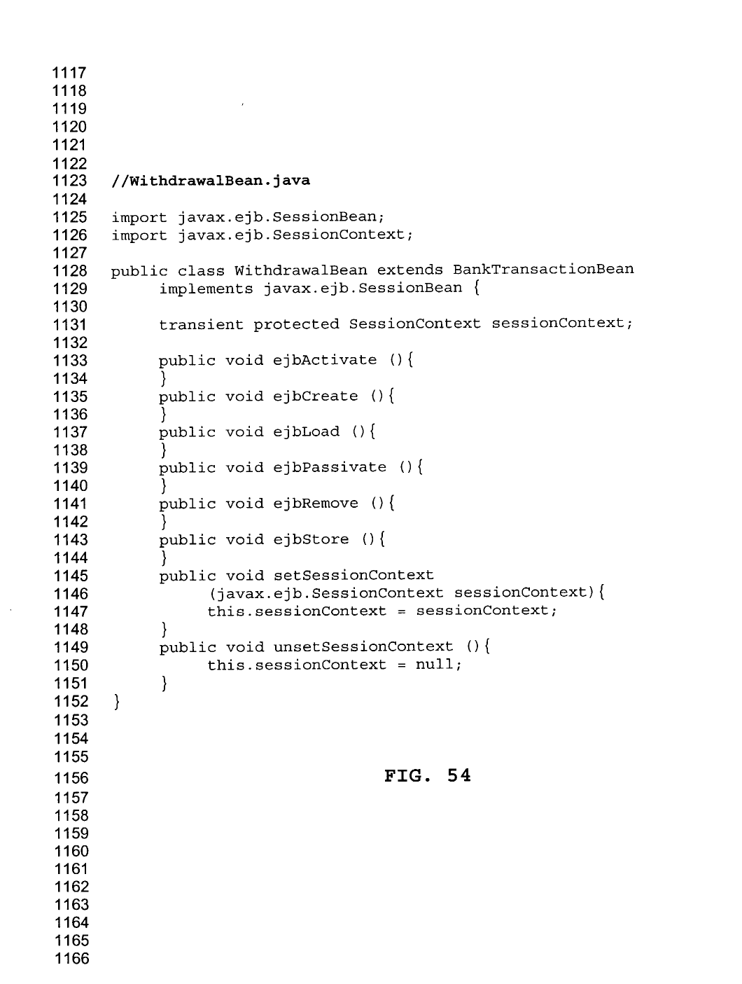

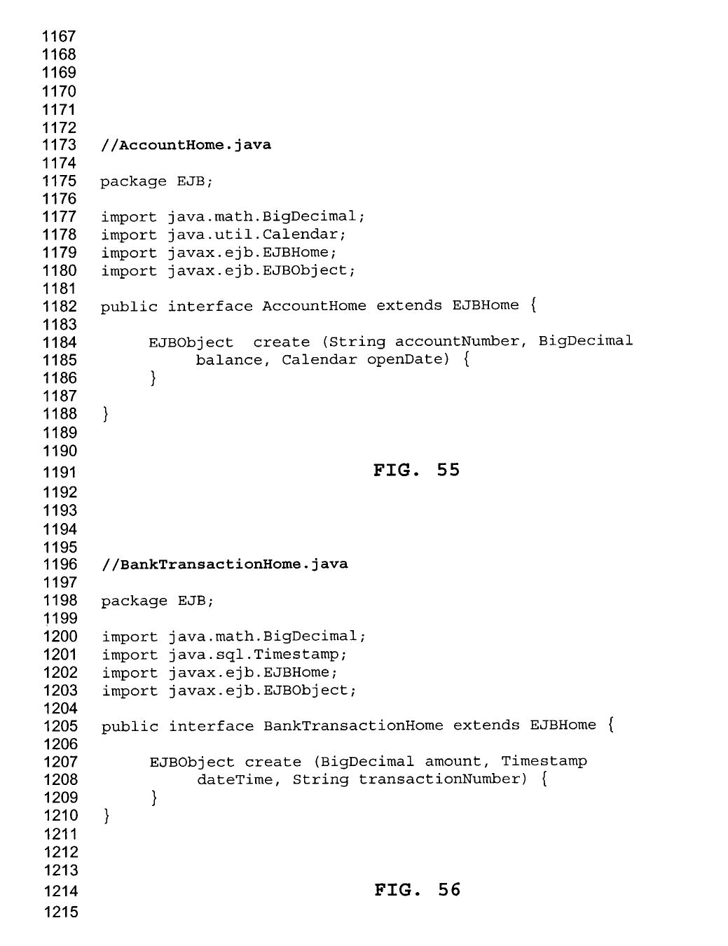

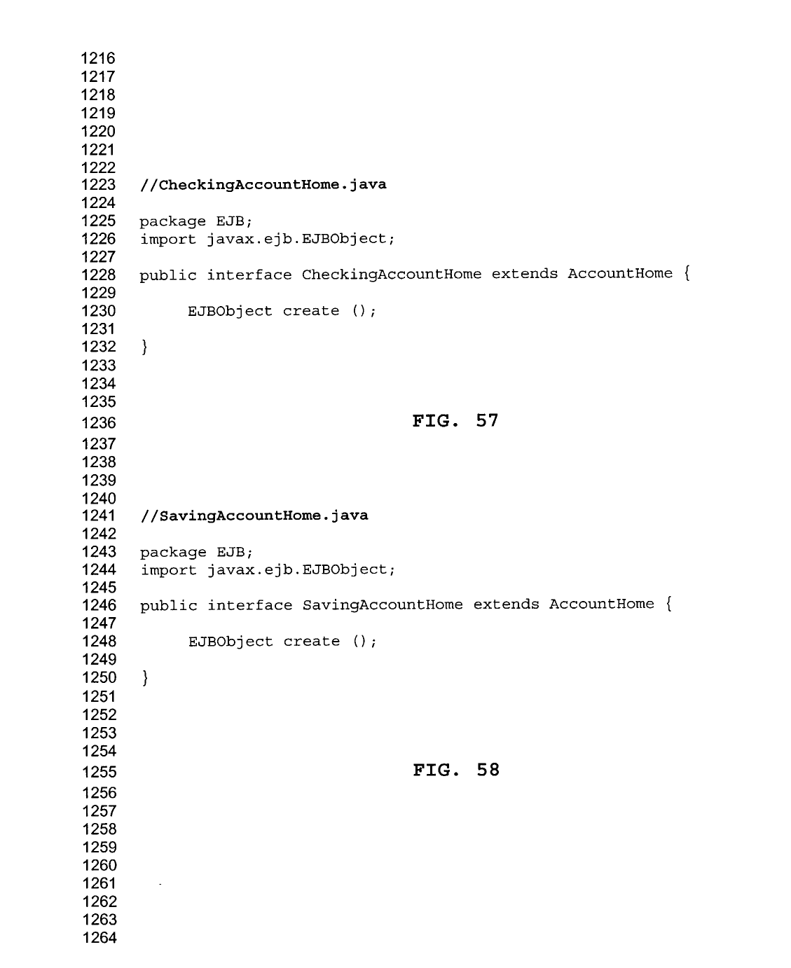

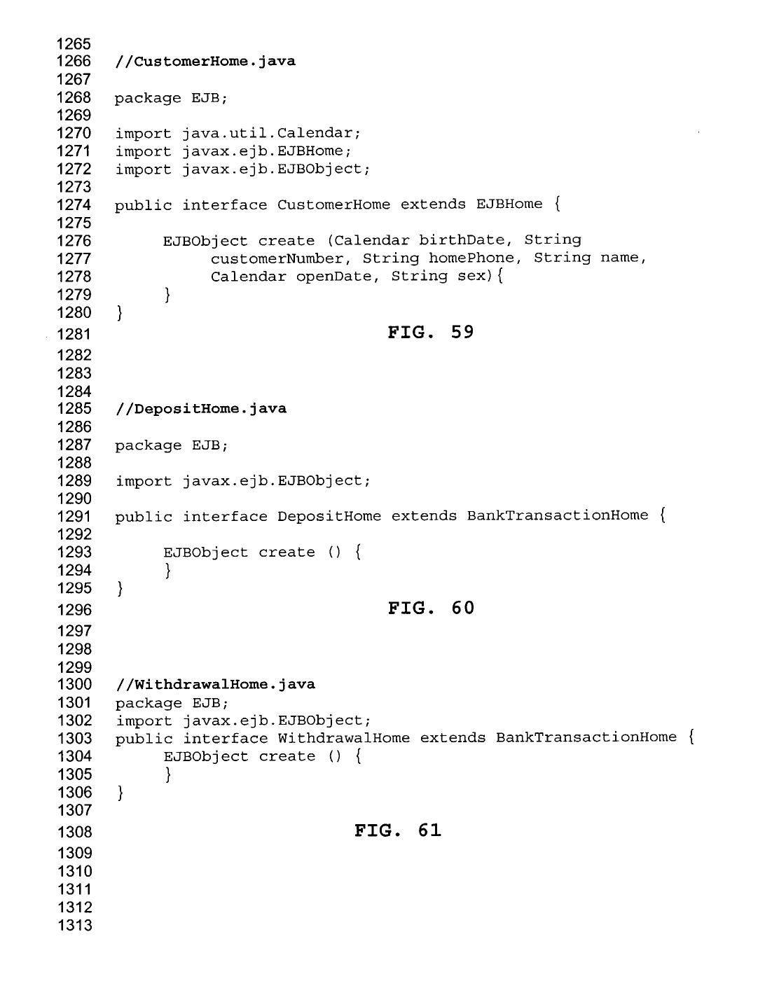

FIG. 41 is the source code of the class Account; FIG. 42 is the source code of the class BankTransaction; FIG. 43 is the source code of the class CheckingAccount; FIG. 44 is the source code of the class SavingAccount; FIG. 45 is the source code of the class Customer; FIG. 46 is the source code of the class Deposit; FIG. 47 is the source code of the class Withdrawal; FIG. 48 comprises FIG. 48A and FIG. 48B and is the source code of the class AccountBean; FIG. 49 comprises FIG. 49A and FIG. 49B and is the source code of the class BankTransactionBean; FIG. 50 is the source code of the class CheckingAccountBean; FIG. 51 is the source code of the class SavingAccountBean; FIG. 52 is the source code of the class CustomerBean; FIG. 53 is the source code of the class DepositBean; FIG. 54 is the source code of the class WithdrawalBean; FIG. 55 is the source code of the class AccountHome; FIG. 56 is the source code of the class BankTransactionHome; FIG. 57 is the source code of the class CheckingAccountHome; FIG. 58 is the source code of the class SavingAccountHome; FIG. 59 is the source code of the class CustomerHome; FIG. 60 is the source code of the class DepositHome; FIG. 61 is the source code of the class WithdrawalHome.

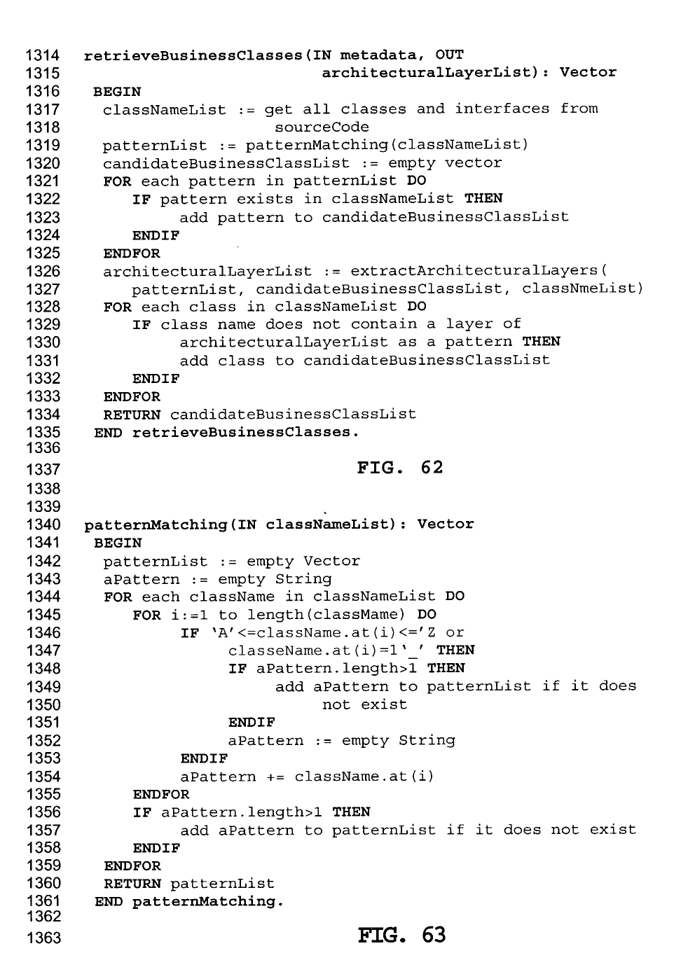

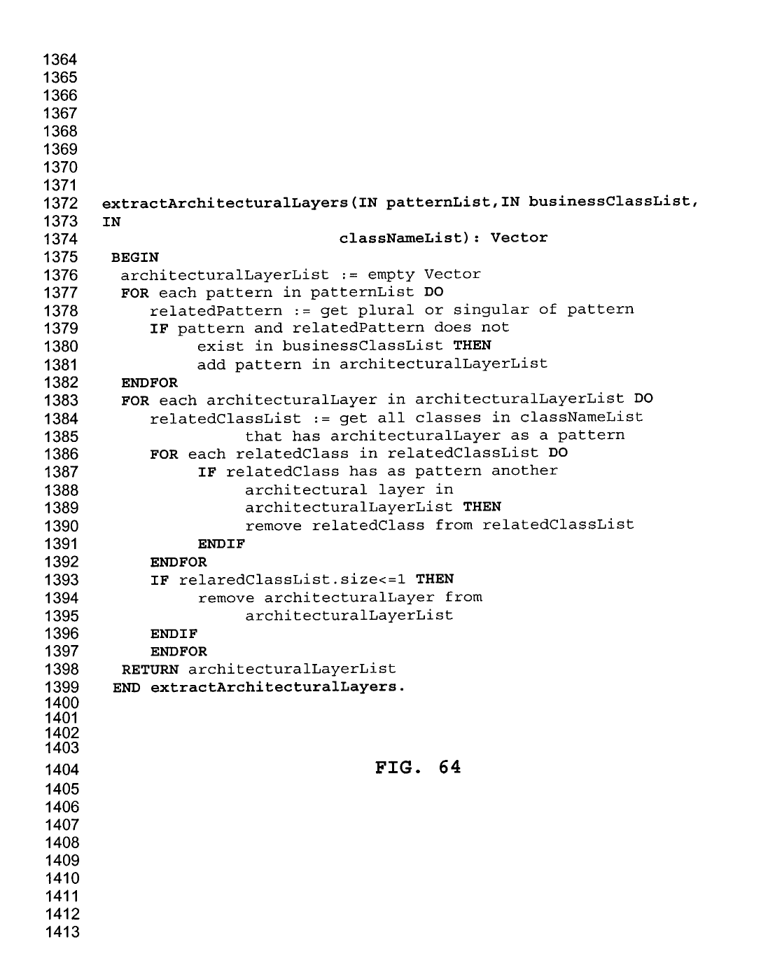

FIG. 62 is pseudo-code for the algorithm retrieveBusinessClasses (1500). FIG. 63 is pseudo-code for the algorithm patternMatching. FIG. 64 is pseudo-code for the algorithm extractArchitecturalLayers.

The algorithm for retrieving attributes of business classes (1423) is presented below.

An attribute is a candidate attribute of a business class if it satisfies two criteria:

It is an attribute of one of the classes that has in its name the business class name as a pattern (line 1439).

It does not exist in other classes that have in their name a pattern other than the business class name (lines 1440-1443).

For instance, the candidate attributes of the business class ‘Account’ are ‘accountNumber’, ‘balance’, ‘openDate’, and ‘customer’ since these attributes belong to the class ‘AccountBean.java’ and do not exist in other classes, such as ‘BankTransactionBean’ or ‘CustomerBean’, which have the pattern ‘Bean’ in their names. Note that the attribute ‘entityContext’ is not a candidate for the ‘Account’ class since it exists in other classes such as ‘CustomerBean’.

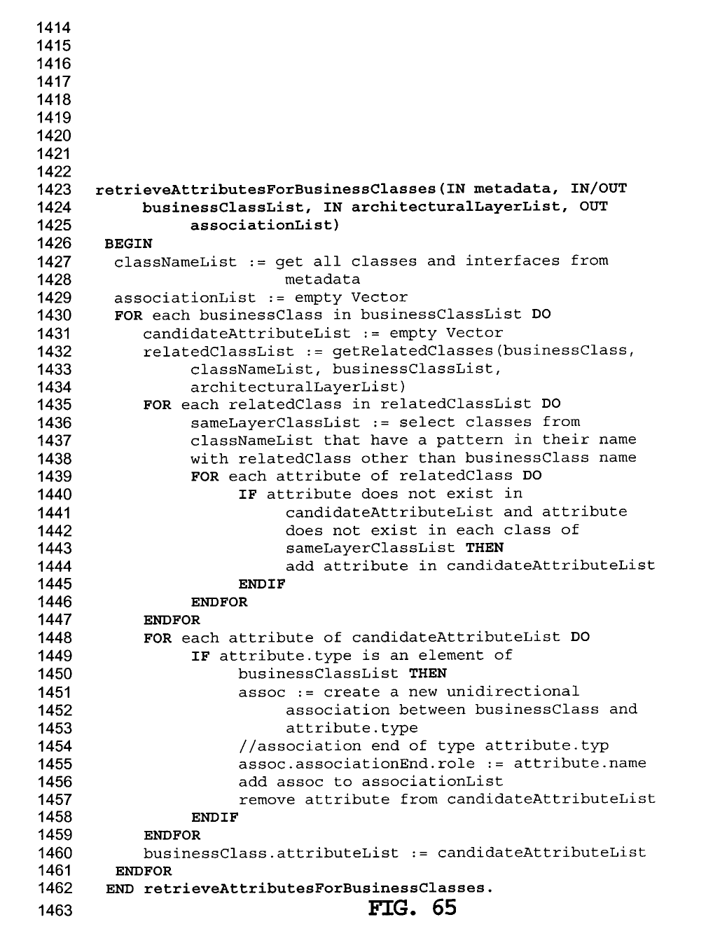

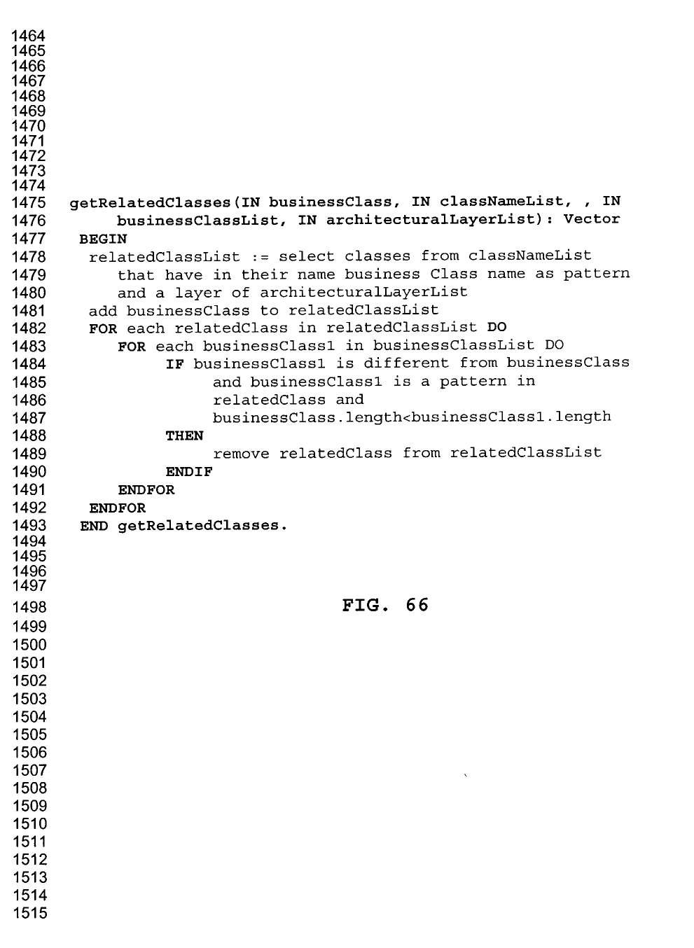

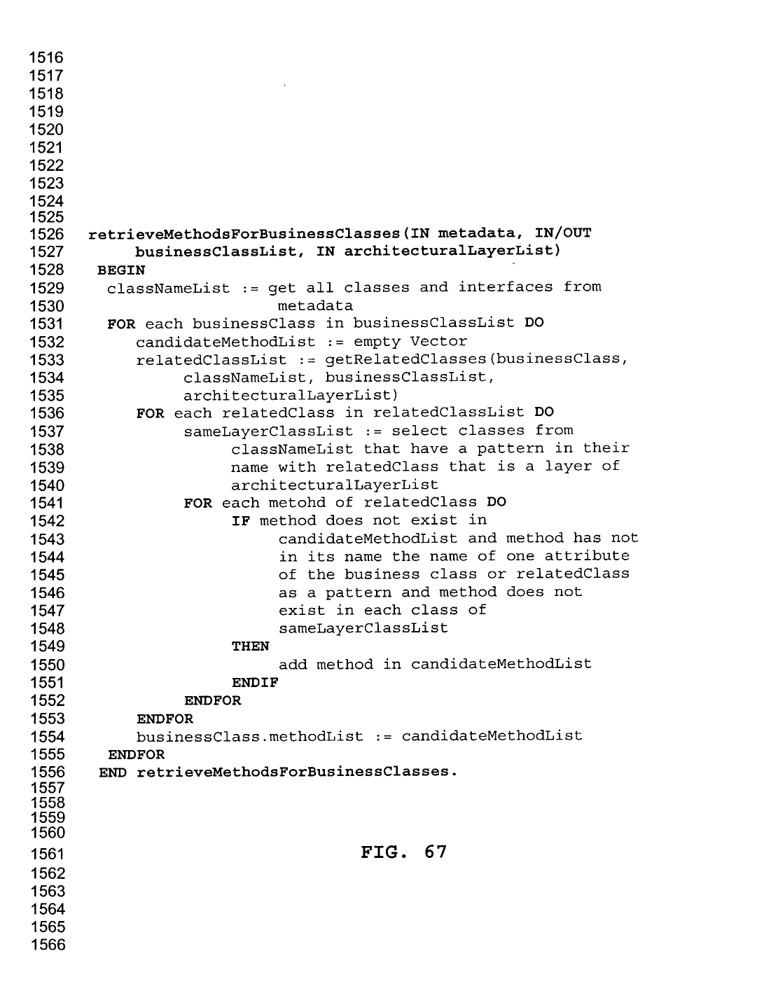

FIG. 65 is pseudo-code for the algorithm retrieveAttributesForBusinessClasses (1423). FIG. 66 is pseudo-code for the algorithm getRelatedClasses.

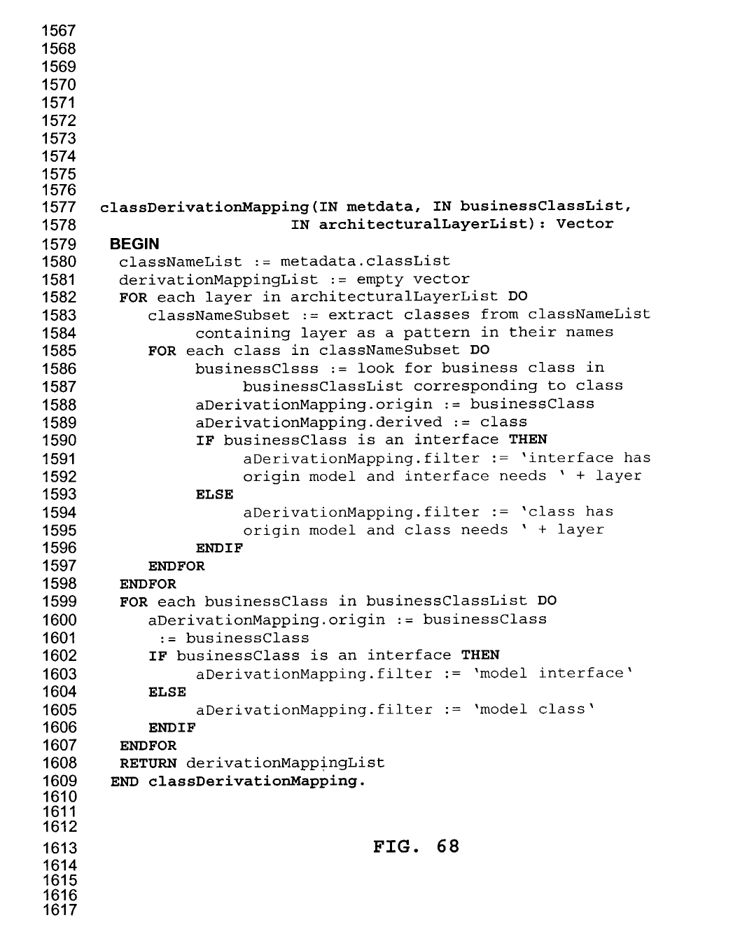

The algorithm for retrieving methods of business classes (FIG. 67) is presented below.

A method is a candidate method of a business class if it satisfies three criteria:

It is a method of one of the classes that has in its name the business class name as a pattern (line 1541).

Its name does not have the name of one of the attributes of the class or the business class as a pattern (lines 1543-1545).

It does not exist in other classes that have in their name a pattern other than the business class name (lines 1546-1548).

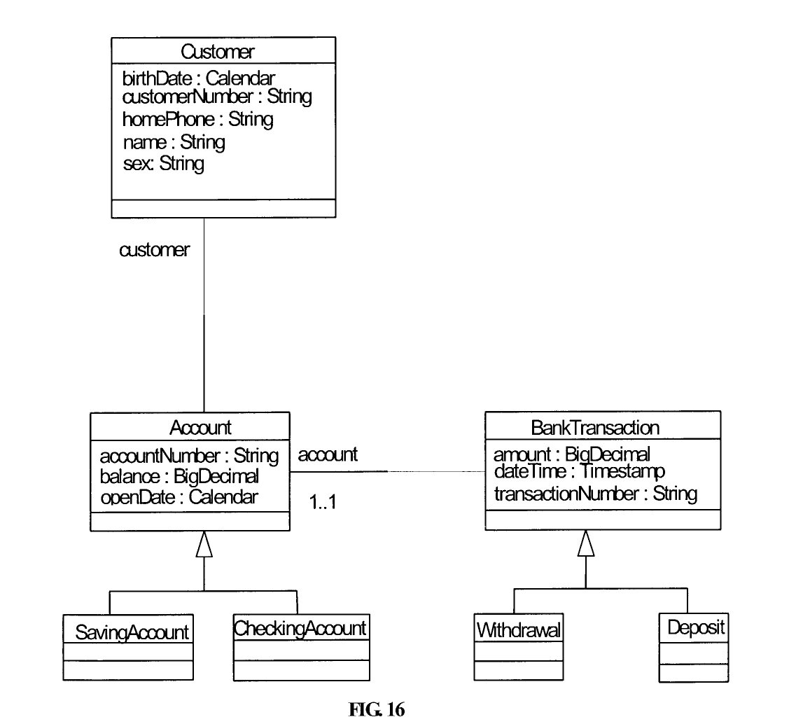

For instance, the class ‘Account’ does not have candidate methods since no methods in ‘AccountBean.java’ and ‘AccountHome.java’ satisfy the three criteria. In fact, the methods ‘ejbActivate’, ‘ejbCreate’, ‘ejbLoad’, ‘ejbPassivate’, ejbPostCreate’, ‘ejbRemove’, ‘ejbStore’, also exist, for instance, in ‘CheckingAccount.java,’ and ‘create’ also exists in ‘CheckingAccountHome.. The selector methods (e.g. ‘getAccountNumber’) correspond to one of the attributes of ‘AccountBean.java’. The business logic of the ‘Bank’ system is described in FIG. 16. Note that non-primitive attributes are considered as associations between classes.

See FIG. 67, which is pseudo-code for the algorithm retrieveMethodsForBusinessClasses (1526).

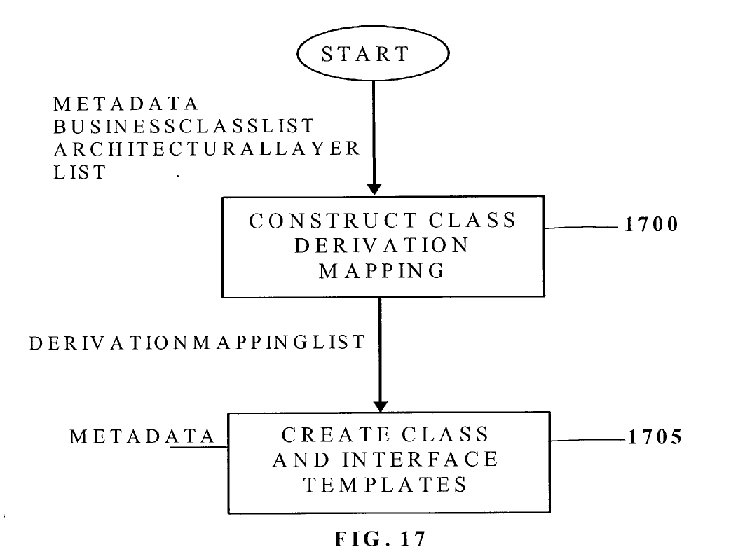

The step ‘construct class and interface templates’ (1410) consists of two sub-steps (see FIG. 17): construct class derivation mapping and create class and interface templates. The algorithm of class derivation mapping is illustrated below (step 1700). The algorithm uses the architectural layers that exist in the source code. For each architectural layer, the algorithm constructs a derivation mapping between a business class and every class that has in its name the layer as a pattern (lines 1583-1597). For instance for the ‘Bean’ layer, derivation mappings are constructed between:

‘Account’ and ‘AccountBean’

‘BankTransaction’ and ‘BankTransactionBean’

‘CheckingAccount’ and ‘CheckingAccountBean’

‘SavingAccount’ and ‘SavingAccountBean’

‘Customer’ and ‘CustomerBean’

‘Deposit’ and ‘DepositBean’

‘Withdrawal’ and ‘WithdrawalBean’.

Moreover, a derivation mapping is constructed between every business class and itself (lines 1599-1607). The remaining derivation mapping, including those for the home layer, are therefore:

‘Account’ and ‘Account’

‘BankTransaction’ and ‘BankTransaction’

‘CheckingAccount’ and ‘CheckingAccount’

‘SavingAccount’ and ‘SavingAccount’

‘Customer’ and ‘Customer’

‘Deposit’ and ‘Deposit’

‘Withdrawal’ and ‘Withdrawal’

‘Account’ and ‘AccountHome’

‘BankTransaction’ and ‘BankTransactionHome’

‘CheckingAccount’ and ‘CheckingAccountHome’

‘SavingAccount’ and ‘SavingAccountHome’

‘Customer’ and ‘CustomerHome’

‘Deposit’ and ‘DepositHome’

‘Withdrawal’ and ‘WithdrawalHome’.

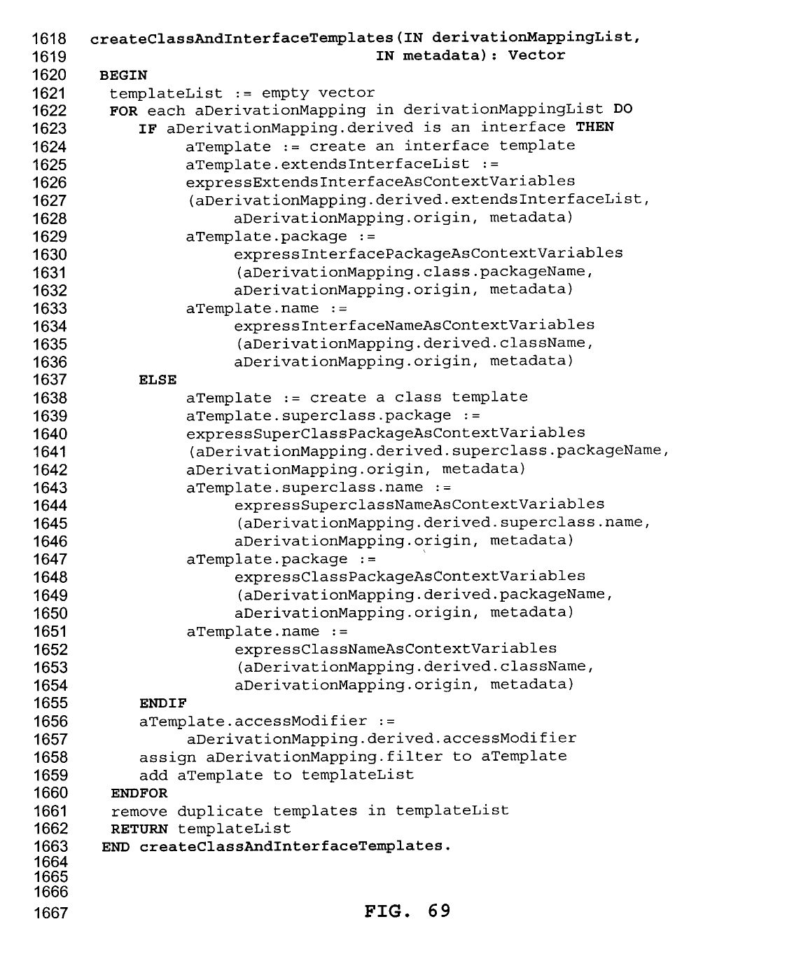

See FIG. 68, which is pseudo-code for the algorithm classDerivationMapping.

The algorithm of class and interface creation (step 1705) is described below.

For each derivation mapping, an interface (respectively, a class) template is created if the derived element is an interface (respectively, a class). For instance, the derivation mapping described above will create:

A class template for the ‘Account’ and ‘AccountBean’ derivation mapping with the following information:

superclass package: ‘<source_superclass_package/>’

superclass name: ‘<source_superclass_name/>’

abstract modifier: ‘public’

package: ‘<source_class_package/>’

name: ‘<source_class_name/>’

implements interface: ‘javax.ejb.EntityBean’.

A class template for the ‘BankTransaction’ and ‘BankTransactionBean’ derivation mapping with the following information:

superclass package: ‘<source_superclass_package/>’

superclass name: ‘<source_superclass_name/>’

abstract modifier: ‘public’

package: ‘<source_class_package/>’

name: ‘<source_class_name/>’

implements interface: ‘javax.ejb.EntityBean’.

A class template for the ‘CheckingAccount’ and ‘CheckingAccountBean’ derivation mapping with the following information:

superclass package: ‘<source_superclass_package/>’

superclass name: ‘<source_superclass_name/>’

abstract modifier: ‘public’

package: ‘<source_class_package/>’

name: ‘<source_class_name/>’

implements interface: ‘javax.ejb.EntityBean’.

A class template for the ‘SavingAccount’ and ‘SavingAccountBean’ derivation mapping with the following information:

superclass package: ‘<source_superclass_package/>’

superclass name: ‘<source_superclass_name/>’

abstract modifier: ‘public’

package: ‘<source_class_package/>’

name: ‘<source_class_name/>’implements interface: ‘javax.ejb.SessionBean’.

A class template for the ‘Customer’ and ‘CustomerBean’ derivation mapping with the following information:

superclass package: ‘<source_superclass_package/>’

superclass name: ‘<source_superclass_name/>’

abstract modifier: ‘public’

package: ‘<source_class_package/>’

name: ‘<source_class_name/>’

implements interface: ‘javax.ejb.SessionBean’.

A class template for the ‘Deposit’ and ‘DepositBean’ derivation mapping with the following information:

superclass package: ‘<source_superclass_package/>’

superclass name: ‘<source_superclass_name/>’

abstract modifier: ‘public’

package: ‘<source_class_package/>’

name: ‘<source_class_name/>’

implements interface: ‘javax.ejb.SessionBean’.

A class template for the ‘Withdrawal’ and ‘WithdrawalBean’ derivation mapping with the following information:

superclass package: ‘<source_superclass_package/>’

superclass name: ‘<source_superclass_name/>’

abstract modifier: ‘public’

package: ‘<source_class_package/>’

name: ‘<source_class_name/>’

implements interface: ‘javax.ejb.SessionBean’.

An interface template for the ‘Account’ and ‘Account’ derivation mapping with the following information:

Extends interfaces: ‘EJBObject’

abstract modifier: ‘public’

package: ‘<source_class_package/>’

name: ‘<source_class_name/>’.

An interface template for the ‘BankTransaction’ and ‘BankTransaction’ derivation mapping with the following information:

Extends interfaces: ‘EJBObject’

abstract modifier: ‘public’

package: ‘<source_class_package/>’

name: ‘<source_class_name/>’.

An interface template for the ‘CheckingAccount’ and ‘CheckingAccount’ derivation mapping with the following information:

Extends interfaces: ‘<source_super_class/>’

abstract modifier: ‘public’

package: ‘<source_class_package/>’

name: ‘<source_class_name/>’.

An interface template for the ‘SavingAccount’ and ‘SavingAccount’ derivation mapping with the following information:

Extends interfaces: ‘<source_super_class/>’

abstract modifier: ‘public’

package: ‘<source_class_package/>’

name: ‘<source_class_name/>’.

An interface template for the ‘Customer’ and ‘Customer’ derivation mapping with the following information:

Extends interfaces: ‘EJBObject’

abstract modifier: ‘public’

package: ‘<source_class_package/>’

name: ‘<source_class_name/>’.

An interface template for the ‘Deposit’ and ‘Deposit’ derivation mapping with the following information:

Extends interfaces: ‘<source_super_class/>’

abstract modifier: ‘public’

package: ‘<source_class_package/>’

name: ‘<source_class_name/>’.

An interface template for the ‘Withdrawal’ and ‘Withdrawal’ derivation mapping with the following information:

Extends interfaces: ‘<source_super_class/>’

abstract modifier: ‘public’

package: ‘<source_class_package/>’

name: ‘<source_class_name/>’.

An interface template for the ‘Account’ and ‘AccountHome’ derivation mapping with the following information:

Extends interfaces: ‘EJBHome’

abstract modifier: ‘public’

package: ‘<source_class_package/>’

name: ‘<source_class_name/>’.

An interface template for the ‘BankTransaction’ and ‘BankTransactionHome’ derivation mapping with the following information:

Extends interfaces: ‘EJBHome’

abstract modifier: ‘public’

package: ‘<source_class_package/>’

name: ‘<source_class_name/>’.

An interface template for the ‘CheckingAccount’ and ‘CheckingAccountHome’ derivation mapping with the following information:

Extends interfaces: ‘<source_super_class/>Home’

abstract modifier: ‘public’

package: ‘<source_class_package/>’

name: ‘<source_class_name/>’.

An interface template for the ‘SavingAccount’ and ‘SavingAccountHome’ derivation mapping with the following information:

Extends interfaces: ‘<source_super_class/>Home’

abstract modifier: ‘public’

package: ‘<source_class_package/>’

name: ‘<source_class_name/>’.

An interface template for the ‘Customer’ and ‘CustomerHome’ derivation mapping with the following information:

Extends interfaces: ‘EJBHome’

abstract modifier: ‘public’

package: ‘<source_class_package/>’

name: ‘<source_class_name/>’.

An interface template for the ‘Deposit’ and ‘DepositHome’ derivation mapping with the following information:

Extends interfaces: ‘<source_super_class/>Home’

abstract modifier: ‘public’

package: ‘<source_class_package/>’

name: ‘<source_class_name/>’.

An interface template for the ‘Withdrawal’ and ‘WithdrawalHome’ derivation mapping with the following information:

Extends interfaces: ‘<source_super_class/>Home’

abstract modifier: ‘public’

package: ‘<source_class_package/>’

name: ‘<source_class_name/>’.

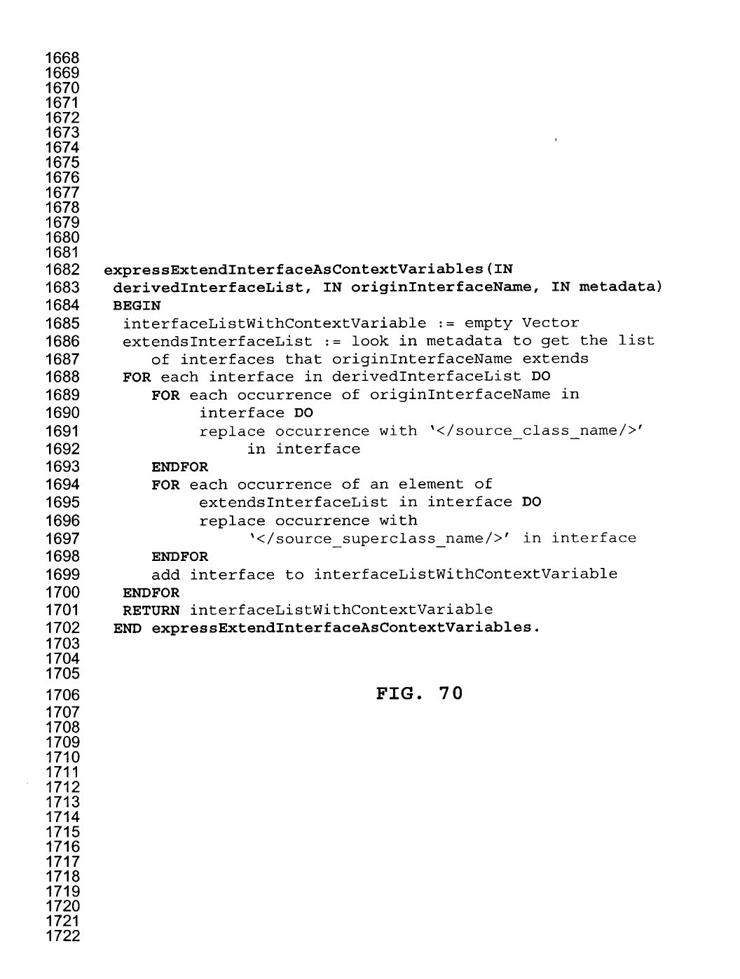

After duplicate templates are removed (line 1674), two class templates and four interface templates remain. See FIG. 69, which is pseudo-code for the algorithm createClassAndInterfaceTemplates (1618). Note that this algorithm uses the following algorithms for expressing template information with context variables:

expressExtendInterfaceAsContextVariables, described in FIG. 70;

expressInterfacePackageAsContextVariables, described in FIG. 71;

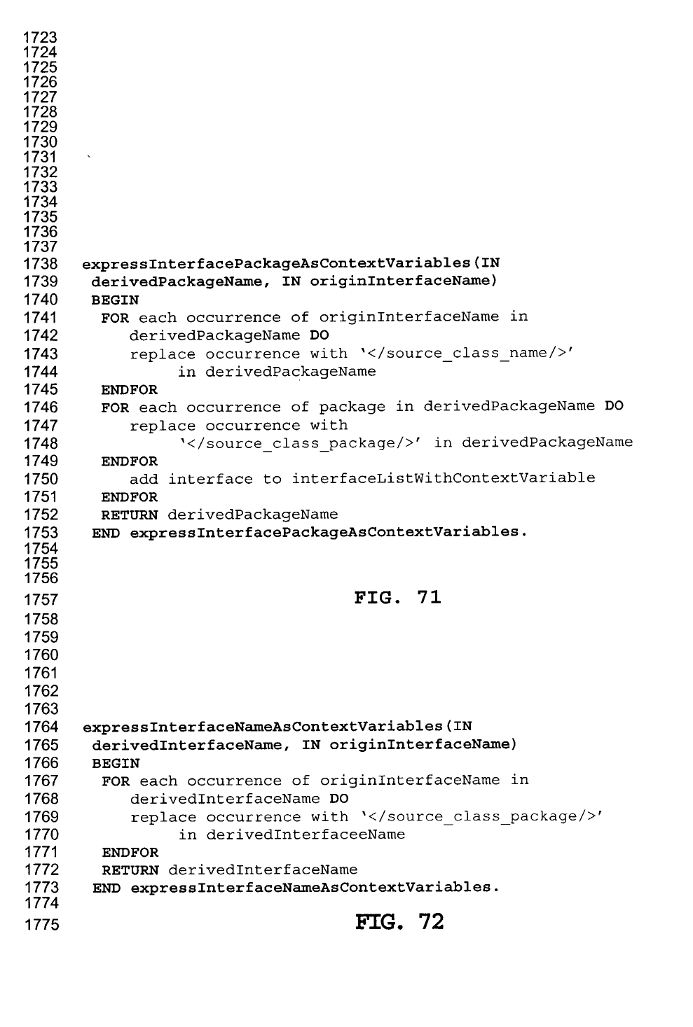

expressInterfaceNameAsContextVariables, described in FIG. 72;

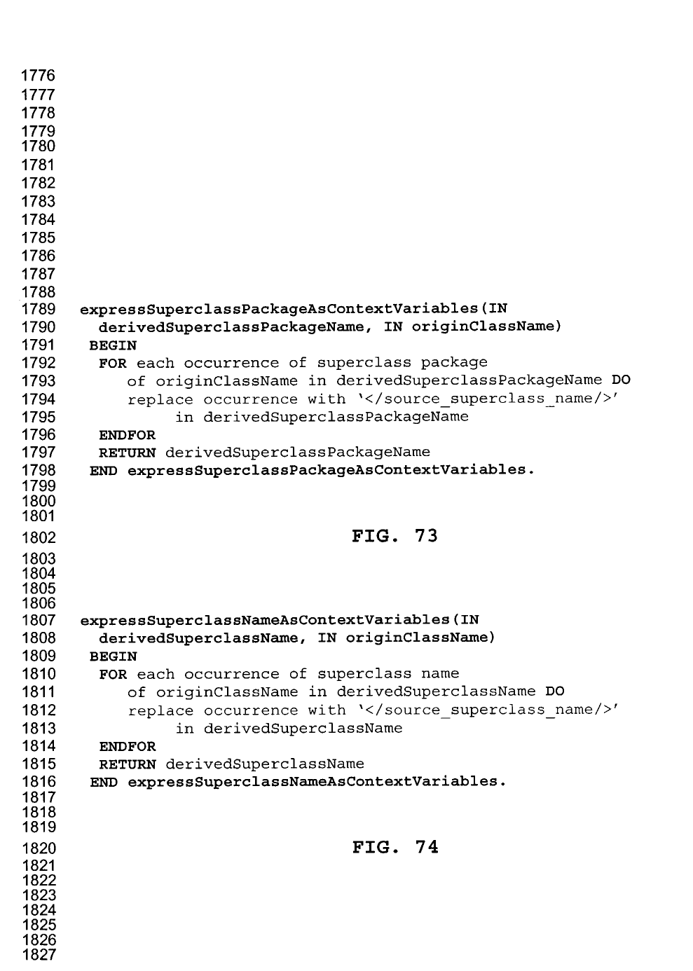

expressSuperclassPackageAsContextVariables, described in FIG. 73;

expressSuperclassNameAsContextVariables, described in FIG. 74;

expressClassPackageAsContextVariables, described in FIG. 75;

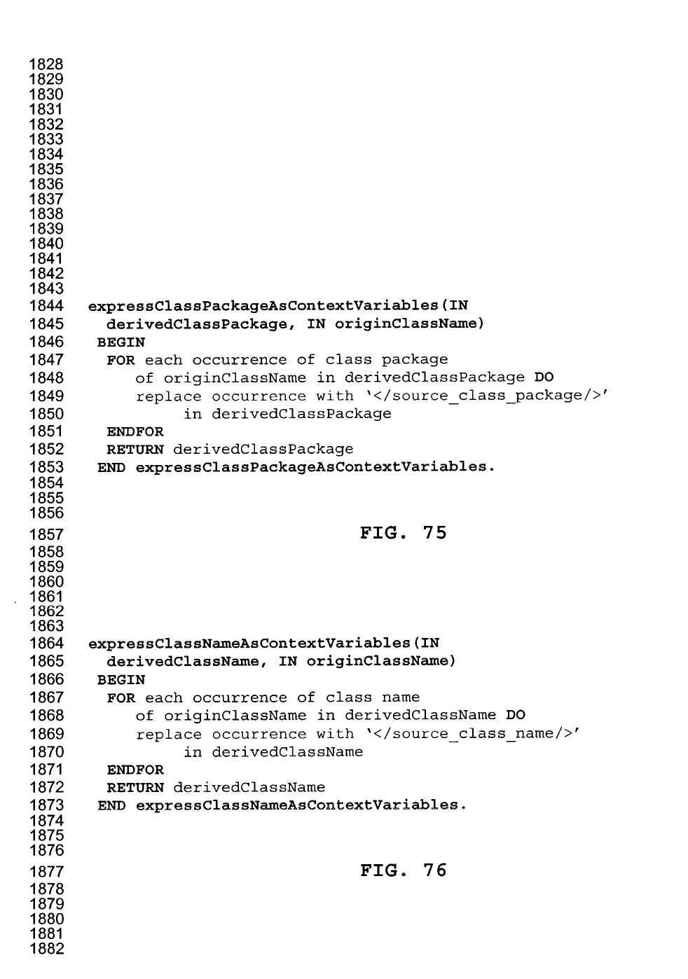

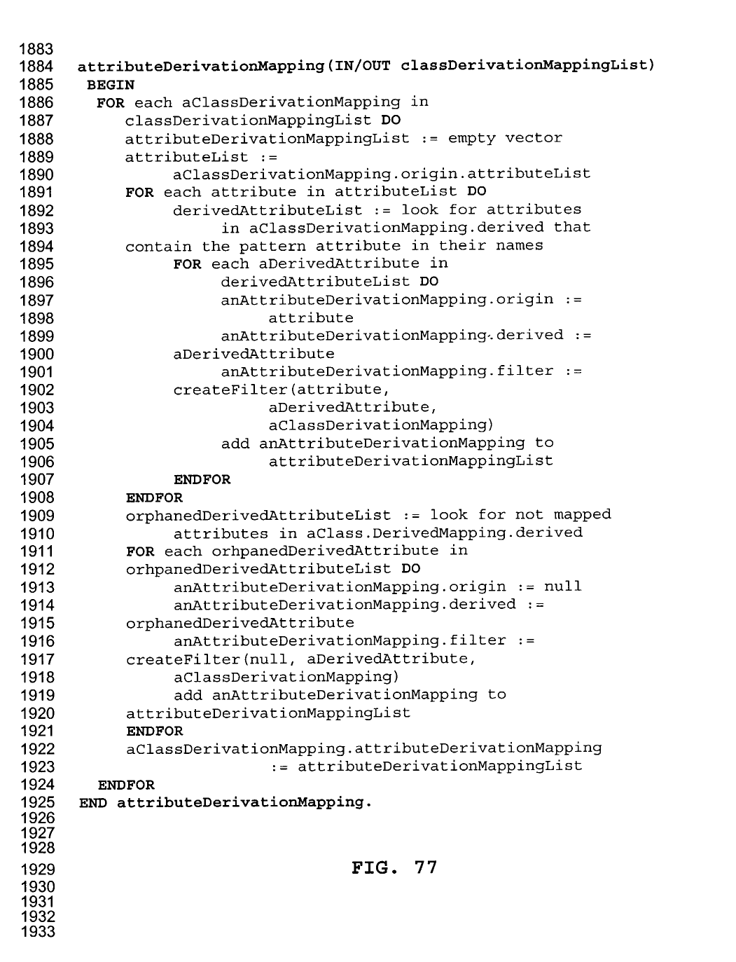

expressClassNameAsContextVariables, described in FIG. 76.

The step ‘construct attribute templates’ (1415) is composed of two sub-steps (see FIG. 18): construct attribute derivation mapping and create attribute templates. The algorithm of attribute derivation mapping is illustrated below (step 1800). It constructs a mapping for every attribute of derived classes. An attribute of a class is derived from an attribute of the origin class if the latter attribute is a pattern of the former attribute (lines 1907-1923). Otherwise, the origin of the attribute is undefined (lines 1925-1937). For the Bank system, for instance, the following derivation mapping information is obtained:

For the ‘AccountBean’ class:

The attribute ‘accountNumber’ is derived from the attribute ‘accountNumber’ of the business class ‘Account’.

The attribute ‘balance’ is derived from the attribute ‘balance’ of the business class ‘Account’.

The attribute ‘openDate’ is derived from the attribute ‘openDate’ of the business class ‘Account’.

The attribute ‘customer’ is derived from the attribute ‘customer’ of the business class ‘Account’.

The origin of the attribute ‘entityContext is undefined.

For the ‘BankTransactionBean’ class:

The attribute ‘amount’ is derived from the attribute ‘amount’ of the business class ‘BankTransaction’.

The attribute ‘dateTime’ is derived from the attribute ‘dateTime’ of the business class ‘BankTransaction’.

The attribute ‘transactionNumber’ is derived from the attribute ‘transactionNumber’ of the business class ‘BankTransaction’.

The attribute ‘account’ is derived from the attribute ‘account’ of the business class ‘BankTransaction’.

The origin of the attribute ‘sessionContext is undefined.

For the ‘CheckingAccountBean’ class:

The origin of the attribute ‘entityContext is undefined.

For the ‘SavingAccountBean’ class:

The origin of the attribute ‘entityContext is undefined.

For the ‘CustomerBean’ class:

The attribute ‘customerNumber’ is derived from the attribute ‘customerNumber’ of the business class ‘Customer’.

The attribute ‘homePhone’ is derived from the attribute ‘homePhone’ of the business class ‘Customer’.

The attribute ‘name’ is derived from the attribute ‘name’ of the business class ‘Customer’.

The origin of the attribute ‘sessionContext is undefined.

For the ‘DepositBean’ class:

The origin of the attribute ‘sessionContext is undefined.

For the ‘WithdrawalBean’ class:

The origin of the attribute ‘sessionContext is undefined.

FIG. 77 is pseudo-code for the algorithm attributeDerivationMapping.

The algorithm of attribute template creation is described below (1805). For each attribute derivation mapping:

An attribute template that iterates over classes is created if the origin of the derived attribute is undefined (lines 1958-1959).

An attribute template that iterates over source attributes if the origin of the attribute is known (lines 1962-1963).

For instance, the attribute derivation mapping described above will create:

An attribute template that iterates over source attributes for the ‘accountNumber’ and accountNumber’ attribute derivation mapping with the following information:

name: <source_attribute/>

type: <source_attribute_type/>

access modifier: private

An attribute template that iterates over source attributes for the ‘balance’ and ‘balance’ attribute derivation mapping with the following information:

name: <source_attribute/>

type: <source_attribute_type/>

access modifier: private

An attribute template that iterates over source attributes for the ‘openDate’ and ‘openDate’ attribute derivation mapping with the following information:

name: <source_attribute/>

type: <source_attribute_type/>

access modifier: private

An attribute template that iterates over source attributes for the ‘customer’ and ‘customer’ attribute derivation mapping with the following information:

name: <source_attribute/>

type: <source_attribute_type/>

access modifier: private

An attribute template that iterates over classes for the ‘entityContext’ and ‘undefined’ attribute derivation mapping with the following information:

name: entityContext

type: EntityContext

access modifier: transient protected

An attribute template that iterates over source attributes for the ‘amount’ and ‘amount’ attribute derivation mapping with the following information:

name: <source_attribute/>

type: <source_attribute_type/>

access modifier: private

An attribute template that iterates over source attributes for the ‘dateTime’ and ‘dateTime’ attribute derivation mapping with the following information:

name: <source_attribute/>

type: <source_attribute_type/>

access modifier: private

An attribute template that iterates over source attributes for the ‘transactionNumber’ and ‘transactionNumber’ attribute derivation mapping with the following information:

name: <source_attribute/>

type: <source_attribute_type/>

access modifier: private

An attribute template that iterates over source attributes for the ‘account’ and ‘account’ attribute derivation mapping with the following information:

name: <source_attribute/>

type: <source_attribute_type/>

access modifier: private

An attribute template that iterates over classes for the ‘sessionContext’ and ‘undefined’ attribute derivation mapping with the following information:

name: sessionContext

type: sessionContext

access modifier: transient protected

An attribute template that iterates over source attributes for the ‘customerNumber’ and ‘customerNumber’ attribute derivation mapping with the following information:

name: <source_attribute/>

type: <source_attribute type/>

access modifier: private

An attribute template that iterates over source attributes for the ‘homephone’ and ‘homePhone’ attribute derivation mapping with the following information:

name: <source_attribute/>

type: <source_attribute_type/>

access modifier: private

An attribute template that iterates over source attributes for the ‘name’ and ‘name’ attribute derivation mapping with the following information:

name: <source_attribute/>

type: <source_attribute_type/>

access modifier: private

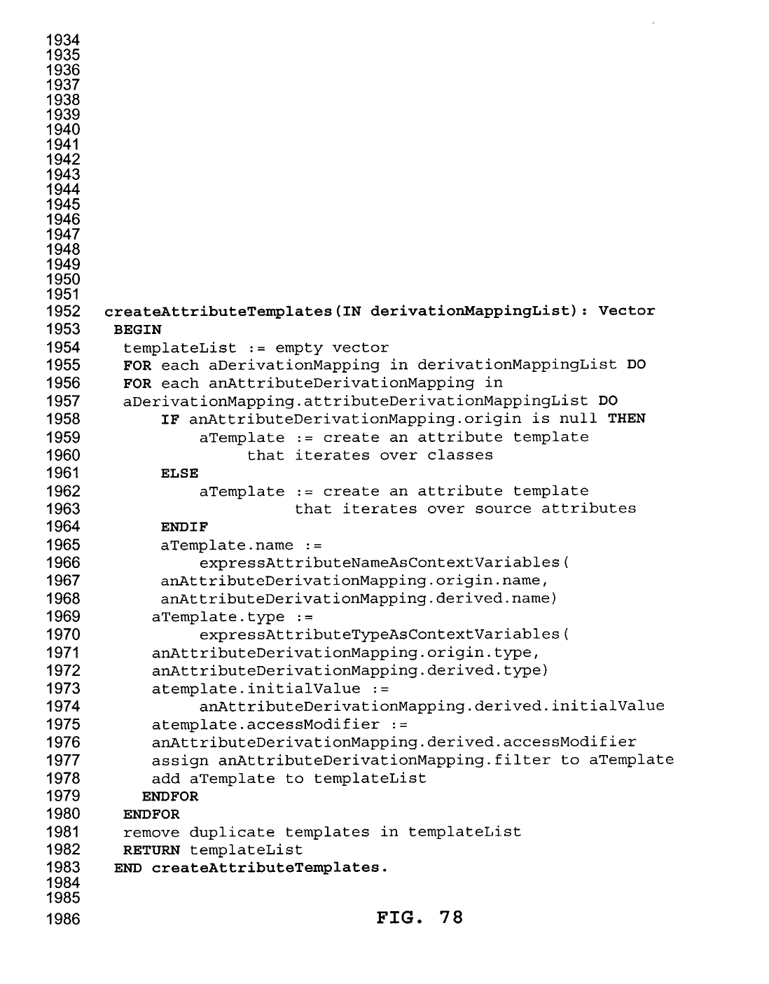

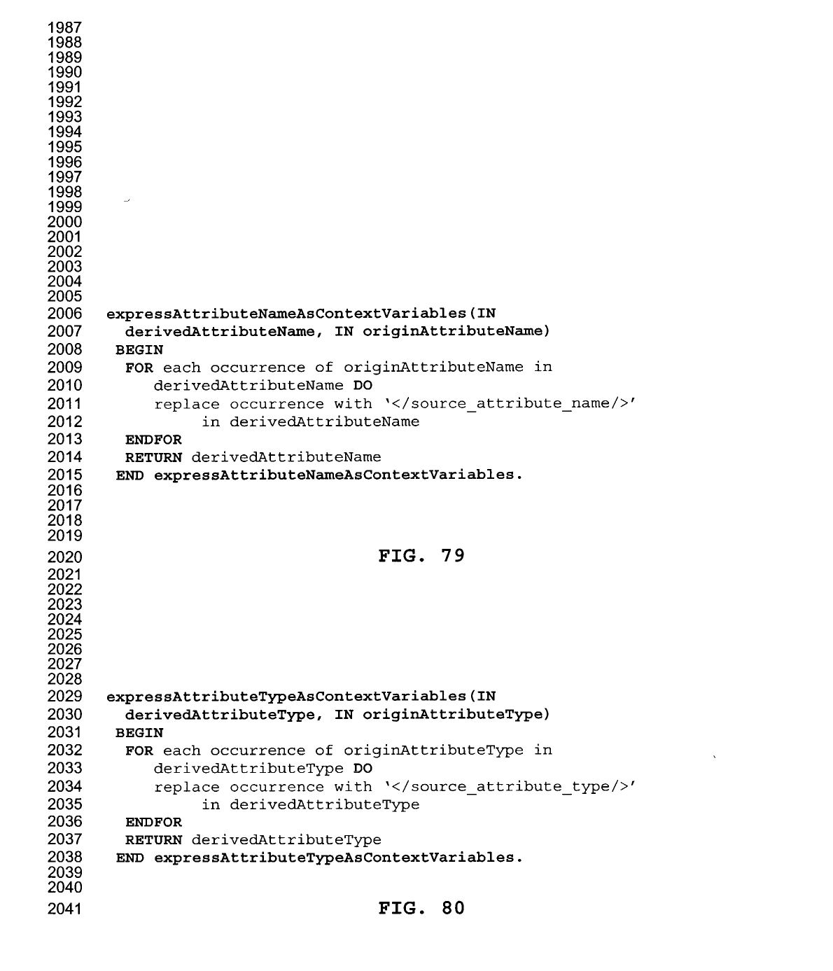

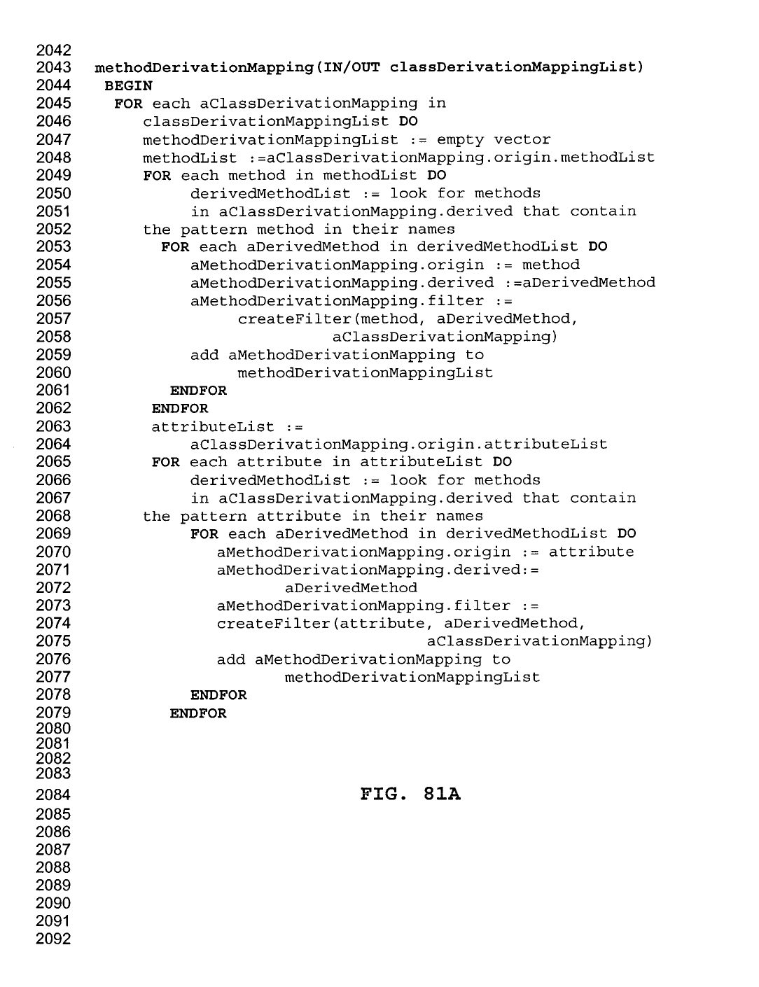

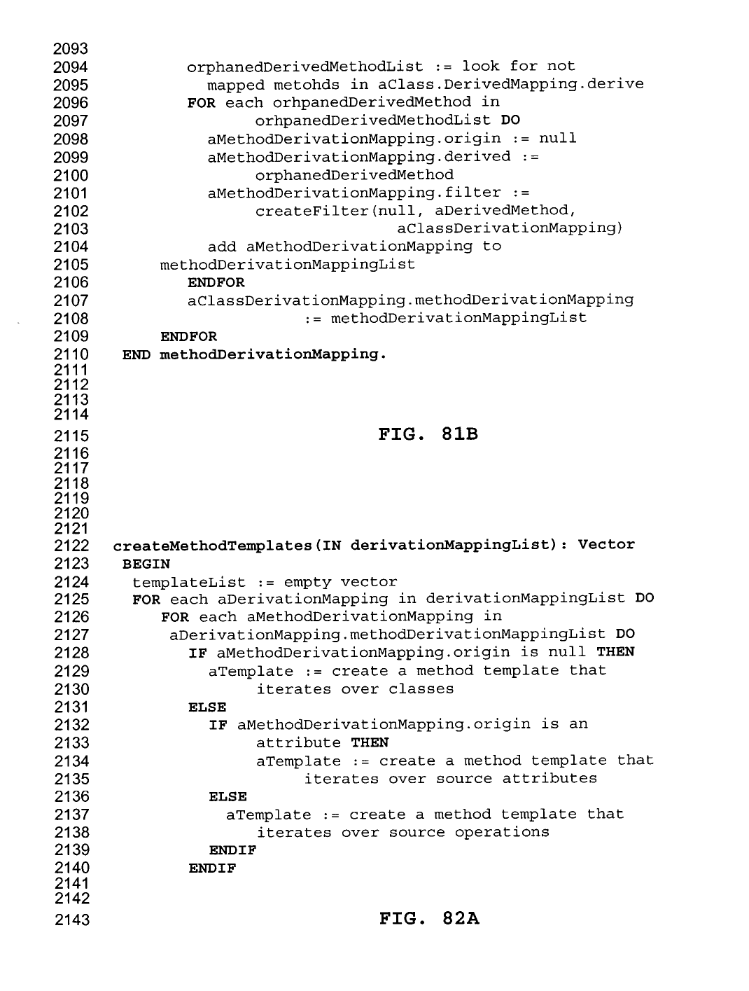

After duplicate templates are removed (line 1981), there remain two attribute templates that iterate over classes and one attribute template that iterates over source attributes. FIG. 78 is pseudo-code for the algorithm createAttributeTemplates; FIG. 79 is pseudo-code for the algorithm expressAttributeNameAsContextVariables; FIG. 80 is pseudo-code for the algorithm expressAttributeTypeAsContextVariables;

The step ‘construct method templates’ (1420) is composed of three sub-steps (see FIG. 19): construct method derivation mapping, create method templates, and abstract the body of each method template. The algorithm of method derivation mapping is presented below (1900). It constructs a mapping for every method of derived classes. Three cases are considered:

A method of a class is derived from a method of the origin class if the latter method is a pattern of the former method (lines 2067-2080).

A method of a class is derived from an attribute of the origin class if the latter attribute is a pattern of the former method (lines 2082-2098).

Otherwise, the origin of the method is undefined (lines 2115-2125).

For the Bank system, for instance, the following derivation mapping information is obtained:

For the ‘AccountBean’ class:

The origin of the method ‘ejbActivate’ is undefined.

The origin of the method ‘ejbCreate’ is undefined.

The origin of the method ‘ejbLoad’ is undefined.

The origin of the method ‘ejbPassivate’ is undefined.

The origin of the method ‘ejbPostCreate’ is undefined.

The origin of the method ‘ejbRemove’ is undefined.

The origin of the method ‘ejbStore’ is undefined.

The method ‘getAccountNumber’ is derived from the attribute ‘accountNumber’ of the business class ‘Account’.

The method ‘getBalance’ is derived from the attribute ‘balance’ of the business class ‘Account’.

The method ‘getOpenDate’ is derived from the attribute ‘openDate’ of the business class ‘Account’.

The method ‘getCustomer’ is derived from the attribute ‘customer’ of the business class ‘Account’.

The method ‘setAccountNumber’ is derived from the attribute ‘accountNumber’ of the business class ‘Account’.

The method ‘setBalance’ is derived from the attribute ‘balance’ of the business class ‘Account’.

The method ‘setOpenDate’ is derived from the attribute ‘openDate’ of the business class ‘Account’.

The method ‘setCustomer’ is derived from the attribute ‘customer’ of the business class ‘Account’.

The origin of the method ‘setEntityContext is undefined.

The origin of the method ‘unsetEntityContext is undefined.

For the ‘BankTransactionBean’ class:

The origin of the method ‘ejbActivate’ is undefined.

The origin of the method ‘ejbCreate’ is undefined.

The origin of the method ‘ejbLoad’ is undefined.

The origin of the method ‘ejbPassivate’ is undefined.

The origin of the method ‘ejbRemove’ is undefined.

The origin of the method ‘ejbStore’ is undefined.

The method ‘getAmount’ is derived from the attribute ‘amount’ of the business class ‘BankTransaction’.

The method ‘getDateTime’ is derived from the attribute ‘dateTime’ of the business class ‘BankTransaction’.

The method ‘getTransactionNumber’ is derived from the attribute ‘transactionNumber’ of the business class ‘BankTransaction’.

The method ‘getAccount’ is derived from the attribute ‘account’ of the business class ‘BankTransaction’.

The method ‘setAmount’ is derived from the attribute ‘amount’ of the business class ‘BankTransaction’.

The method ‘setDateTime’ is derived from the attribute ‘dateTime’ of the business class ‘BankTransaction’.

The method ‘setTransactionNumber’ is derived from the attribute ‘transactionNumber’ of the business class ‘BankTransaction’.

The method ‘setAccount’ is derived from the attribute ‘account’ of the business class ‘BankTransaction’.

The origin of the method ‘setSessionContext is undefined.

The origin of the method ‘unsetSessionContext is undefined.

For the ‘CheckingAccountBean’ class:

The origin of the method ‘ejbActivate’ is undefined.

The origin of the method ‘ejbCreate’ is undefined.

The origin of the method ‘ejbLoad’ is undefined.

The origin of the method ‘ejbPassivate’ is undefined.

The origin of the method ‘ejbRemove’ is undefined.

The origin of the method ‘ejbStore’ is undefined.

The origin of the method ‘setEntityContext is undefined.

The origin of the method ‘unsetEntityContext is undefined.

For the ‘SavingAccountBean’ class:

The origin of the method ‘ejbActivate’ is undefined.

The origin of the method ‘ejbCreate’ is undefined.

The origin of the method ‘ejbLoad’ is undefined.

The origin of the method ‘ejbPassivate’ is undefined.

The origin of the method ‘ejbRemove’ is undefined.

The origin of the method ‘ejbStore’ is undefined.

The origin of the method ‘setEntityContext is undefined.

The origin of the method ‘unsetEntityContext is undefined.

For the ‘CustomerBean’ class:

The origin of the method ‘ejbActivate’ is undefined.

The origin of the method ‘ejbCreate’ is undefined.

The origin of the method ‘ejbLoad’ is undefined.

The origin of the method ‘ejbPassivate’ is undefined.

The origin of the method ‘ejbRemove’ is undefined.

The origin of the method ‘ejbStore’ is undefined.

The method ‘getCustomerNumber’ is derived from the attribute ‘customerNumber’ of the business class ‘customer’.

The method ‘getHomePhone’ is derived from the attribute ‘homePhone’ of the business class ‘Customer’.

The method ‘getName’ is derived from the attribute ‘name’ of the business class ‘Customer’.

The method ‘setCustomerNumber’ is derived from the attribute ‘customerNumber’ of the business class ‘customer’.

The method ‘setHomePhone’ is derived from the attribute ‘homePhone’ of the business class ‘Customer’.

The method ‘setName’ is derived from the attribute ‘name’ of the business class ‘Customer’.

The origin of the method ‘setSessionContext is undefined.

The origin of the method ‘unsetSessionContext is undefined.

For the ‘DepositBean’ class:

The origin of the method ‘ejbActivate’ is undefined.

The origin of the method ‘ejbCreate’ is undefined.

The origin of the method ‘ejbLoad’ is undefined.

The origin of the method ‘ejbPassivate’ is undefined.

The origin of the method ‘ejbRemove’ is undefined.

The origin of the method ‘ejbStore’ is undefined.

The origin of the method ‘setSessionContext is undefined.

The origin of the method ‘unsetSessionContext is undefined.

For the ‘WithdrawalBean’ class:

The origin of the method ‘ejbActivate’ is undefined.

The origin of the method ‘ejbCreate’ is undefined.

The origin of the method ‘ejbLoad’ is undefined.

The origin of the method ‘ejbPassivate’ is undefined.

The origin of the method ‘ejbRemove’ is undefined.

The origin of the method ‘ejbStore’ is undefined.

The origin of the method ‘setSessionContext is undefined.

The origin of the method ‘unsetSessionContext is undefined.

For the ‘AccountHome’ class:

The origin of the method ‘create’ is undefined.

For the ‘BankTransactionHome’ class:

The origin of the method ‘create’ is undefined.

For the ‘CheckingAccountHome’ class:

The origin of the method ‘create’ is undefined.

For the ‘SavingAccountHome’ class:

The origin of the method ‘create’ is undefined.

For the ‘CustomerHome’ class:

The origin of the method ‘create’ is undefined.

For the ‘DepositHome’ class:

The origin of the method ‘create’ is undefined.

For the ‘WithdrawalHome’ class:

The origin of the method ‘create’ is undefined.

FIG. 81 comprises FIG. 81A and FIG. 81B and is pseudo-code for the algorithm method DerivationMapping.

The algorithm of method templates creation is described below (1905). For each method derivation mapping:

A method template that iterates over classes is created if the origin of the derived attribute is undefined (lines 2147-2149).

A method template that iterates over source attributes if the origin of the method is an attribute of the origin class (lines 2151-2154).

A method template that iterates over source operations if the origin of the method is a method of the origin class (lines 2156-2157).

For instance, the method derivation mapping described above will create:

A method template that iterates over source classes for the ‘ejbActivate’ and ‘null’method derivation mapping with the following information:

name: ejbActivate

return type: void

access modifier: public;

A method template that iterates over source classes for the ‘ejbCreate’ and ‘null’ method derivation mapping with the following information:

name: ejbCreate

return type: void

access modifier: public;

A method template that iterates over source classes for the ‘ejbLoad’ and ‘null’ method derivation mapping with the following information:

name: ejbLoad

return type: void

access modifier: public;

A method template that iterates over source classes for the ‘ejbPassivate’ and ‘null’ method derivation mapping with the following information:

name: ejbPassivate

return type: void

access modifier: public;

A method template that iterates over source classes for the ‘ejbPostCreate’ and ‘null’ method derivation mapping with the following information:

name: ejbAPostCreate

return type: void

access modifier: public;

A method template that iterates over source classes for the ‘ejbRemove’ and ‘null’ method derivation mapping with the following information:

name: ejbRemove

return type: void

access modifier: public;

A method template that iterates over source classes for the ‘ejbStore’ and ‘null’ method derivation mapping with the following information:

name: ejbStore

return type: void

access modifier: public;

A method template that iterates over source attributes for the ‘getAccountNumber’ and ‘accountNumber’ method derivation mapping with the following information:

name: get<source_attribute_name/>

return type: <source_attribute_type/>

access modifier: public

body: return accountNumber;

A method template that iterates over source attributes for the ‘getBalance’ and ‘balance’ method derivation mapping with the following information:

name: get<source_attribute_name/>

return type: <source_attribute_type/>

access modifier: public

body: return balance;

A method template that iterates over source attributes for the ‘getOpenDate’ and ‘openDate’ method derivation mapping with the following information:

name: get<source_attribute_name/>

return type: <source_attribute_type/>

access modifier: public

body: return openDate;

A method template that iterates over source attributes for the ‘getCustomer’ and ‘customer’ method derivation mapping with the following information:

name: get<source_attribute_name/>

return type: <source_attribute_type/>

access modifier: public

body: return customer;

A method template that iterates over source attributes for the ‘setAccountNumber’ and ‘accountNumber’ method derivation mapping with the following information:

name: set<source_attribute_name/>

return type: void

access modifier: public

parameters: <source_attribute_type/>a<source_attribute_name/>

body: this.accountNumber=aAccountNumber;

A method template that iterates over source attributes for the ‘setBalance’ and ‘balance’ method derivation mapping with the following information:

name: set<source_attribute_name/>

return type: void

access modifier: public

parameters: <source_attribute_type/>a<source_attribute_name/>

body: this.balance=aBalance;

A method template that iterates over source attributes for the ‘setOpenDate’ and ‘openDate’ method derivation mapping with the following information:

name: set<source_attribute_name/>

return type: void

access modifier: public

parameters: <source_attribute_type/>a<source_attribute_name/>

body: this.openDate=aOpenDate;

A method template that iterates over source attributes for the ‘setCustomer’ and ‘customer’ method derivation mapping with the following information:

name: set<source_attribute_name/>

return type: void

access modifier: public

parameters: <source_attribute_type/>a<source_attribute_name/>

body: this.customer=aCustomer;

A method template that iterates over source classes for the ‘setEntityContext’ and ‘null’ method derivation mapping with the following information:

name: setEntityContext

return type: void

access modifier: public

parameters: javax.ejb.EntityContext entityContext

body: this.entityContext=entityContext;

A method template that iterates over source classes for the ‘unsetEntityContext’ and ‘null’ method derivation mapping with the following information:

name: unsetEntityContext

return type: void

access modifier: public

body: this.entityContext=null;

A method template that iterates over source attributes for the ‘getAmount’ and ‘amount’ method derivation mapping with the following information:

name: get<source_attribute_name/>

return type: <source_attribute_type/>

access modifier: public

body: return amount;

A method template that iterates over source attributes for the ‘getDateTime’ and ‘dateTime’ method derivation mapping with the following information:

name: get<source_attribute_name/>

return type: <source_attribute_type/>

access modifier: public

body: return dateTime;

A method template that iterates over source attributes for the ‘getTransactionNumber’ and ‘transactionNumber’ method derivation mapping with the following information:

name: get<source_attribute_name/>

return type: <source_attribute_type/>

access modifier: public

body: return transactionNumber;

A method template that iterates over source attributes for the ‘getaccount’ and ‘account’ method derivation mapping with the following information:

name: get<source_attribute_name/>

return type: <source_attribute_type/>

access modifier: public

body: return account;

A method template that iterates over source attributes for the ‘setAmount’ and ‘amount’ method derivation mapping with the following information:

name: set<source_attribute_name/>

return type: void

access modifier: public

parameters: <source_attribute_type/>a<source_attribute_name/>

body: this.<amount=aAmount;

A method template that iterates over source attributes for the ‘setDateTime’ and ‘dateTime’ method derivation mapping with the following information:

name: set<source_attribute_name/>

return type: void

access modifier: public

parameters: dateTime=a<source_attribute_name/>

body: this.<source_attribute_name/>=a<DateTime;

A method template that iterates over source attributes for the ‘setTransactionNumber’ and ‘transactionNumber’ method derivation mapping with the following information:

name: set<source_attribute_name/>

return type: void

access modifier: public

parameters: transactionNumber=aTransactionNumber

body: this.<source_attribute_name/>=a<source_attribute_name/>;

A method template that iterates over source attributes for the ‘setAccount’ and ‘account’ method derivation mapping with the following information:

name: set<source_attribute_name/>

return type: void

access modifier: public

parameters: <source_attribute_type/>a<source_attribute_name/>

body: this.account=aAccount;

A method template that iterates over source classes for the ‘setSessionContext’ and ‘null’ method derivation mapping with the following information:

name: setSessionContext

return type: void

access modifier: public

parameters: javax.ejb.SessionContext SessionContext

body: this.sessionContext=sessionContext;

A method template that iterates over source classes for the ‘unsetSessionContext’ and ‘null’ method derivation mapping with the following information:

name: unsetSessionContext

return type: void

access modifier: public

body: this.sessionContext=null;

A method template that iterates over source attributes for the ‘getCustomerNumber’ and ‘customerNumber’ method derivation mapping with the following information:

name: get<source_attribute_name/>

return type: <source_attribute_type/>

access modifier: public

body: return customerNumber;

A method template that iterates over source attributes for the ‘getHomePhone’ and ‘homePhone’ method derivation mapping with the following information:

name: get<source_attribute_name/>

return type: <source_attribute_type/>

access modifier: public

body: return homePhone;

A method template that iterates over source attributes for the ‘getName’ and ‘name’ method derivation mapping with the following information:

name: get<source_attribute_name/>

return type: <source_attribute_type/>

access modifier: public

body: return name;

A method template that iterates over source attributes for the ‘setCustomerNumber’ and ‘customerNumber’ method derivation mapping with the following information:

name: set<source_attribute_name/>

return type: void

access modifier: public

parameters: <source_attribute_type/>a<source_attribute_name/>

body: this.customerNumber=aCustomerNumber;

A method template that iterates over source attributes for the ‘setHomePhone’ and ‘homePhone’ method derivation mapping with the following information:

name: set<source_attribute_name/>

return type: void

access modifier: public

parameters: <source_attribute_type/>a<source_attribute_name/>

body: this.homePhone=aHomePhone;

A method template that iterates over source attributes for the ‘setName’ and ‘name’ method derivation mapping with the following information:

name: set<source_attribute_name/>

return type: void

access modifier: public

parameters: <source_attribute_type/>a<source_attribute_name/>

body: this.name=aName;

A method template that iterates over source classes for the ‘create’ and ‘null’ method derivation mapping with the following information:

name: create

return type: EJBObject

access modifier: public.

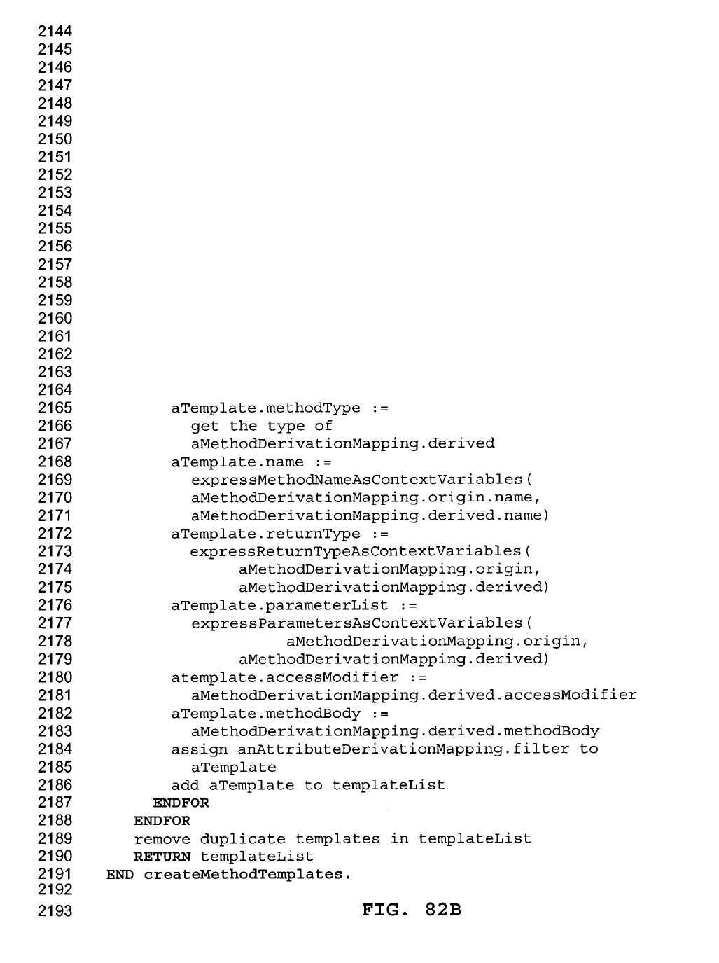

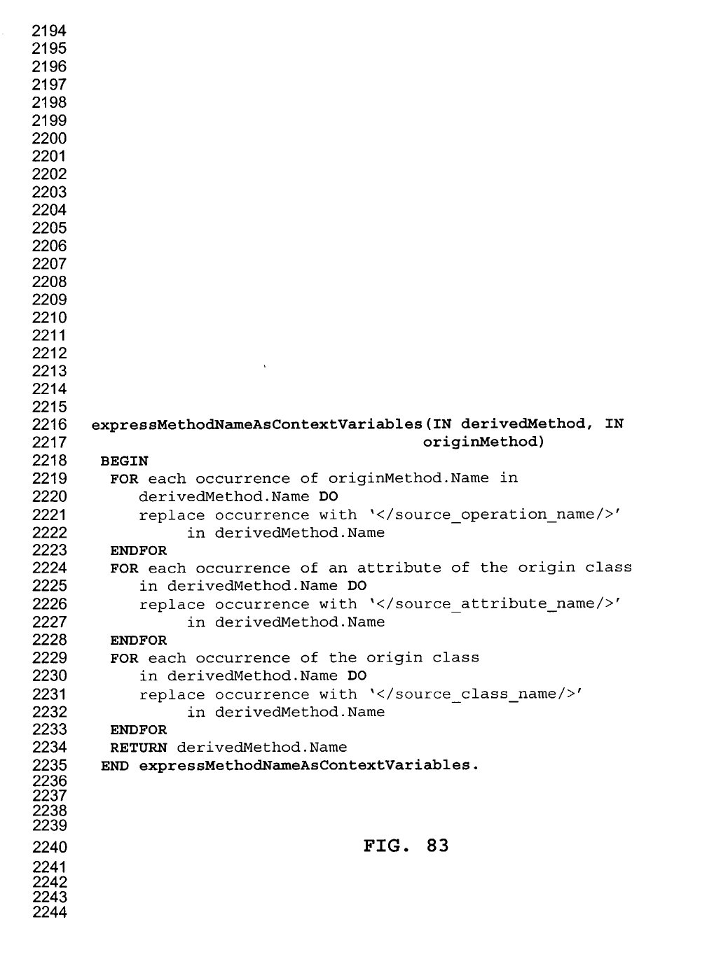

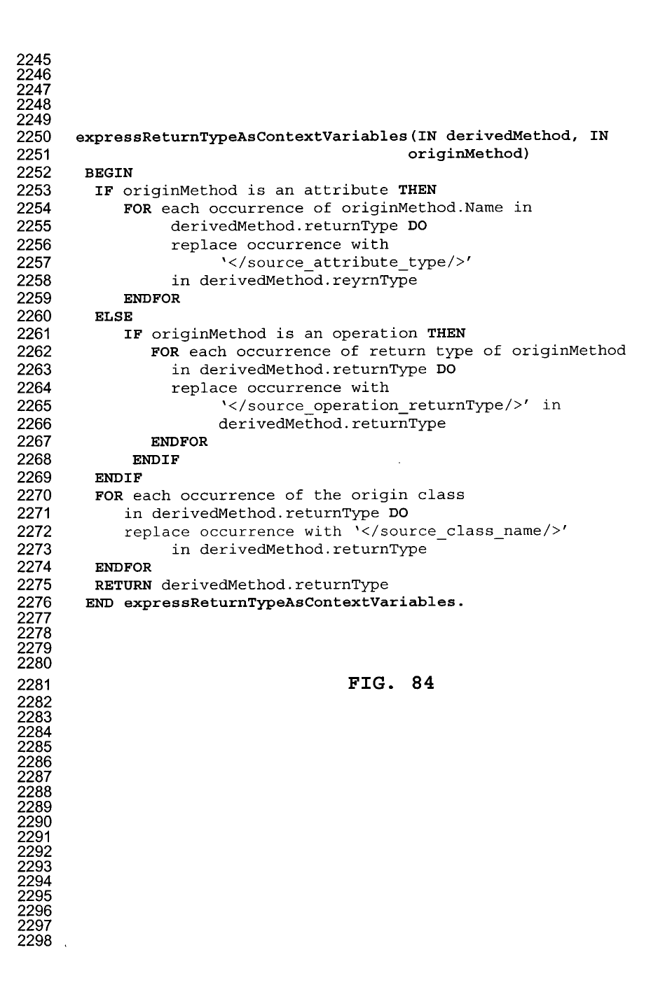

After duplicate templates are removed (line 2189), there remain twelve methods that iterate over classes and twenty two method templates that iterate over source attributes. FIG. 82 comprises FIG. 82A and FIG. 82B and is pseudo-code for the algorithm createMethodTemplates; FIG. 83 is pseudo-code for the algorithm expressMethodNameAsContextVariables; FIG. 84 is pseudo-code for the algorithm expressReturnTypeAsContextVariables; FIG. 85 is pseudo-code for the algorithm expressParametersAsContextVariables.

Finally, the algorithm of the last sub-step (1910) is illustrated below. It serves to replace in the body of method templates all concrete instances with context variables. The method templates created by the preceding step (1905) for the Bank system will be (other templates remain unchanged):

The method template that iterates over source attributes for the ‘getAccountNumber’and ‘accountNumber’ method derivation mapping with the following information:

name: get<source_attribute_name/>

return type: <source_attribute_type/>

access modifier: public

body: return <source_attribute_name/>;

The method template that iterates over source attributes for the ‘getBalance’ and ‘balance’ method derivation mapping with the following information:

name: get<source_attribute_name/>

return type: <source_attribute_type/>

access modifier: public

body: return <source_attribute_name/>;

The method template that iterates over source attributes for the ‘getOpenDate’ and ‘openDate’ method derivation mapping with the following information:

name: get<source_attribute_name/>

return type: <source_attribute_type/>

access modifier: public

body: return <source_attribute_name/>;

The method template that iterates over source attributes for the ‘getCustomer’ and ‘customer’ method derivation mapping with the following information:

name: get<source_attribute_name/>

return type: <source_attribute_type/>

access modifier: public

body: return <source_attribute_name/>;

The method template that iterates over source attributes for the ‘setAccountNumber’ and ‘accountNumber’ method derivation mapping with the following information:

name: set<source_attribute_name/>

return type: void

access modifier: public

parameters: <source_attribute_type/>a<source_attribute_name/>

body: this.<source_attribute_name/>=a<source_attribute_name/>;

The method template that iterates over source attributes for the ‘setBalance’ and ‘balance’ method derivation mapping with the following information:

name: set<source_attribute_name/>

return type: void

access modifier: public

parameters: <source_attribute_type/>a<source_attribute_name/>

body: this.<source_attribute_name/>=a<source_attribute_name/>;

The method template that iterates over source attributes for the ‘setOpenDate’ and ‘openDate’ method derivation mapping with the following information:

name: set<source_attribute_name/>

return type: void

access modifier: public

parameters: <source_attribute_type/>a<source_attribute_name/>

body: this.<source_attribute_name/>=a<source_attribute_name/>;

The method template that iterates over source attributes for the ‘setCustomer’ and ‘customer’ method derivation mapping with the following information:

name: set<source_attribute_name/>

return type: void

access modifier: public

parameters: <source_attribute_type/>a<source_attribute_name/>

body: this.<source_attribute_name/>=a<source_attribute_name/>;

The method template that iterates over source attributes for the ‘getAmount’ and ‘amount’ method derivation mapping with the following information:

name: get<source_attribute_name/>

return type: <source_attribute_type/>

access modifier: public

body: return <source_attribute_name/>;

The method template that iterates over source attributes for the ‘getDateTime’ and ‘dateTime’ method derivation mapping with the following information:

name: get<source_attribute_name/>

return type: <source_attribute_type/>

access modifier: public

body: return <source_attribute_name/>;

The method template that iterates over source attributes for the ‘getTransactionNumber’ and ‘transactionNumber’ method derivation mapping with the following information:

name: get<source_attribute_name/>

return type: <source_attribute_type/>

access modifier: public

body: return <source_attribute_name/>;

The method template that iterates over source attributes for the ‘getAccount’ and ‘account’ method derivation mapping with the following information:

name: get<source_attribute_name/>

return type: <source_attribute_type/>

access modifier: public

body: return <source_attribute_name/>;

The method template that iterates over source attributes for the ‘setAmount’ and ‘amount’ method derivation mapping with the following information:

name: set<source_attribute_name/>

return type: void

access modifier: public

parameters: <source_attribute_type/>a<source_attribute_name/>

body: this.<source_attribute_name/>=a<source_attribute_name/>;

The method template that iterates over source attributes for the ‘setDateTime’ and ‘dateTime’ method derivation mapping with the following information:

name: set<source_attribute_name/>

return type: void

access modifier: public

parameters: <source_attribute_type/>a<source_attribute_name/>

body: this.<source_attribute_name/>=a<source_attribute_name/>;

The method template that iterates over source attributes for the ‘setTransactionNumber’ and ‘transactionNumber’ method derivation mapping with the following information:

name: set<source_attribute_name/>

return type: void

access modifier: public

parameters: <source_attribute_type/>a<source_attribute_name/>

body: this.<source_attribute_name/>=a<source_attribute_name/>;

The method template that iterates over source attributes for the ‘setAccount’ and account’ method derivation mapping with the following information:

name: set<source_attribute_name/>

return type: void

access modifier: public

parameters: <source_attribute_type/>a<source_attribute_name/>

body: this.<source_attribute_name/>=a<source_attribute_name/>;

The method template that iterates over source attributes for the ‘getCustomerNumber’ and ‘customerNumber’ method derivation mapping with the following information:

name: get<source_attribute_name/>

return type: <source_attribute_type/>

access modifier: public

body: return <source_attribute_name/>;

The method template that iterates over source attributes for the ‘getHomePhone’ and ‘homePhone’ method derivation mapping with the following information:

name: get<source_attribute_name/>

return type: <source_attribute_type/>

access modifier: public

body: return <source_attribute_name/>;

The method template that iterates over source attributes for the ‘getName’ and ‘name’ method derivation mapping with the following information:

name: get<source_attribute_name/>

return type: <source_attribute_type/>

access modifier: public

body: return <source_attribute_name/>;

The method template that iterates over source attributes for the ‘setCustomerNumber’ and ‘customerNumber’ method derivation mapping with the following information:

name: set<source_attribute_name/>

return type: void

access modifier: public

parameters: <source_attribute_type/>a<source_attribute_name/>

body: this.<source_attribute_name/>=a<source_attribute_name/>;

The method template that iterates over source attributes for the ‘setHomePhone’ and ‘homePhone’ method derivation mapping with the following information:

name: set<source_attribute_name/>

return type: void

access modifier: public

parameters: <source_attribute_type/>a<source_attribute_name/>

body: this.<source_attribute_name/>=a<source_attribute_name/>;

The method template that iterates over source attributes for the ‘setName’ and ‘name’ method derivation mapping with the following information:

name: set<source_attribute_name/>

return type: void

access modifier: public

parameters: <source_attribute_type/>a<source_attribute_name/>

body: this.<source_attribute_name/>=a<source_attribute_name/>;

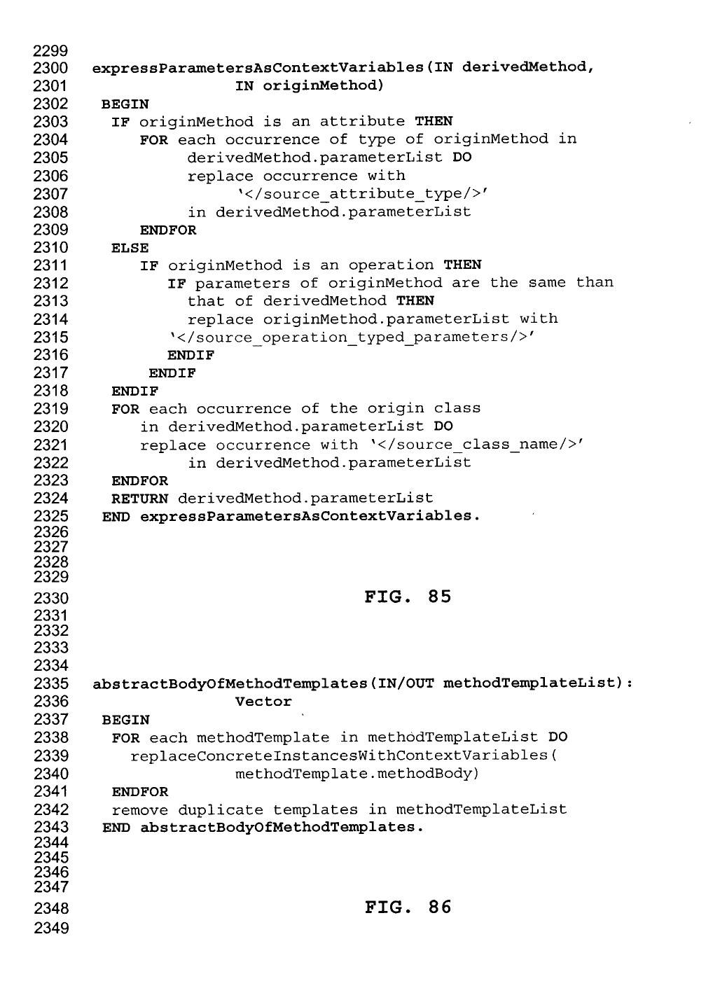

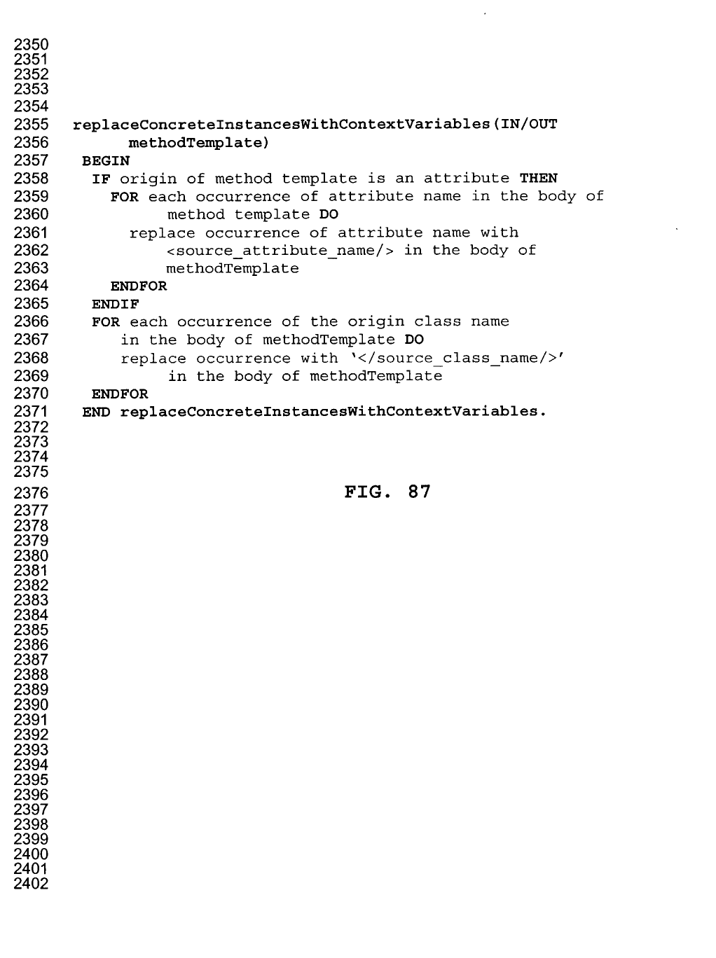

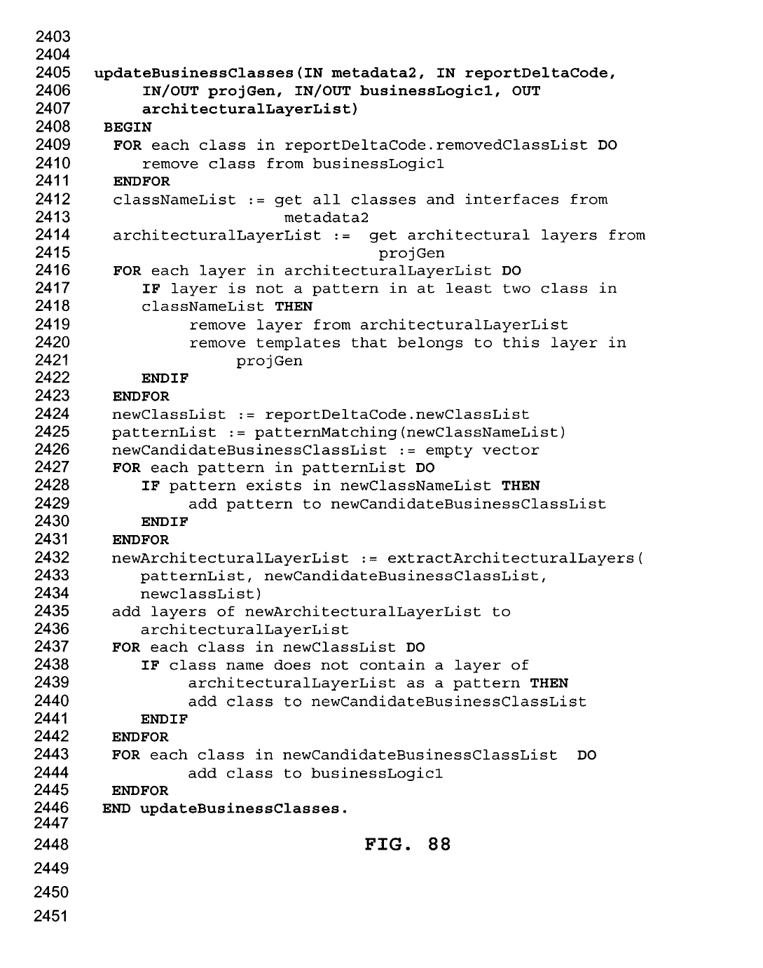

After duplicate templates are removed (line 2389), there remain twelve methods that iterate over classes and only two method templates that iterate over source attributes. FIG. 86 is pseudo-code for the algorithm abstractBodyOfMethodTemplates, and FIG. 87 is pseudo-code for the algorithm replaceConcreteInstancesWithContextVariables.

Scenario 3

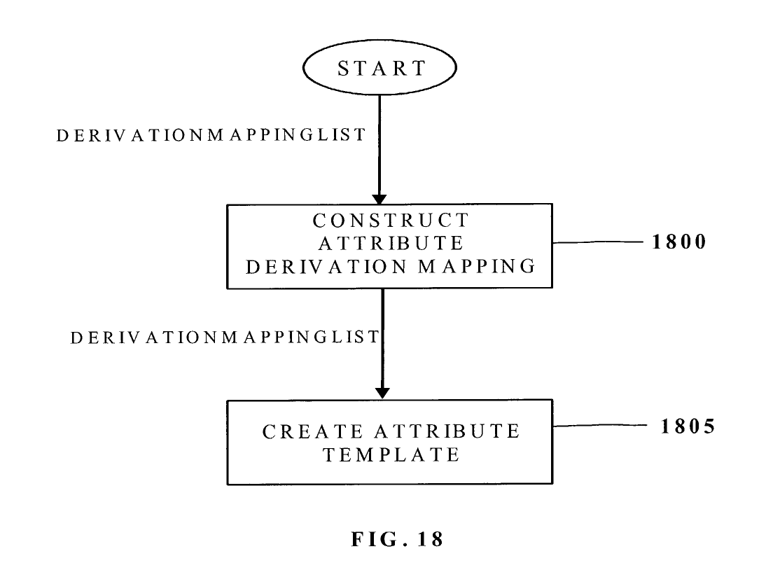

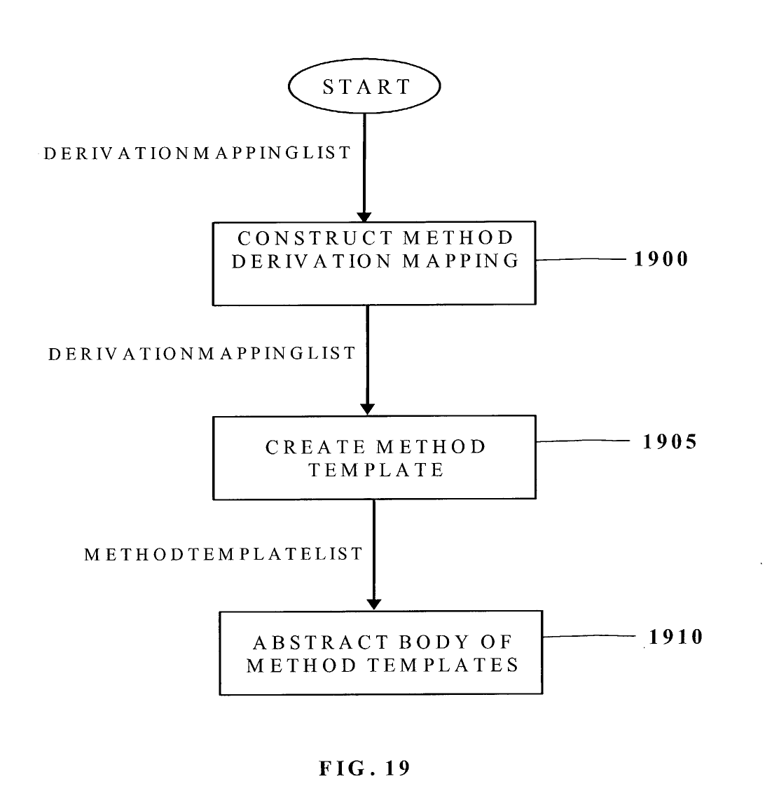

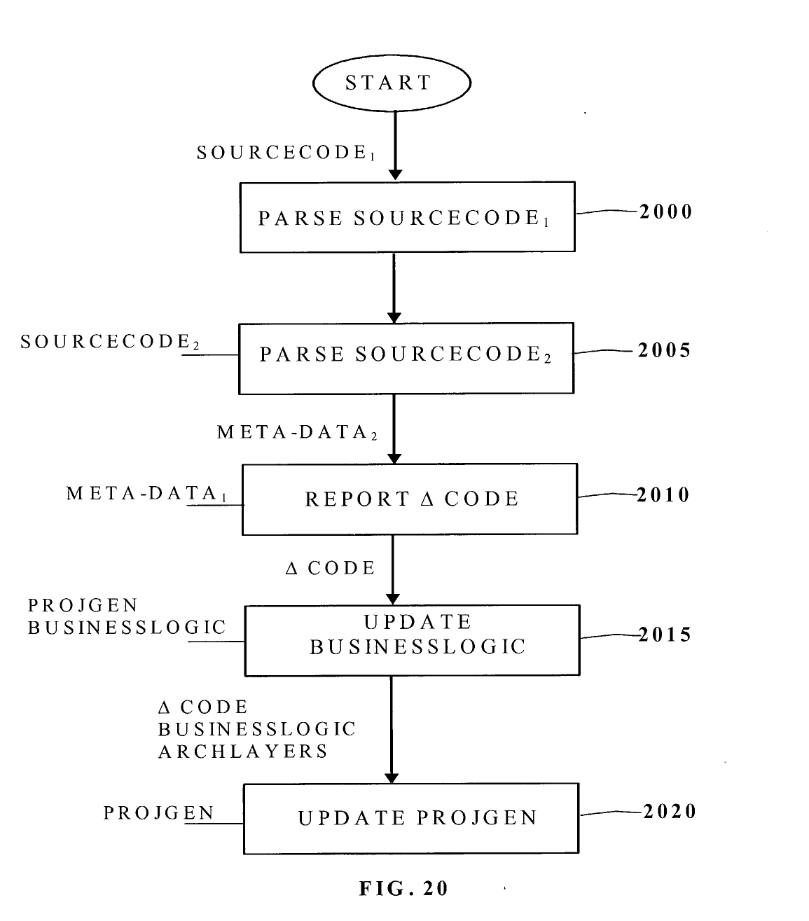

This scenario is a mix of the first two scenarios. Let sourceCode1 be component-based source code, businessLogic1 be the abstract representation of its business logic, and projGen a set of generation templates used to generate sourceCode1 from businessLogic1 [refer to patent]. Assuming that sourceCode1 has evolved to sourceCode2, to ensure the consistency between the source code and its abstract representation, the reverse-engineering engine in this scenario follows the process described in FIG. 20. This process consists of five steps: parse sourceCode1, parse sourceCode2, report Δ code, update businessLogic1, and update projGen.

The parsing steps (2000 and 2005) consist of getting the meta-data of the source code including packages, classes, class and component attributes, and class and component methods. These steps are the same as the steps (200) and (205).

The step ‘report Δ code’ (2010), as in (210), provides the following information:

What are the classes of sourceCode2 that do not exist in sourceCode1 ?

What are the classes of sourceCode1 that do not exist anymore in sourceCode2?

What are the classes of sourceCode1 that are changed in sourceCode2?

For each changed class of sourceCode2,

What are the new attributes?

What are the suppressed attributes?

What are the updated attributes?

What are the new methods?

What are the suppressed methods?

What are the updated methods?

What are the new associations?

What are the suppressed associations?

What are the updated associations?

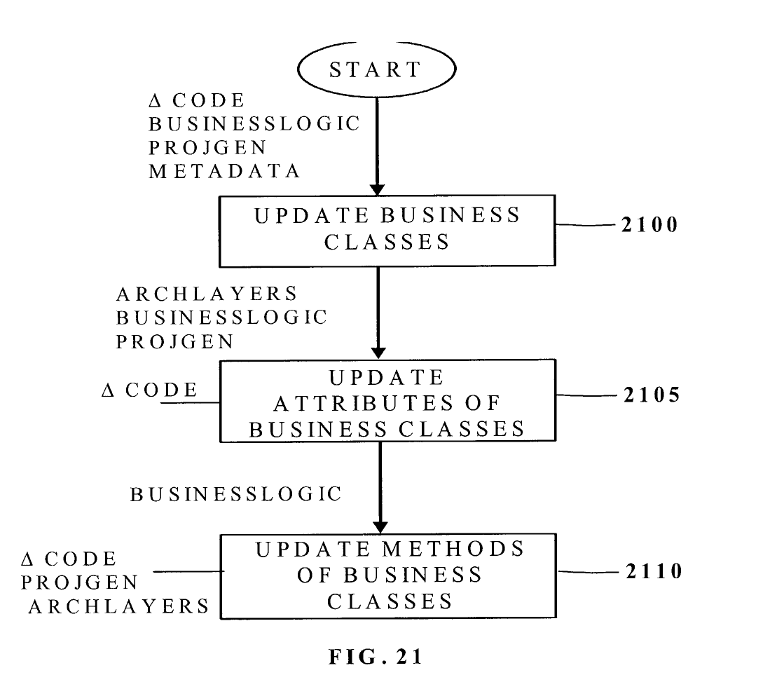

The step ‘update businessLogic1’ (2015) consists of updating the business logic of the component source code with the information reported by the preceding step and filtered with the generation templates contained in projGen. This step is different from step (215). In fact, in this scenario, updating the business logic is a process that comprises three sub-steps (see FIG. 21): update business classes, update attributes of business classes, and update methods of business classes.

The algorithm for updating business classes (2100) is presented below. The algorithm starts by removing business classes that no longer exist (lines 24340-2441). Then it removes architectural layers and their corresponding generation templates that no longer exist in the evolved source code (lines 2443-2453). Finally, the algorithm looks for new candidate business classes from the new classes reported by the last step (2010). Extracting new candidate business classes follows the same process as in (1500).

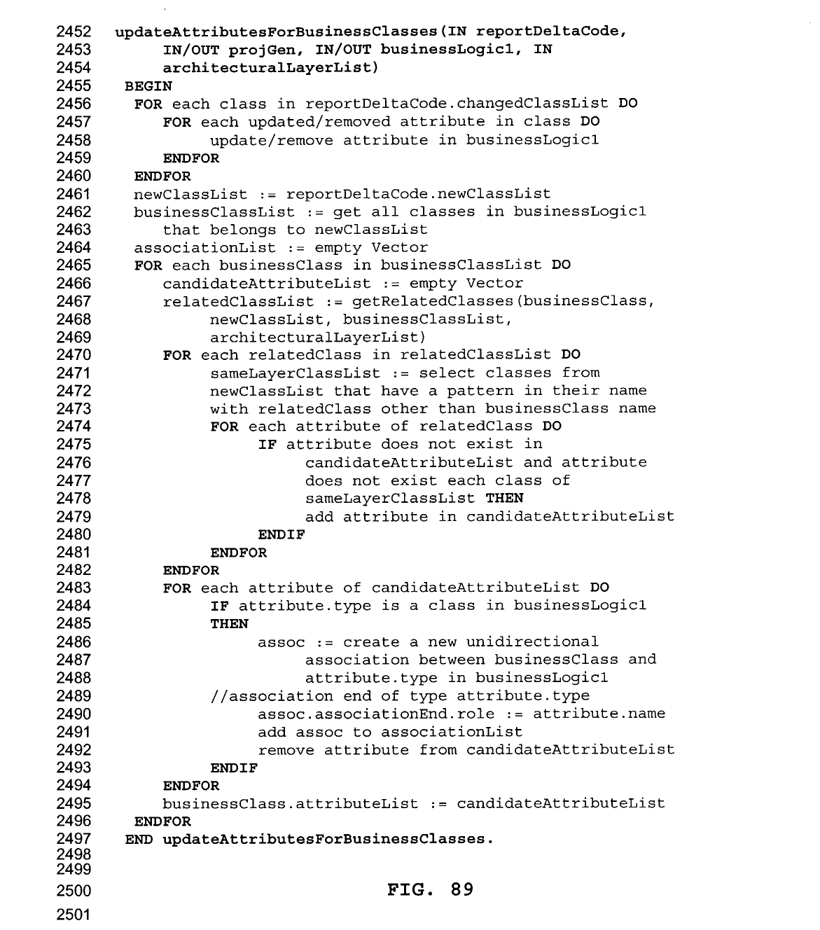

See FIG. 88, which is pseudo-code for the algorithm updateBusinessClasses (2100).

The algorithm for updating attributes of business classes (2105) is presented below. The algorithm starts by removing attributes of business classes that no longer exist (lines 2487-2491). Then the algorithm looks for the attributes of new candidate business classes from the new classes reported by the last step (2010). Extracting attributes of new candidate business classes follows the same process as in (1505).

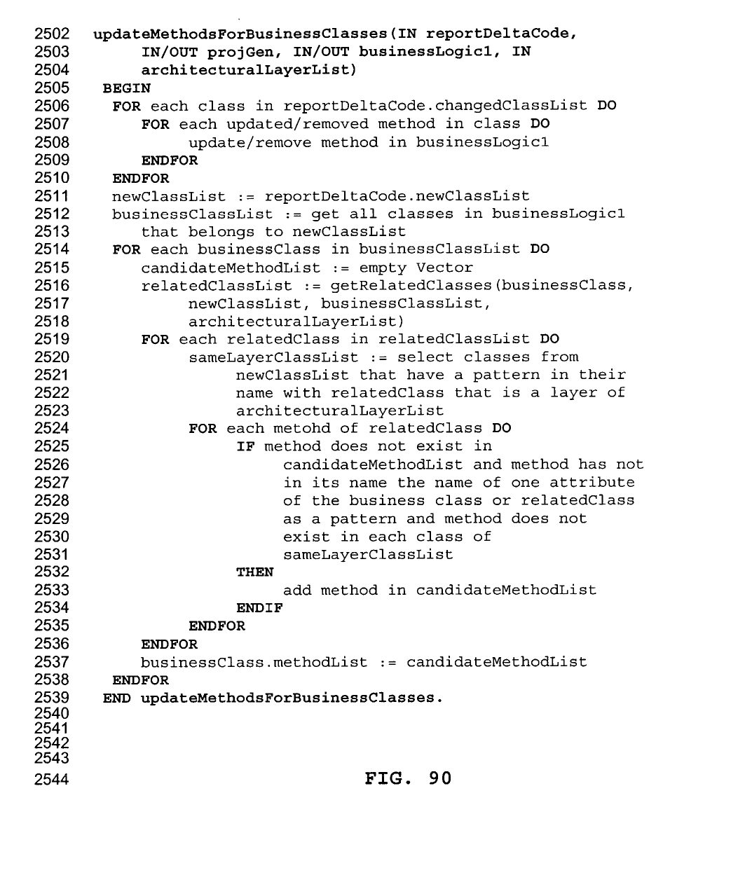

See FIG. 89, which is pseudo-code for the algorithm updateAttributesForBusinessClasses (2105).

The algorithm for updating methods of business classes (2110) is presented below. The algorithm starts by removing methods of business classes that no longer exist (lines 2538-2542). Then the algorithm looks for the methods of new candidate business classes from the new classes reported by the last step (2010). Extracting methods of new candidate business classes follows the same process as in (1510).

See FIG. 90, which is pseudo-code for the algorithm updateMethodsForBusinessClasses (2110).

The step ‘update projGen’ (2020) consists of three sub-steps (see FIG. 22): update class and interface templates, update attribute templates, update method templates.

The step ‘update class and interface templates’ (2200) follows the same process as the step (1410), except that (2200) works only on new classes reported by step (2010).

The step ‘update attribute templates’ (2205) follows the same process as step (1415), except that (2205) works only on new classes reported by step (2010).

The step ‘update attribute templates’ (2210) follows the same process as step (1420), except that (2210) works only on new classes reported by step (2010).

While the invention has been described with particular reference to the illustrated embodiment, it will be understood that numerous modifications thereto will appear to those skilled in the art. Accordingly, the above description and accompanying drawings should be taken as illustrative of the invention and not in a limiting sense.

What is claimed is:

1. A method of generating a higher-level representation of program source code, the method comprising:
providing a program source code;
parsing said program source code to obtain meta-data corresponding to said program source code;
determining a business logic from at least said meta-data;
translating said program source code into parameterized source code using at least one of said business logic and said meta-data;
extracting infrastructure code from said parameterized source code using at least one of said source code and said meta-data;
building the higher-level representation of said source code using said business logic and said infrastructure code,
wherein said higher-level representation provides sufficient information about said source code to permit generation of said program source code using said higher-level representation.

2. A method as claimed in claim 1, wherein said providing comprises retrieving a file containing said program source code.

3. A method as claimed in claim 1, wherein said meta-data are structural properties and are at least one of a package, a class name, a class attribute, a component attribute, a class method, an attribute type, a method signature, a visibility, a body and a component method.

4. A method as claimed in claim 1, wherein said parsing comprises creating a new class and obtaining a meta-data for said new class, and said determining comprises adding said meta-data for said new class to said business logic.

5. A method as claimed in claim 1, further comprising providing an indication of said higher-level representation of said source code.

6. A method as claimed in claim 1, further comprising editing said higher-level representation.

7. A method as claimed in claim 5, further comprising editing said indication of said higher-level representation.

8. A method as claimed in claim 1, wherein said higher-level representation comprises a UML model represented as a class diagram with specification data.

9. A method as claimed in claim 1, wherein said higher-level representation comprises at least one generation template having template data.

10. A method of program code reengineering comprising:
providing a program source code;
parsing said program source code to obtain meta-data corresponding to said program source code;
determining a business logic from at least said meta-data;
translating said program source code into parameterized source code using at least one of said business logic and said meta-data;
extracting infrastructure code from said parameterized source code using at least one of said source code and said meta-data;
building the higher-level representation of said source code using said business logic and said infrastructure code, wherein said higher-level representation provides sufficient information about said source code to permit generation of said program source code using said higher-level representation;
modifying at least a portion of said higher-level representation to effect a reengineering change in said program source code; and
generating reengineered program source code using said modified higher-level representation.

11. A method as claimed in claim 10, wherein said providing comprises retrieving a file containing said program source code.

12. A method as claimed in claim 10, wherein said modifying comprises changing a class name.

13. A method as claimed in claim 10, wherein said modifying comprises changing an attribute of a component.

14. A method as claimed in claim 10, wherein said modifying comprises editing template data obtained from said higher-level representation.

15. A method as claimed in claim 10, wherein said generating comprises creating a reengineered program source code different from said program source code, said reengineered program source code having modifications according to said modified higher-level representation.

16. A method of generating a higher-level representation of program source code using a set of previously used generation template data, the method comprising:
providing a program source code;
providing a set of generation template data previously used to generate said program source code;
selecting at least one of said set of generation template data;
parsing said program source code to obtain meta-data corresponding to said program source code;
determining a business logic from at least said meta-data;
translating said program source code into parameterized source code using said set of generation template data and at least one of said business logic and said meta-data;
extracting infrastructure code from said parameterized source code using said set of generation template data and at least one of said source code and said meta-data;
building the higher-level representation of said source code using said business logic and said infrastructure code,
wherein said higher-level representation provides sufficient information about said source code to permit generation of said program source code using said higher-level representation.

17. A method as claimed in claim 16, further comprising providing an indication of said higher-level representation of said source code and an indication of associated generation template data corresponding to at least a portion of said source code.

18. A method as claimed in claim 16, further comprising providing means to enable portion of the source code corresponding to specific generation template data to be reflected in the higher-level representation if the generation template data is not acting as a filter by unselecting its associated means.

19. An apparatus for generating a higher-level representation of program source code comprising:
a program source code provider for providing a program source code;
a parser for parsing said program source code to obtain meta-data corresponding to said program source code;
a business logic determiner for determining a business logic from at least said meta-data;
a code translator for translating said program source code into parameterized source code using at least one of said business logic and said meta-data;
an infrastructure extractor for extracting infrastructure code from said parameterized source code using at least one of said source code and said meta-data;
an abstraction builder for building the higher-level representation of said source code using said business logic and said infrastructure code, wherein said higher-level representation provides sufficient information about said source code to permit to a code generator to generate said program source code using said higher-level representation.

20. An apparatus as claimed in claim 19, wherein said program source code provider receives a signal containing said program source code.

21. An apparatus as claimed in claim 19, further comprising a display for providing an indication of said higher-level representation of said source code.

22. An apparatus as claimed in claim 21, further comprising an editor for editing said higher-level representation.

23. An apparatus as claimed in claim 19, further comprising a transmitter for transmitting a signal comprising said higher-level representation.

24. An apparatus for reengineering program code comprising:
a program source code provider for providing a program source code;
a parser for parsing said program source code to obtain meta-data corresponding to said program source code;
a business logic determiner for determining a business logic from at least said meta-data;
a code translator for translating said program source code into parameterized source code using at least one of said business logic and said meta-data;
an infrastructure extractor for extracting infrastructure code from said parameterized source code using at least one of said source code and said meta-data;
an abstraction builder for building the higher-level representation of said source code using said business logic and said infrastructure code, wherein said higher-level representation provides sufficient information about said source code to permit to a code generator to generate said program source code using said higher-level representation;
a reengineering modifier for modifying at least a portion of said higher-level representation to effect a reengineering change in said program source code; and
a code generator for generating reengineered program source code using said modified higher-level representation.

25. An apparatus as claimed in claim 24, wherein said provider retrieves a file containing said program source code.

26. An apparatus as claimed in claim 24, further comprising an abstraction transmitter for transmitting a signal comprising said higher-level representation.

27. An apparatus as claimed in claim 24, further comprising a reengineered code transmitter for transmitting a signal comprising said reengineered program source code.

28. An apparatus for generating a higher-level representation of program source code using a set of previously used generation template data, the apparatus comprising:
a program source code provider for providing a program source code; template provider for providing a set of generation template data previously used to generate said program source code;
template selector for selecting at least one of said set of generation template data;
a parser for parsing said program source code to obtain meta-data corresponding to said program source code;
a business logic determiner for determining a business logic from at least said meta-data;
a code translator for translating said program source code into parameterized source code using said set of generation template data and at least one of said business logic and said meta-data;
an infrastructure extractor for extracting infrastructure code from said parameterized source code using said set of generation template data and at least one of said source code and said meta-data;
an abstraction builder for building the higher-level representation of said source code using said business logic and said infrastructure code, wherein said higher-level representation provides sufficient information about said source code to permit to a code generator to generate said program source code using said higher-level representation.

29. An apparatus as claimed in claim 28, further comprising a display for providing an indication of said higher-level representation of said source code and an indication of associated generation template data corresponding to at least a portion of said source code.

30. An apparatus as claimed in claim 28, further comprising means to enable portion of the source code corresponding to specific generation template data to be reflected in the higher-level representation if the generation template data is not acting as a filter by unselecting its associated means.

31. A computer program comprising code means adapted to perform all steps of any one of claims 1 to 18, embodied on a computer readable medium.

32. A computer program comprising code means adapted to perform all steps of any one of claims 1 to 18, embodied as an electrical or electro-magnetical signal.

33. A computer data signal embodied in a carrier wave comprising said higher-level representation built according to any one of claims 1 to 30.

34. A computer program comprising code means adapted to make, once loaded into a computer, the apparatus of any one of claims 19 to 30, embodied on a computer readable medium.

35. A computer program comprising code means adapted to make, once loaded into a computer, the apparatus of any one of claims 19 to 30, embodied as an electrical or electro-magnetical signal.
